(19) United States
(12) Patent Application Publication
(10) Pub. No.: US 2009/0285935 A1
(43) Pub. Date: Nov. 19, 2009

(54) SYSTEM FOR MAKING PRODUCTS WITH IMPROVED PARTICLE MORPHOLOGY AND PARTICLE DISTRIBUTION AND PRODUCTS

(76) Inventors: James S. Brophy, Independence, MN (US); Linda Brophy, Independence, MN (US)

Correspondence Address: COOK ALEX LTD, SUITE 2850, 200 WEST ADAMS STREET, CHICAGO, IL, 60606, US

(21) Appl. No.: 11/813,364

(22) PCT Filed: Jan. 18, 2007
(86) PCT No.: PCT/US07/60730

§ 371 Date: Jul. 5, 2007

Related U.S. Application Data
(60) Provisional application No. 60/760,086, filed on Jan. 18, 2006.

(51) Int. Cl. A23L 1/20; A23P 1/00; C12H 1/00; A23C 23/00; A23C 9/00

(52) U.S. Cl. 426/46; 426/665; 426/634; 426/592; 426/583; 426/580

(57) ABSTRACT

A method for improving the physical, functional and organoleptic properties of product particles is described for fiber, protein, carbohydrate and cellulosic materials. The method involves modifying the particles within the product to meet certain particle morphology parameters. Products themselves also are disclosed, and these include corn-originating products, specifically including products for producing ethanol soybean-originating products, and other products.

Priority is claimed from U.S. Provisional Patent Application Ser. No. 60/760,086, filed Jan. 18, 2006, and from PCT Application Serial No. PCT/US2006/028392, filed Jul. 20, 2006, incorporated hereby by reference hereinto.

The present invention is directed to a system for preparing products with an improved particle morphology, the system utilizing ultrasound technology to process a variety of products on a commercial scale.

### BACKGROUND OF THE INVENTION

Commercial manufacturers strive to consistently deliver high quality products that can be manufactured in an efficient manner, and that have an acceptable shelf life in the retail market. Today's commercial industries have the benefit of many years of research on various ingredients and processing techniques that enable the commercial manufacturer to achieve these goals. However, as consumer demands change and increase, the product manufacturer is faced with new challenges in processing technology.

Many commercial products on the market involve some form of emulsion or other multi-phasic technology, such as dispersions, suspensions, colloidal mixtures, and the like (hereinafter collectively referred to as “emulsions”). Emulsions have a continuous phase into which at least one dispersed phase is suspended. Products that are based on emulsions include, but are not limited to, a variety of food products, such as dairy products including cheese, ice cream and yogurt, non-dairy products such as non-dairy beverages, salad dressings, frostings, and the like.

Emulsions are typically formed in various products by the introduction of shear forces to generate the dispersed phase within the continuous phase. Homogenizers, high shear mixers, high pressure pumps, and similar equipment have been developed to create emulsions in commercial scale processing.

The prevalence of emulsions in many products has led to a vast array of emulsifier and stabilizer ingredients that are commercially available to stabilize the emulsions in order to enhance the physical properties and the shelf life of the product. Emulsifiers and stabilizers are typically surfactants having both a hydrophilic, polar structure and a lipophilic, non-polar structure at the molecular level. Emulsifiers and stabilizers function by creating a stable interface between the continuous and dispersed phases of the emulsion, thereby allowing the dispersed phase to remain dispersed in the continuous phase without significant separation of the phases.

Although the use of emulsifiers and stabilizers has greatly benefited many commercial manufacturers, there is a continuing industry demand to reduce the amount of emulsions and stabilizers needed in a particular product to help reduce its cost of manufacture. In addition, particularly for food products, there is a growing consumer preference for “all-natural” food products containing little or no emulsifiers and stabilizers. These needs pose new challenges for the commercial product manufacturers.

### SUMMARY OF THE INVENTION

The present invention is directed to the unexpected discovery that by utilizing ultrasound technology in a processing system, it is possible to significantly reduce the amount of emulsifiers or stabilizers needed to create and maintain an emulsion in the product. The method of the present invention includes the step of applying ultrasonic energy to the product to create a dispersed phase within the continuous phase. The ultrasonic energy is provided at a level suitable to create dispersed globules or droplets in the continuous phase. In important embodiments, the globules or droplets have a particle morphology that provides enhanced properties for selected uses and/or achieves specific beneficial objectives. In addition, the particle size distribution of the globules or droplets is preferably reduced as compared to a conventionally-made product.

In addition to the reduction in the amount of emulsifiers or stabilizers needed to create and maintain an emulsion in the product, it was also unexpectedly discovered that by utilizing ultrasound technology in a processing system as discussed herein, it is possible to improve many physical properties of the product.

For example, in food products, it has been discovered that the use of ultrasound energy increases the texture and other desirable organoleptic properties of the product. This is particularly beneficial since commercial food manufacturers are using increased levels of non-fat solids to enhance the perceived creaminess of food products, especially non-fat food products such as non-fat dairy products. While not intending to be bound by theory, it is believed that one effect of having the ultrasonic energy applied to the food product results in the food product having an enhanced viscosity profile as compared to a food product having the same formulation which has been otherwise processed, such as by using conventional homogenization methods.

### BRIEF DESCRIPTION OF THE DRAWINGS

FIG. 1 is a flow diagram of a continuous processing system which can be used to treat products with ultrasound.

FIG. 2a-d are plots of particle morphology analysis of skim milk, with FIG. 2a is a plot equivalent spherical diameter. FIG. 2b is a plot of aspect ratios. FIG. 2c is a plot of shape parameters. FIG. 2d is a plot of sphericity.

FIG. 3a-c are plots of equivalent spherical diameter from particle morphology analysis of skim milk.

FIGS. 4a-d are plots of particle morphology analysis of skim milk. FIG. 4a is a plot equivalent spherical diameter. FIG. 4b is a plot of aspect ratios. FIG. 4c is a plot of shape parameters FIG. 4d is a plot of sphericity.

FIG. 5a-d are plots of particle morphology analysis of orange juice. FIG. 5a is a plot equivalent spherical diameter. FIG. 5b is a plot of aspect ratios. FIG. 5c is a plot of shape parameters. FIG. 5d is a plot of sphericity.

FIG. 6a-d are plots of particle morphology analysis of corn starch. FIG. 6a is a plot equivalent spherical diameter. FIG. 6b is a plot of aspect ratios. FIG. 6c is a plot of shape parameters. FIG. 6d is a sphericity comparison each bar displays the percentage difference in the number of particles found at each sphericity value of the test sample as compared to the control sample.

FIG. 7a-d are plots of particle morphology analysis of soy slurry, FIG. 7a is a plot equivalent spherical diameter. FIG. 7b is a plot of aspect ratios. FIG. 7c is a plot of shape parameters. FIG. 7d is a plot of sphericity.

FIG. 8a-d are plots of particle morphology analysis of soy bean base.

FIG. 8a is a plot equivalent spherical diameter. FIG. 8b is a plot of aspect ratios. FIG. 8c is a plot of shape parameters. Fig d is a plot of sphericity

FIG. 9 is a flow diagram of a continuous processing system which can be used to treat products with ultrasound.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

As used herein, “particle morphology” shall refer to the collective structural characteristics of fine particles, including sphericity, shape, equivalent spherical diameter, aspect ratio, shape classification, analysis of variance (ANOVA), and grand radial plot representation, as further explained below.

“Sphericity”, as used herein, is defined as 4π times the ratio of the particle projected area to the square of the particle perimeter. The sphericity of a circle is 1.0.

While not intending to be bound by theory, ultrasonic energy can be used to generate a dispersed phase having particles/globules with greater sphericity and/or smaller particle size distribution than traditional homogenizing methods. For example these factors can be combined to enable stabilizers, to the extent they are added to the system, to function more effectively. As a result, a smaller amount of emulsifiers or stabilizers needs to be added to a product to achieve the same stability as in a product prepared using a conventional processing approach such as conventional homogenization and conventional levels of emulsifiers or stabilizers. In addition, it has been surprisingly discovered that the use of ultrasound energy as described herein results in improved organoleptic properties, due in part to the positive impact on particle morphology, as compared to a conventionally-processed product.

In one embodiment, the particle size distribution range was reduced by about 30%.

In one embodiment, the mean sphericity of the dispersed particles in a product treated using the ultrasound process of the present invention was at least about 40% greater than the mean sphericity of the dispersed particles in a conventionally homogenized product.

As used herein, “shape” is defined as the pattern of all the points on the boundary of a particle. The morphological shape term is the size normalized variance of the radial distribution of the particle profile and represents the amount of deviation between the radii of a particle profile and the radii of a circle. The shape of a circle is zero since the radius of a circle at any angle θ is a constant. The circle is the reference point from which all shapes are measured.

The “Equivalent Spherical Diameter” (ESD) is a size-related measurement, which is defined herein as the diameter of a sphere having the same volume as the particle.

The “Aspect Ratio” (AR) is a shape-related measurement, which is defined herein as the ratio of the particle diameter located perpendicular to the maximum diameter (i.e., the Aspect Diameter) to the maximum diameter.

“Shape classification analysis” as used herein combines features of sphericity and aspect ratio to place particles in various shape classes. For purposes of the present invention, the shape classes are: a) bulky-rounded, b) bulky-irregular, c) elongated-thick and d) elongated-thin.

The “Analysis of Variance” (ANOVA), as defined herein, uses t-testing methods to show over 99% confidence level differences between samples on specified features. In the present invention, the specified features include equivalent spherical diameter, aspect ratio, shape and sphericity.

A “Grand Radial Plot” analysis as defined herein provides a graphical representation of the particle size and shape data for a given sample by providing the graphic overlay of all the boundary points in a sample on a single graph.

The method of the present invention includes determining the optimal ranges for the above-defined parameters of a type of particle's morphology, and processing the product containing such particles in such a way as to manipulate the particles' morphology to increase and make more uniform the distribution of particles within those optimal ranges.

A histogram may be obtained by splitting a range of data into equal-sized “bins” or “classes.” The number of points from the data set that fall into each bin are then counted. Bins can be defined arbitrarily, or with the use of some systematic rule. The particle morphology analysis described herein was carried out using Powder WorkBench32, a program that is available from Particle Characterization Measurements, Inc. of Iowa City, Iowa, hereby incorporated by reference hereinto.

In accordance with the present invention, there is at least about a 1% increase to about a 100% increase in the percentage of particles at each “bin” or “class” falling within the recited range compared to a control product that has not been subjected to a particle morphology modifying process. Preferably, the number of particles is between about 5% to about 75% greater than the control in each bin within the range, more preferably between about 10% and about 60% greater, and particularly preferably between about 20% to about 50% greater than the control product.

It will be appreciated by those of skill in the art that many products have particles that fall within the ranges described above, as well as particles that fall outside the ranges described above. The present invention is directed to statistically significantly increasing the number of particles that fall within the recited ranges, and making the particle distribution within each range more uniform, thereby reducing the number of particles that fall outside of the ranges, to improve the functional and/or organoleptic properties of the product.

As will be demonstrated in some of the examples below, conventionally prepared products typically have a very random distribution of particles across the various particle morphology parameters, and often have spikes or significant increases in the percentage of particles outside either end of the ranges described herein. The present invention is directed to reducing or eliminating these “end region spikes” and providing instead a more uniform distribution of particles within the recited ranges.

Although the use of ultrasound energy is described herein as the preferred method of obtaining the desired particle morphology, those skilled in the art will appreciate that other treatment methods may be suitable to obtain the desired particle morphology in accordance with the present invention, typically while deviating from conventional approaches and treatment specifics. Such other treatment methods include, but are not limited to, homogenization, high shear treatment, cavitation, impingement treatment, and the like.

In products, the dispersed phase may be a protein-, fiber-, or carbohydrate-containing phase, or a multi-component phase. It has been unexpectedly discovered that the use of ultrasound energy as discussed herein to process such products results in improved product performance and/or physical or organoleptic properties of the product, as compared to conventionally-processed products.

The desired particle morphology will vary with the type(s) of dispersed phase(s), protein, fiber, or carbohydrate that are being modified. In some embodiments particles with lower sphericity are desirable. For instance, starch particles with lower sphericity have an increased surface area to react with enzymes to convert the starch to sugar. An increase in the conversion of corn starch to sugar can in turn boost the efficiency of ethanol production from corn. In the case of soy milk and other soy foods, the soy fiber can produce a gritty mouthfeel which can be reduced if the fiber size is reduced to produce particles with a lower equivalent spherical volume. In addition, the cost efficiency of processing soy beans can be increased if the percentage of large particles, pulp, in the slurry of ground soy beans can be reduced. The processing of soy bean slurry to increase the yield particles with the desired morphological characteristics can reduce the amount of pulp present in the slurry and result in an increased yield of soy base, the fraction used to produce soy food products.

The ultrasound treatment system of the present invention may also be used to extract valuable components of biological cells. For example, biological cells can be lysed using the ultrasound treatment system of the present disclosure to facilitate extraction of intracellular components, including proteins, carbohydrates and DNA particles.

The ultrasound treatment system of the present invention can be used to construct a particle or globule in a way that results in functional and/or sensory properties similar to that obtained by using, for example, twice the level of emulsifiers or stabilizers to make a conventional product. It is believed that the use of ultrasonic energy as disclosed herein enables more efficient use of food ingredients overall, due in part to the reduction in shear forces found in conventional homogenization techniques. Other Ingredients that may be affected by the use of ultrasonic homogenization include, but are not limited to, proteins, fibers, carbohydrates, flavorings and sweeteners.

To achieve the desired sphericity and reduction in particle size distribution, in certain embodiments along with the other particle morphology parameters, it has been discovered that the ultrasonic energy must be applied at a certain amplitude for a certain period of time depending on the type of product being processed. Generally, the amplitude can range from 0-100%, preferably from about 20-80%, and more preferably from about 50-70%. In some systems, the ultrasound can be applied (pulsed) for 0-1 cycles, preferably 1 cycle. The typical power frequency to the ultrasound apparatus is between about 50 Hz (hertz) to 60 Hz and can be single of multiphase. In the embodiments described herein, the frequency is about 60 Hz. The ultrasound apparatus described in many examples herein typically operates at a frequency of about 18-24 kHz. However, systems can be scaled so less power is applied to a sample of smaller volumes and more power to samples of larger volumes by utilizing ultrasound apparatus operating at frequencies ranging more than 0 KHz to about 600 KHz.

The total power input to the sample to reach the desired particle morphology is generally between about 90 watts to about 600 watts or above using the equipment described in the examples herein. If the process is scaled up, then the power to volume ratio should be maintained to obtain particles with the desired morphological characteristics. Therefore, the amount of power input into samples will be increased as the volume processed is increased. For a half gallon a minute input of 550 watts would be increased to 600 Kilowatts for a 600 gallon a minute flow cell, keeping all other parameters constant.

It will be understood by those of skill in the art that the energy input is dependent on the amplitude of the ultrasound system being used, the residence time as a function of flow rate, the back pressure, and the solids content and other aspects of the product being treated. For instance, for a given amplitude, increasing back pressure increases the intensity of energy transferred to the slurry. This increased energy results in a tighter particle size distribution (equivalent spherical diameter) than that produced with the same amplitude at a lower back pressure for some products. Unexpectedly, increased back pressure alters other morphology parameters of the particles produced by the ultrasonication e.g. shape characteristics of the particles such as sphericity, aspect ratio, and shape classification.

In one embodiment involving a slurry of dry milled corn with total solids more than 0% and less than about 50% and total starch in the solids between 50-75% of ultrasonic energy having an amplitude of between about 0-100% was applied. In another embodiment, the amplitude was between about 50-100%. In another embodiment the amplitude may be between about 70-100% (with an adjustment to the residence time according to the energy level used). In one embodiment the energy is applied for a period of less than about 30-60 seconds. In another embodiment the energy is applied for less than about 15-30 seconds. In a further embodiment the energy is applied for less than 5-15 seconds. In another embodiment the energy is applied for less than one second, to achieve the desired starch particle size distribution and sphericity, as well as the other particle morphology parameters defined herein. If an amplifier is used, the amplitude can be even higher, for example, about 2-5 fold higher. For some embodiments the sonotrode diameter can range from about 2 cm to about 3.4 cm or greater with the face area consequently ranging from about 3.8 cm2 to about 9 cm for equipment up to about 2000 Kilowatts of the type discussed herein, namely Hielscher units discussed herein. Industrial scale sonotrodes can be designed with diameters of up to 20 cm and above.

In an embodiment of a continuous system in accordance with the present invention, the ultrasound treatment can be applied to a milled corn slurry for as little as 0.036 seconds. The flow rate can be varied from about 1 liter/minute to up to about 4 liters/minute, through a flow cell with a sonic control volume of 1.5 cm³ to achieve the desired results. In one embodiment the control volume ranges from about 1 to about 3 cm3.

In one embodiment the back pressure can range from 0 to about 150 PSI (0 to 10 Bar). In another embodiment the back pressure can range from 5 to about 100 PSIG. In a further embodiment the back pressure can range from about 10 to about 80 PSIG. For some applications, lower back pressures can be beneficial, such as from about 2 to 28 PSIG, 5 to 25 PSIG, and 10 to 20 PSIG. In some applications, a moderate back pressure can be beneficial, such as from 29 to 50 PSIG, 30 to 40 PSIG. In some applications, a higher back pressure can be beneficial such as 51 to 90 PSI, 55 to 85 PSIG, 60 to 80 PSIG, and 65 to 75 PSIG. In one embodiment the back pressure can range from about 30 to about 150 PSI.

In some applications the amplitude can range from about 4 μm to about 60 μm. In some applications the amplitude can range from about 61 in to about 57 μm. For some applications the amplitude can range from about 10 μm to about 50 μm. For other applications the amplitude can range from about 20 μm to about 40 μm. For some applications the amplitude can range from about 25 μm to about 35 μm.

For some embodiments the total solids in the system range from about 10% to about 40% by weight per volume. For some applications the total solids in the slurry range from about 15% to about 35%. For other applications the total solids in the system ranges from about 25% to about 30%. For some further applications a lower concentration of solids in the system can be beneficial such as 5 to 20%, 7 to 18%, and 9 to 16%. For some applications a higher concentration of solids in the system can be beneficial such as 22-42%, 25-39%, 28-36%, and 30-34%.

The temperature of the product during ultrasonication can be controlled and can range from 40° F. to 230° F. (between about 4 and about 110 C). In some applications a range of 40 to 190° F. (between about 4 and about 88 C) can be beneficial. In some applications a lower temperature range can be beneficial such as between 45 to 60° F. (about 7 and about 16 C) and 50 to 57° F. (about 10 to about 14 C). In some application a moderate temperature can be beneficial such as between 60 to 120° F. (about 16 to about 49 C), 70 to 110° F. (about 21 to about 43 C), and 80 to 100° F. (about 27 to about 38 C). In some application a higher temperature can be beneficial such as between 130 to 220° F. (about 54 to about 105 C), 140 to 210° F. (abut 60 to 99 C), 160 to 200° F. (about 71 to 93 C), and 170 to 190° F. (about 77 to 88 C). In the case of some products, for instance carbohydrates, it may be advantageous to maintain a lower temperature as this can reduce swelling before ultrasonication, and result in an increased flow rate and the formation of particles with lower equivalent spherical volume and other favorable morphological characteristics.

In an embodiment involving a slurry of soybeans using the ultrasonication parameters were as described herein, a moderate intensity range can be beneficial, such as 30 to 55 watts/cm2, and 35 to 40 watts/cm2. In an embodiment involving a slurry of soybeans an moderate amplitude range can be beneficial, such as 6 to 26 μm, 10 to 20 μm, and 13 to 17 μm. In an embodiment involving a slurry of soybeans temperature range of 170-190° F. (about 77 to 88 C) can be beneficial. In an embodiment involving a slurry of soybeans, a lower concentration of total solids can be beneficial such as 12 to 18%, and 14 to 16%, with a flow rate of 1 to 2 liters per minute.

In an embodiment involving of soy base using the ultrasonication parameters were as described herein, a moderate intensity range can be beneficial, such as 30 to 55 watts/cm2, and 35 to 40 watts/cm2. In an embodiment involving a soy base a moderate amplitude range can be beneficial, such as 4 to 26 μm, 10 to 20 pn, and 13 to 17 μm. In an embodiment involving soy base a range of temperatures can be beneficial, for instance 40 to 190° F., (between about 4 and 88 C), 55 to 175° F. (between about 13 to 80 C), 75 to 150° F. (about 24 to 66 C), 90 to 125° F. (about 32 to 52 C). In an embodiment involving a slurry of soy base lower concentration of total solids can be beneficial such as 12 to 18%, and 14 to 16%, with a flow rate of 1 to 2 liters per minute.

In an embodiment involving of soy milk using the ultrasonication parameters were as described herein, a moderate intensity range can be beneficial, such as 30 to 55 watts/cm2, and 35 to 40 watts/cm2. In an embodiment involving a soy milk an moderate amplitude range can be beneficial, such as 4 to 26 μm, 10 to 20 μm, and 13 to 17 μm. In an embodiment involving soy milk a range of temperatures can be beneficial, for instance 40 to 190° F. (about 4 to 88 C), 55 to 175° F. (about 13 to 80 C), 75 to 150° F. (about 24 to 66 C), 90 to 125° F. (about 32 to 52 C). In an embodiment involving a soy milk lower concentration of total solids can be beneficial such as 2 to 12%, and 4-10%, with a flow rate of 1 to 2 liters per minute.

In an embodiment involving corn slurry ultrasonication according to the methods of this invention produce starch particles with a sphericity ranging between about 0.03 and about 0.75. In an embodiment involving corn slurry ultrasonication according to the methods of this invention produce starch particles with a sphericity ranging between about 0.25 and about 0.75. In an embodiment involving corn slurry ultrasonication according to the methods of this invention produce starch particles with a sphericity ranging between about 0.25 and about 0.69.

In an embodiment involving corn slurry ultrasonication according to the methods of this invention produce starch particles with an estimated spherical diameter ranging between above 0 to about 8 microns. In an embodiment involving corn slurry ultrasonication according to the methods of this invention produce starch particles with an estimated spherical diameter ranging between about 0.32 to about 8 microns. In an embodiment involving corn slurry ultrasonication according to the methods of this invention produce starch particles with an estimated spherical diameter ranging between about 0.41 to about 8 microns.

In an embodiment involving corn slurry ultrasonication according to the methods of this invention produce starch particles with a shape parameter ranging between about 0.13 to about 0.5. In an embodiment involving corn slurry ultrasonication according to the methods of this invention produce starch particles with a shape parameter ranging between about 0.23 to about 0.38. In an embodiment involving corn slurry ultrasonication according to the methods of this invention produce starch particles with a shape parameter ranging between about 0.25 to about 0.38.

In an embodiment involving corn slurry ultrasonication according to the methods of this invention produce starch particles with an aspect ratio ranging between above zero to about 0.75. In an embodiment involving corn slurry ultrasonication according to the methods of this invention produce starch particles with an aspect ration ranging between about 0.19 to about 0.63. In an embodiment involving corn slurry ultrasonication according to the methods of this invention produce starch particles with an aspect ration ranging between about 0.22 to about 0.63.

In an embodiment involving soy bean slurry ultrasonication according to the methods of this invention produce particles with a sphericity ranging between about 0.38 and about 1.0. In an embodiment involving soy bean slurry ultrasonication according to the methods of this invention produce particles with a sphericity ranging between about 0.47 and about 1.

In an embodiment involving soy bean slurry ultrasonication according to the methods of this invention produce particles with an estimated spherical diameter ranging between above zero to about 10 microns. In an embodiment involving soybean slurry ultrasonication according to the methods of this invention produce particles with an estimated spherical diameter ranging between about 0.32 to about 8 microns. In an embodiment involving soy bean slurry ultrasonication according to the methods of this invention produce particles with an estimated spherical diameter ranging between about 0.41 to about 8 microns.

In an embodiment involving soy bean slurry ultrasonication according to the methods of this invention produce particles with a shape parameter ranging between about 0.19 to about 0.5. In an embodiment involving soy bean slurry ultrasonication according to the methods of this invention produce particles with a shape parameter ranging between about 0.23 to about 0.36. In an embodiment involving soy bean slurry ultrasonication according to the methods of this invention produce particles with a shape parameter ranging between about 0.30 to about 0.36.

In an embodiment involving soy bean slurry ultrasonication according to the methods of this invention produce particles with an aspect ration ranging between above 0.38 to about 1.0. In an embodiment involving soy bean slurry ultrasonication according to the methods of this invention produce particles with an aspect ration ranging between about 0.41 to about 1.0.

In an embodiment involving soy base ultrasonication according to the methods of this invention produce particles with a sphericity ranging between about 0.53 and about 1.0. In an embodiment involving soy base ultrasonication according to the methods of this invention produce particles with a sphericity ranging between about 0.53 and about 0.81. In an embodiment involving soy base ultrasonication according to the methods of this invention produce particles with a sphericity ranging between about 0.63 and about 0.81.

In an embodiment involving soy base ultrasonication according to the methods of this invention produce particles with an estimated spherical diameter ranging between above 0 to about 10 microns. In an embodiment involving soy base ultrasonication according to the methods of this invention produce particles with an estimated spherical diameter ranging between about 0.23 to about 8 microns. In an embodiment involving soy base ultrasonication according to the methods of this invention produce particles with an estimated spherical diameter ranging between about 0.5 to about 7.5 micron.

In an embodiment involving soy base ultrasonication according to the methods of this invention produce particles with a shape parameter ranging between about 0.14 to about 0.5. In an embodiment involving soy base ultrasonication according to the methods of this invention produce particles with a shape parameter ranging between about 0.27 to about 0.34. In an embodiment involving soy base ultrasonication according to the methods of this invention produce particles with a shape parameter ranging between about 0.28 to about 0.36.

In an embodiment involving soy base ultrasonication according to the methods of this invention produce particles with an aspect ratio ranging between about 0.66 to about 1.0. In an embodiment involving soy base ultrasonication according to the methods of this invention produce particles with an aspect ratio ranging between about 0.45 to about 0.90.

In an embodiment involving soy milk ultrasonication according to the methods of this invention produce particles with a sphericity ranging between about 0.47 and about 0.98. In an embodiment involving soy milk ultrasonication according to the methods of this invention produce particles with a sphericity ranging between about 0.69 and about 0.87. In an embodiment involving soy milk ultrasonication according to the methods of this invention produce particles with a sphericity ranging between about 0.75 and about 0.87.

In an embodiment involving soy milk ultrasonication according to the methods of this invention produce particles with an estimated spherical diameter ranging between above zero to about 10 microns. In an embodiment involving soy milk ultrasonication according to the methods of this invention produce particles with an estimated spherical diameter ranging between about 0.23 to about 7 micron. In an embodiment involving soy milk ultrasonication according to the methods of this invention produce particles with an estimated spherical diameter ranging between about 0.5 to about 5.0 micron.

In an embodiment involving soy milk ultrasonication according to the methods of this invention produce particles with a shape parameter ranging between about 0.188 to about 0.5. In an embodiment involving soy milk ultrasonication according to the methods of this invention produce particles with a shape parameter ranging between about 0.188 to about 0.3252. In an embodiment involving soy milk ultrasonication according to the methods of this invention produce particles with a shape parameter ranging between about 0.188 to about 0.234.

In an embodiment involving soy milk ultrasonication according to the methods of this invention produce particles with an aspect ration ranging between above 0.53 to about 0.95. In an embodiment involving soy milk ultrasonication according to the methods of this invention produce particles with an aspect ratio ranging between about 0.53 to about 0.80. In an embodiment involving soy milk ultrasonication according to the methods of this invention produce particles with an aspect ratio ranging between about 0.67 to about 0.80.

Sonication is a reproducible process that can be readily scaled up to as long as the power to volume ratio is maintained. Therefore, through the use of larger flow cells, multiple ultrasonic units in series or in parallel configurations, the flow rate can reach 1000 gallons a minute while producing particles of desired particle morphology. Scaling will take into account the residency time, amplitude and intensity.

The ultrasonic energy can be applied to the product at any stage during processing at which the product is in a flowable state. For example, the product can be treated with ultrasonic energy: immediately upon entering the processing system; before or after being milled, before or after being heated, pasteurized, treated with ultra high temperatures (UHT), sterilized, or treated with any other aseptic process; before or after being mixed with other ingredients; before or after being packaged; or a combination thereof. In the case of food products, it may be advantageous to deaerate product before ultrasonication to improve flavor characteristics.

The product can also be treated with ultrasound energy on more than one pass through the processing system. For example, to achieve the desired particle morphology, it may be desirable to provide a feedback loop through which the product can be treated with ultrasound energy more than one time. If an ethanol plant ran at 100% efficiency the plant would produce 3.2 gallons of ethanol from each bushel of No. 2 dent corn which is 67% starch. Currently, the majority of ethanol production plants are 80% efficient in their ethanol conversion, and produce 2.7 gallons of ethanol per bushel of ethanol.

Ethanol is produced from grains (corn, wheat, barley, rice, etc) by fermentation. However yeast can not ferment starch and therefore the starches of grains must first be converted to simple sugars such as glucose for fermentation to occur. In commercial settings the starch of a grain, typically corn, can be converted to sugar through the use of either dry milling or wet milling.

Dry milling involves an initial grinding step in which the grain is ground into a fine powder usually by hammer mills. Next is a liquefaction step in which the ground powder is mixed with water to produce a slurry and then enzymes are added. The enzymes, which are typically alpha-amylases, hydrolyze the saccharide bonds between the sugar subunits of starch to break down starch into simpler sugars. During the liquefaction process the slurry with the added enzymes is heated. This provides a cooking temperature that can range from about 70° F. to about 200° F. (about 20 to about 93° C.) at ambient pressure. Alternatively, the slurry can undergo jet cooking, a process in which the temperature is raised above boiling under pressure, for instance the temperature can be raised to about 245° F. to 302° F. (about 118 to 150° C.) with a pressure of about 120-150 lbs/in² (8.4 to 10.5 kg/cm²) or to 220 to 225° F. (104-107° C.) and a pressure of about 120 Lb/in² (8.4 kg/cm²). After cooking, additional alpha-amylase or other suitable enzyme often is added while the temperature is held between 70-200° F. (about 20 to about 93° C.) to continue the hydrolysis of starch to form maltodextrins and oligosaccharides.

The next step in the production of ethanol is saccharification, in which the slurry, some times called a mash, is cooled and another enzyme such as gluco-amylase is added to continue the conversion of starch to fermentable single sugars (e.g. glucose). Saccharification is followed by fermentation in which yeast is added to the slurry or mash, Fermentation is allowed to continue until the sugars are converted to ethanol. In commercial processes, saccharification is often combined with fermentation and these processes are continued through a number of tanks to produce a continuous process with the addition of added slurry in some tanks and the removal of the fermented product in other tanks. In a continuous process yeast and unfermented sugars can be recycled back into the fermentation while ethanol is continually removed. Alternatively, the process can be a batch type process in which ethanol is removed at completion of the fermentation of a batch.

Ethanol is purified by distillation. In this process, the fermented mash, beer, which can contain up to about 17-18% ethanol (volume/volume) is typically pumped into multi-column distillation systems where the beer is heated to vaporize the ethanol. The ethanol is then condensed in the distillation columns. The residual mash is called whole stillage. The solids from the whole stillage typically are isolated by centrifugation to produce wet cake while the remaining liquid called thin stillage enters evaporators where the moisture is removed to produce a thick syrup of soluble solids. The wet cake and syrup can then be combined to be sold as livestock feed as Distillers Wet Grain with Solubles (DWGS). The combination of wet cake and syrup can also be dried and sold as Distiller Dry Grain with Solubles (DDGS) as a livestock feed, or alternatively can be burned as fuel.

Alcohol can also be produced from grains by wet milling. In this process the grain is separated into various components, and therefore, unlike typical dry milling only the starch, not the whole grain enters the fermentation process. In wet milling, the grain is first milled, Subsequently, the ground grain is heated in a solution of sulfur dioxide and water for one to two days to loosen the hull fibers and germ. Next swollen grain is ground and the germ is separated from the kernel. Following additional grinding and washing steps the fiber and a high-protein gluten portions of the kernel are removed. The remaining starch then undergoes liquefaction, saccharification and fermentation steps similar to those described for dry milling. Oil can be purified from the removed germ of the grain. The fiber of the hulls, germ meal, and gluten can be combined to produce gluten feed for cattle.

A recognized loss of efficiency of ethanol conversion from corn is in the conversion of corn starch to glucose. Currently 20% of the starch in corn is not convertible to sugar, in part because the converting enzymes can not get access to some starch because a portion of the starch is attached to the fiber and germ of the corn. Additionally, the conversion of starch into sugar can be incomplete and results in larger chained saccharides that can not be converted into ethanol of yeast.

Ethanol production can be increased by producing starch particles with the morphological characteristics that optimize the enzymatic conversion of starch to sugars that are efficiently converted to ethanol during fermentation. Ultrasonication according to an embodiment of the present invention can produce starch particles with shape morphological characteristics that boost ethanol production. In addition, ultrasonication as described in an embodiment of the present invention can also boost ethanol production from corn by reducing the amount of corn starch associated with the fiber and germ of corn. For instance, ultrasonication to produce particles of the appropriate morphological characteristics can raise the conversion process of starch to sugar to at least 90% efficiency which would result in increasing the amount of ethanol produced from a bushel of corn to 3 gallons.

In embodiments involving producing ethanol from corn starch particles, ultrasonication of corn slurry according to the invention increases yields of fermentable sugars (glucose, maltose, dextrin) obtained from amylase digestions by 15 to 17% as compared to producing ethanol from corn slurries not treated according to the invention. Similarly, ultrasonication of corn slurry according to the invention increases yields of ethanol obtained following fermentation by 9 to 15%, as compared to untreated slurries. Interestingly, ultrasonic treatments of corn slurry that are not in accordance with the methods of this invention resulted in lower yields of both the amount of fermentable sugars obtained from the amylase enzyme digestions and the percentage of ethanol obtained from fermentation.

Soy food products are typically produced from soy beans by initially swelling the soy beans in water and subsequently grinding the swollen beans to produce a slurry. The large solids of the soy bean slurry, called pulp or okara, is usually removed by centrifugation and reprocessed by additional grinding. The collection of smaller soy solids that are not removed by centrifugation is called the base. The soy base is usually further processed to produce soy foods. For instance, the base can be diluted for the production of soy milk, coagulated for the production of tofu, cultured to produce soy yogurt, or further processed to produce a wide variety of products including soy ice cream, pudding, etc. Increasing the percentage of particles with a smaller equivalent spherical diameter by the use of ultrasonication of the soy slurry results in a reduction of the amount of okara and an increase in the amount of soy base. This increases the yield of food products produced from a bushel of soybeans and reduces the amount of reprocessing of okara that is typically involved in soy food production. Utilization of ultrasonication of soy base can produce particles with morphological characteristics that result in products with improved water retention, reduction of beany or green flavor, and/or enhanced mouthfeel.

Although the examples described herein involve certain products, the present invention may have the potential to be used in connection with virtually any type of product, including, but not limited to, the following:

Milk products (fresh, organic, and pasteurized): skim milk, 1% milk, 2% milk, whole milk, flavored milk (such as chocolate, vanilla, strawberry, and the like), UF filtered milk, low carbohydrate dairy beverages, cream, half & half, soft serve ice cream, ice cream, ice milk, ice cream mix, shake mix, gelato, ice cream novelties, mellorine, artificially sweetened dairy products, Italian ice, sorbet, frozen yogurt, yogurt imitations, kefir, sour cream, egg nog, creamers, non-dairy creamers, buttermilk, sour cream, yogurt, yogurt-based beverages, custard, yogurt premix, cheese, processed cheese, cheese toppings, American cheese, cream cheese, spreadable cheese, string cheese, cheese blends, whipping cream, cottage cheese, butter, margarine, whey, milk and cream based liqueurs, milk concentrates, milk proteins, condensed milk, sweetened condensed milk, enriched/fortified products, fermented products, dairy desserts, whey, whey protein concentrate, casein, lactic acid,

Soy: soy base, soymilk, soy yogurt, soy ice cream, soy butter, soymilk spreads, soymilk blends, flavored soymilk, soymilk beverages, soymilk desserts, soy beverages, soy protein, tofu, tempeh;

Beverage/Juices: sports drinks, isotonics, energy drinks, protein drinks, flavored water, juice (fruit, vegetable, or other), fruit pulps and concentrates, juice blends, juice/milk blends, juice/soy blends, juice/milk/soy blends, juice/grain blends, diet shakes, diet drinks, energy drinks, nutritional drinks, ice tea, tea drinks, tea, fluid meal replacement drinks, geriatric drinks, nutrient-enhanced New-Age drinks, reduced calorie drinks, reduced carbohydrate drinks, tomato juice, chai teas, iced cappuccinos, beer, lite beer, dark beer, ales, lagers, specialty beers, wine (red, white, dessert, fortified, rose, fruit, champagne, sparkling), alcohol drink mixes (chocolate, Irish cream, amaretto, coffee, and the like), liquors, beverage emulsion, protein fortified juices and juice beverages, juice flavored beverages, nutraceuticals, Vitamin and Mineral Enriched Drinks, Herbal Drinks, Wellness Drinks, Carbonated Soft Drinks and functional soft drinks, concentrates, beverage emulsions;

Sauces/soups/spreads: tomato condiments, tomato paste concentrate, tomato sauce, ketchup, mayonnaise, mustard, salad dressing, gravy, peanut butter, spreads, nut paste, mustard, barbeque sauce, steak sauce, soy sauce, picante sauce, taco sauce, creamy soup, broth-based soup, honey, sauces, vinegar, balsamico, olive oil;

Confectionary: chocolate, cocoa, cocoa butter, cocoa paste, chocolate coatings and syrups, chocolate candy, chocolate bars, chocolate liquor, sweetened & unsweetened chocolate, ice cream toppings & coatings, sugar free chocolate, gum, sugarless gum, sugarless non chocolate, food color, caramel, non chocolate candy, frostings, sugar slurries, sugar syrup, natural and artificial sugars;

Sweeteners: corn syrup, dextrose, high fructose corn syrup, maltose, sugar, sucrose, caramel;

Fibers/Grains/Pulp/Solids: wheat, oat, barley, rice, malt, sorghum, corn, millet, rye, triticale, durum, quinoa, amaranth, pulp (fruit and vegetable);

Miscellaneous: pudding, cake batter, batter mixes, pie fillings (fruit or cream-based), custard, syrups, starter cultures, flavorings, fragrances, baby food, infant formula (dairy, rice and soy based), baby milk, eggs, vitamins and minerals, citric acid, citrates, citrus juice, citrus products, flavor emulsions, gelatin, amino acids, starch, gypsum, emulsifiers, stabilizers, isoflavones, flavors/flavorings, yeast, pectin, cloud emulsions, functional ingredients, reduced fat products;

Cosmetic/Healthcare: body lotion, body wash, hand lotion, hand wash, hand cream, antibacterial products, shampoo, conditioner, cosmetics, baby products, bar soaps and detergents, liquid soap, bath products, A/P gels, deodorants and antiperspirants, depilatories, eye make-up preparations, eye ointments, face make-up preparations, feminine hygiene products, fragrance and perfume preparations, creams, hair bleach, hair dye, hair color, hair care products, hair straightener and permanents, lipstick, lip balm, lip gloss, make-up pencils, nail care, oral care products, shaving products, skin care products, suntan and sunscreen preparations, tanning lotion, waves, micro emulsions, amino emulsions, cationic emulsions, creams and lotions, ointments, skin care lotions, aloe vera, liposomes, moisturizers, anti-age creams, anti-wrinkle creams, collagen, cerebrosides, aloe, surfactants, mascara, nail polish, nail remover, surfactant blends, perfumes, toothpaste, liposomes, liposome emulsions;

Chemical/Industrial Products: paint, paint pigment, paint dispersions, specialty paints and coatings, ink, ink pigment, ink dispersions, pigment dispersions, color pastes, colorants, polishes, photographic emulsions, grease, fuel oil, fumed silica dispersions, detergents, waxes, wax emulsions, wax filler dispersions, adhesives, lubricants, kaolin, colloidal suspensions, mineral dispersion, mineral oil emulsions, carbon black dispersions, dyestuffs with solvents, paraffin emulsions, antioxidants, resins, corrosion inhibitors, lanolin, latex, latex emulsions, silicones, starches, lubrication oil, emulsions, clay dispersions, coatings, dye dispersions, resin/rosins, colorants, gel coats, insecticides, pesticides, ceramics, soap, wood preservation, solvents, polymers, polishes, rubber solutions, rubber latex, paper coatings, betonies in oil, bentonite clay, bitumen base, cellulose land derivatives, anti-foam emulsions, weatherproofing, silicone emulsions, textile emulsions, asphalt emulsions, can coatings, shoe polish;

Pharmaceutical: drugs, antacids, ointments, creams, tablet coatings, intravenous emulsions, drug emulsions, dye dispersions, antibiotics, antioxidants, burn creams, liposomes, nutrition supplements, syrups, veterinary preps, vitamins and minerals, antibiotics, proteins, API (active pharmaceutical ingredients), viruses;

Biological Cells: algae, enzymes, human and/or animal blood cells, microbial cells (bacterial, yeast, mold).

### Example 1

### Treatment of Skim Milk Protein

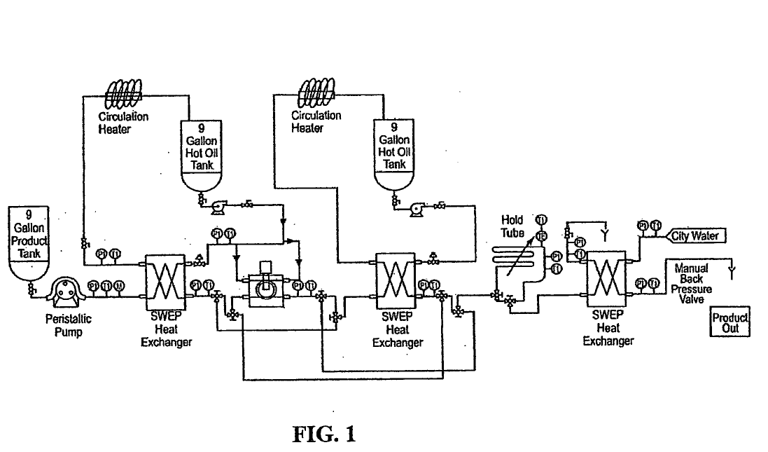

To demonstrate the effects of ultrasonic treatment on protein molecules, unprocessed skim milk was subjected to ultrasonic energy in the continuous system shown in FIG. 1. Skim milk generally contains less than 0.5% milkfat by weight. The skim milk (0.02% milkfat by weight) was treated with ultrasound at a frequency of 24 kilohertz for the time periods shows in the Figures, at a flow rate of 0.25 gallons/minute. The treated skim milk was evaluated for the particle morphology parameters described above, both at the micron and the sub-micron levels to fully understand the effects of ultrasonication on protein molecules.

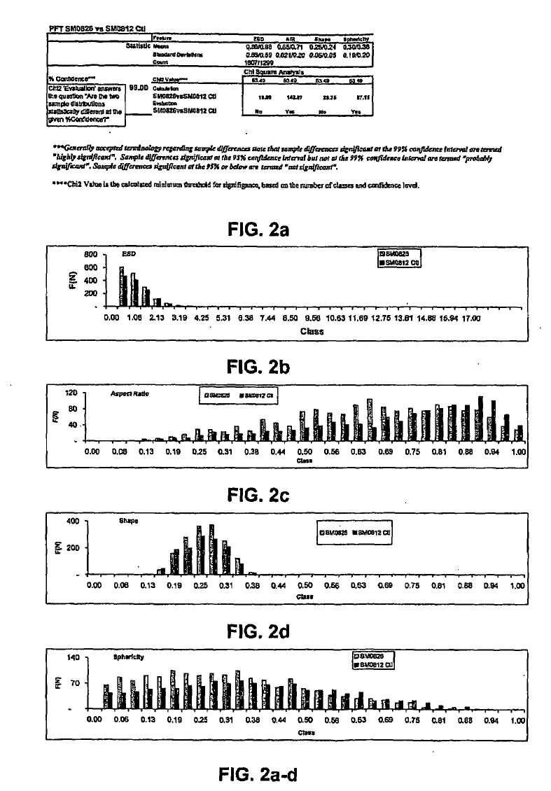

FIGS. 2a-2d show the results of the particle morphology analysis of the skim milk. Due to the very low fat content of skim milk, the analysis focused on the protein content of the skim milk. Overall, the equivalent spherical diameter, aspect ratio, and sphericity decreased, while the shape parameter increased, as compared to a control skim milk that was processed using conventional homogenization techniques. In this and all the following examples, the particle morphology variables are determined from the raw data.

In this example, the mean equivalent spherical diameter decreased by about 2.3% from the control, the mean aspect ratio decreased by about 8.45% from the control, the mean sphericity decreased by about 16.6% from the control, and the mean shape parameter increased by about 4.16% from the control.

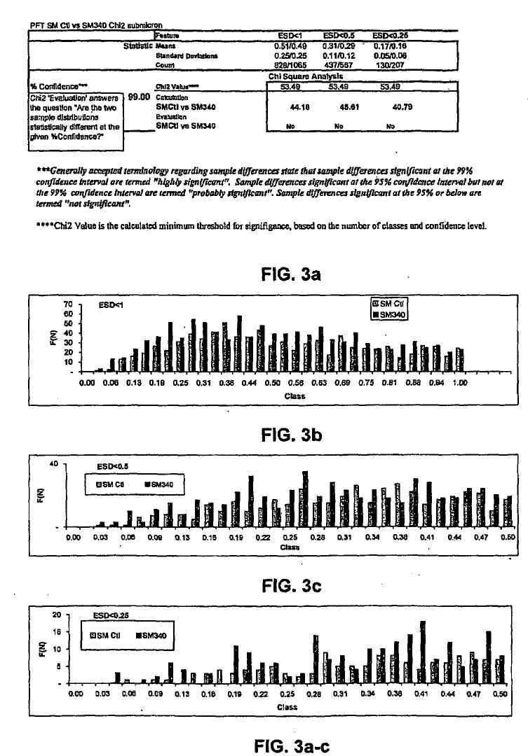

A sub-micron level analysis was done to determine the number of particles having a mean equivalent spherical diameter less than 1 micron, less than 0.5 micron, and less than 0.25 micron. The results are shown in FIGS. 3a-3c. At all levels, consistent with the data in FIG. 2a, the mean equivalent spherical diameter of the ultrasound-treated skim milk samples decreased as compared to the control skim milk samples. Of particular interest was the increase in count, or number of particles of a given equivalent spherical diameter in a prescribed area. The sub-micron level analysis shows an increase of about 28% compared to the control, of particles having an equivalent spherical diameter of less than 1 micron, about a 30% increase in particles having an equivalent spherical diameter of less than 0.5 micron as compared to the control, and almost a 60% increase in particles having an equivalent spherical diameter of less than 0.25 micron as compared to the control.

While not intending to be bound by theory, it is believed that this significant change at the sub-micron level, for protein-containing products treated with ultrasound energy, results in the increased creaminess and other desirable organoleptic properties observed. The significant increase of particles at the less than 0.25 micron level may account for an increase in viscosity as compared to the control skim milk product.

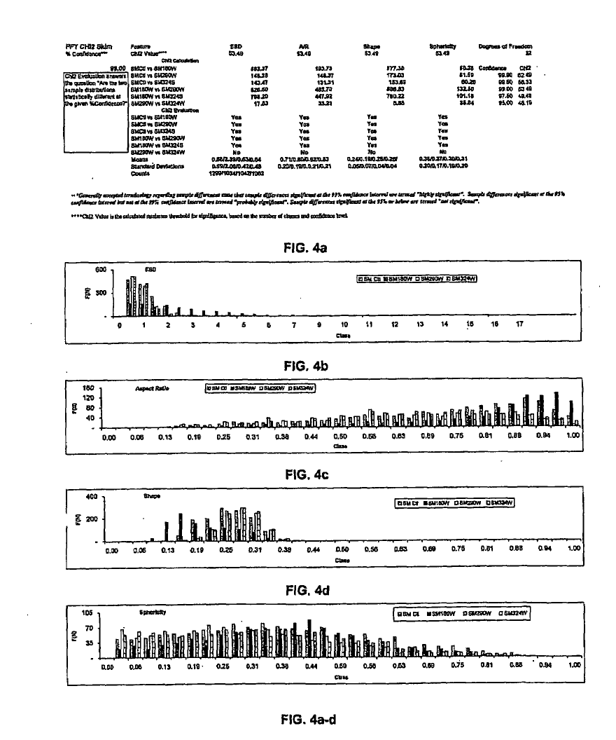

FIGS. 4a-d show the results of ultrasound treatment of skim milk in accordance with the present invention under various levels of ultrasound treatment. In these figures, SM Ctl is the control skim milk without ultrasound treatment, SM 180 W is skim milk treated with ultrasound at 180 watts, SM290 W is skim milk treated with ultrasound at 290 watts, and SM324W is skim milk treated with ultrasound at 324 watts.

### Example 2

### Treatment of Soy Milk Fiber

Soy milk and other milk substitutes often suffer from problems such as a gritty mouthfeel or product separation during storage. These problems reduce the consumer acceptability of such products, even though many consumers who are allergic to dairy ingredients must rely on such products. The ultrasonic treatment system of the present invention is believed to overcome many of these problems due to the effects of ultrasound energy on fibers and fibrous ingredients.

To demonstrate the effects of ultrasound treatment on fiber particles, unprocessed soy milk base samples were subjected to ultrasonic energy, and the resulting particle morphology was analyzed. Soy milk generally includes about 7.5% by weight total solids, which include soluble soy fiber.

The fiber content in soy milk can result in a grainy or gritty mouthifeel, but the complete removal of the soy fiber from the soy milk is virtually impossible on a commercial scale using modern manufacturing techniques, such as extrusion. Because of the solids content, it is difficult to keep the continuous and dispersed phases in a stable emulsion, which is why most soy milk and other soy beverages must be shaken well prior to consumption. The addition of emulsifiers to soy milk can help alleviate the problems, but due to consumers' negative perceptions of emulsifiers and stabilizers, and the view that soy milk is a health food, an alternative solution is needed.

By using the ultrasonic treatment of the present invention, it has been discovered that ultrasound energy can be used to break up the fiber particles into smaller particles that have a significantly reduced impact on the mouthfeel of the soy milk product. The ultrasound treated soy milk product had a reduced grainy or gritty mouthfeel when compared to a commercially processed product. The use of ultrasound energy in accordance with the present invention will allow commercial soy milk producers to continue using conventional extrusion technology, but with a significant reduction of the adverse effects of the soy fiber content on the organoleptic properties of the soy milk.

The soy milk base was treated with ultrasound energy at a frequency of 24 kilohertz for the time periods shown in the Tables below. The treated soy milk product was then evaluated for the particle morphology parameters described above, at both the micron and sub-nicron levels to fully understand the effects of ultrasonication on fiber molecules. The results of the particle morphology analysis of the soy milk product are summarized in Table 1 below.

TABLE 1
Summary of Soy Milk Particle Morphology Analysis

| | | ESD | | AR | | Sphericity | | Shape | |
|---|---|---|---|---|---|---|---|---|---|
| Count | Sample Name | Ave | StdDev | Ave | StdDev | Ave | StdDev | Ave | StdDev |
| 1098 | Organic Soybase | 11.787 | 12.513 | 0.713 | 0.171 | 0.643 | 0.211 | 0.260 | 0.042 |
| 1240 | Soybase 140 F. 15 Sec | 11.345 | 8.417 | 0.633 | 0.174 | 0.551 | 0.206 | 0.260 | 0.040 |
| 1071 | Soybase 140 F. 5 Sec | 22.999 | 23.605 | 0.652 | 0.167 | 0.459 | 0.202 | 0.237 | 0.051 |
| 1049 | Soybase 40 F. 15 Sec | 22.183 | 26.430 | 0.657 | 0.171 | 0.554 | 0.192 | 0.237 | 0.053 |
| 1089 | Soybase 40 F. 5 Sec | 16.821 | 15.829 | 0.665 | 0.186 | 0.663 | 0.212 | 0.244 | 0.037 |
| 1099 | Soybase Raw Control | 11.088 | 8.033 | 0.641 | 0.176 | 0.557 | 0.211 | 0.263 | 0.040 |

The sample names for the ultrasound treated samples indicate the temperature of the sample and the amount of time of the ultrasound treatment. The control sample which was treated in a conventional homogenization system is labeled “Organic Soybase”, and the sample labeled “soybase raw control” is non-processed soybase.

Overall, in general, the equivalent spherical diameter increased, while the aspect ratio, sphericity, and shape parameter decreased, upon ultrasound treatment, as compared to the “Organic Soybase” sample. A sub-micron level analysis was done on the samples, and the results are summarized in Table 2.

TABLE 2
Sub-micron Analysis Summary of Soy Milk Particles

| Sample | Count | <0.25μ | <0.50μ | <1.0μ | % < .25 | % < .5 | % < 1.0 |
|---|---|---|---|---|---|---|---|
| Organic | 1098 | 1 | 1 | 2 | 0.09 | 0.09 | 0.18 |
| Soybase | | | | | | | |
| Soybase | 1240 | 1 | 1 | 5 | 0.08 | 0.08 | 0.40 |
| 140 F. | | | | | | | |
| 15 s | | | | | | | |
| Soybase | 1071 | 0 | 0 | 1 | 0.00 | 0.00 | 0.09 |
| 140 F. 5 s | | | | | | | |
| Soybase | 1049 | 0 | 0 | 1 | 0.00 | 0.00 | 0.10 |
| 40 F. 15 s | | | | | | | |
| Soybase | 1089 | 0 | 0 | 1 | 0.00 | 0.00 | 0.09 |
| 40 F. 5 s | | | | | | | |
| Soybase | 1099 | 1 | 3 | 6 | 0.09 | 0.27 | 0.55 |
| Raw | | | | | | | |

The data summarized in the foregoing tables show that upon ultrasound treatment, the particles in soy milk, which are primarily fibers, show an increase in equivalent spherical diameter, and a decrease in the number of sub-micron particles. While not intending to be bound by theory, it is believed that the ultrasound treatment causes a rupture of the larger fiber particles and a swelling of the smaller fiber particles, resulting in a more uniform particle distribution. Due to these effects on the fiber particles, the fiber component of the soy milk becomes less dense and occupies a greater volume. The ultrasound treatment is also believed to make the surface of the fiber particles smoother. These combined effects on the soy milk fiber particles results in a smoother, less gritty mouthfeel, as compared to a traditionally homogenized soy milk product.

### Example 3

### Treatment of Carbohydrate in Beverage Products

Many beverages, such as sports drinks or liquid electrolyte supplements, require a significant amount of stabilizers to maintain the fluidity and smoothness of such beverages over the course of their shelf life. Problems with consumer acceptability can occur when the ingredients, such as sugars or other carbohydrates, of such beverages begin to separate or even precipitate out of solution. In fact, for some of these products, such separation results in the products becoming less effective for their intended purpose, such as for replenishing electrolytes lost during dehydration caused by perspiration or an upset stomach. However, there is a growing consumer desire for products containing lower levels of stabilizers, so a need exists to be able to provide a stable beverage product that contains a lower level of stabilizers and yet remains suitably stable for consumer use.

The ultrasonic treatment system of the present invention is believed to overcome many of these problems due to the effects of ultrasound energy on the ingredients of such beverages. It has been surprisingly discovered that the use of the ultrasonic treatment system of the present invention allows the use of a lower level of stabilizers than in products processed using conventional homogenization methods, while maintaining the shelf life and desired organoleptic properties of conventionally homogenized products.

To demonstrate the effects of ultrasound treatment on beverages, unprocessed beverage base was subjected to ultrasonic energy and the resulting particle morphology was evaluated.

By using the ultrasonic treatment system of the present invention, it has been discovered that ultrasound energy can be used to stabilize beverages with about half the amount of stabilizers needed in conventionally treated beverage products. The ultrasound treated beverages had the same stability and desired organoleptic properties as a conventionally stabilized beverage product, but were able to be made with about 50% less stabilizer In the formula The reduction in the amount of stabilizers that needed to be added is an improvement not only from the consumer perspective standpoint, but also from the standpoint of reducing costs for the manufacturer.

While not intending to be bound by theory, it is believed that the ultrasound treatment of carbohydrate-containing beverages results in increasing the useful surface area of the carbohydrates, particularly the high molecular weight carbohydrates. As a result, the functionality of the carbohydrates is increased, which changes the wetting properties of the carbohydrate slurries, which, in turn, improves the adherence properties of the slurry. The slurry therefore “adheres” more readily to the aqueous medium, such as a sport beverage. As a result, beverages containing carbohydrates have an increased stability and require the addition of less stabilizer ingredients to remain stable over the desired period of time.

Although this evaluation was conducted on beverages, it is believed that the same ultrasound treatment effects on carbohydrates could be useful in other carbohydrate slurries, such as those used for coating food or other products. It is believed that the ultrasound treatment in accordance with the present invention will also improve the appearance of carbohydrate-containing products, such as cereal coatings or adhesives.

### Example 4

### Treatment of Fruit and Vegetable Cellular Components

Pulp-free fruit or vegetable juices, such as orange juice, often suffer from the consumer perception of cellular pulp residue remaining in the mouth. Consumers who purchase pulp-free fruit juices do so to for the smoothness of the product and to avoid the feeling of a cellular coating or remains in the mouth after drinking the juice.

Using the ultrasonic treatment system of the present invention, it has been found that the perception of the cellular content of fruit juices can be significantly reduced without adversely affecting the organoleptic properties of the juice. The juice products treated with ultrasound energy are smoother and more organoleptically pleasing than control products. Typically, fruit juices are not homogenized because of the issues associated with the fruit juice components plugging the homogenizing equipment. By using the present invention, however, it is possible to achieve the desirable results of to homogenization, but without the concomitant difficulties in processing products such as fruit juice.

To demonstrate the effects of ultrasound treatment on juice products, unprocessed pulp-free orange juice was subjected to ultrasonic energy, and the particle morphology was analyzed as described below.

By using the ultrasonic treatment system of the present invention, it has been discovered that ultrasound energy can be used to treat juice products to reduce the perception of the juice's natural cellular content without adverse effects on the organoleptic properties of the juice. It is believed that the ultrasound energy breaks down the pulp cell walls into smaller, uniform particles that are not as readily detected upon consumption.

The orange juice was treated with ultrasound energy at a frequency of 24 kilohertz for the time periods specified. The treated orange juice product was then evaluated for the particle morphology parameters described above, at both the micron and sub-micron levels to fully understand the effects of ultrasonication on the solid particles.

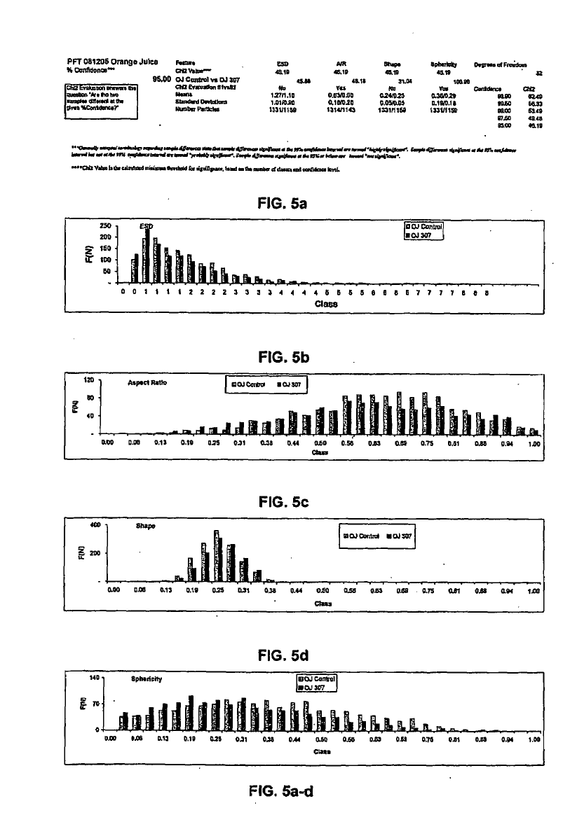

FIGS. 5a-d show the results of the particle morphology analysis of the orange juice product. Overall, the equivalent spherical diameter, the aspect ratio and the sphericity decreased, while the shape parameter increased, compared to a control orangejuice product sample that was processed using conventional homogenization techniques.

In this example, the mean equivalent spherical diameter decreased by about 13.4% compared to the control, the mean aspect ratio decreased by about 4.76% compared to the control, and the mean sphericity decreased by about 19.4% compared to the control, while the mean shape parameter increased by about 4.2% as compared to the control.

A sub-micron level analysis was done to determine the number of particles having a mean equivalent spherical diameter of less than 1 micron, less than 0.5 micron, and less than 0.25 micron. The results are summarized in Table 3, which shows the count, or number of particles of a given equivalent spherical diameter in a prescribed area, the number of particles having an equivalent spherical diameter less than the given value and the percentage of particles that had an equivalent spherical diameter less than the given value.

TABLE 3
Summary of Sub-micron Particle Analysis

| Sample | Count | <0.25μ | <0.50μ | <1.0μ | % < 0.25μ | % < 0.5μ | % < 1.0μ |
|---|---|---|---|---|---|---|---|
| Control | 1331 | 101 | 295 | 645 | 7.59 | 22.16 | 48.46 |
| Treated | 1159 | 126 | 362 | 649 | 10.87 | 31.23 | 56.00 |

As seen in the foregoing data, there was a significant increase in number of particles having an equivalent spherical diameter of less than 1 micron when the samples were treated with ultrasound energy, as compared to the sub-micron analysis of the untreated control sample.

While not intending to be bound by theory, it is believed that this increase in the number of particles having a mean equivalent spherical diameter of less than about 1 micron, for cellular-fragment containing products, such as orange juice, treated with ultrasound energy, results in a significant reduction in the perception of cellular residue associated with juice products that are treated in commercial homogenization systems.

### Example 5

### Treatment of Corn Starch

To determine starch particle morphological characteristics that produce increased yields of fermentable sugars and ethanol in a dry mill fermentation process, slurries of milled corn were subjected to ultrasonication under a variety of conditions. The ultraonsonication was carried out with a Hielscher UIP 1000 ultrasonic processor, using a 20 cm bead. A BS2d22 sonotrode with 2.2 cm diameter and 3.8 cm² surface area was used in a D100LK-1S flow cell which has a sonic control volume of 1.5 cn³. The flow rate was about 2 liters per minute to produce a residence time of about 0.036 seconds under the sonotrode. The system pressure was 5 PSIG, and the temperature in the sonic unit was 174° F. The milled corn kernels were mixed in an aqueous solution to produce a mixture that was 32% solid, with 67% starch, which was at a pH of 7.3.

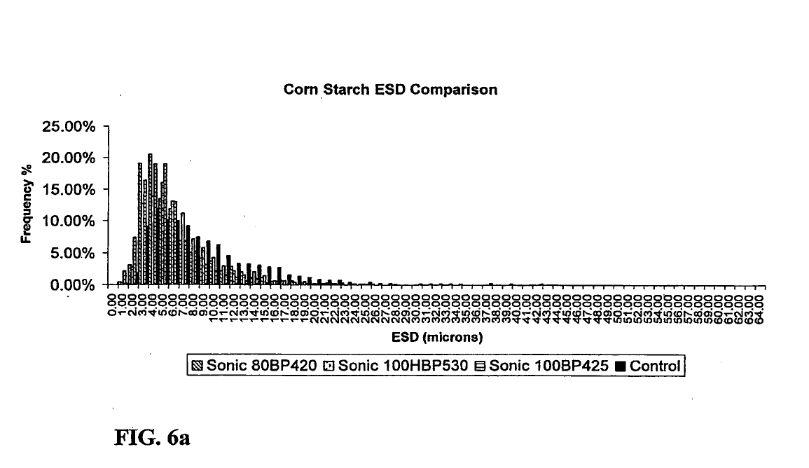

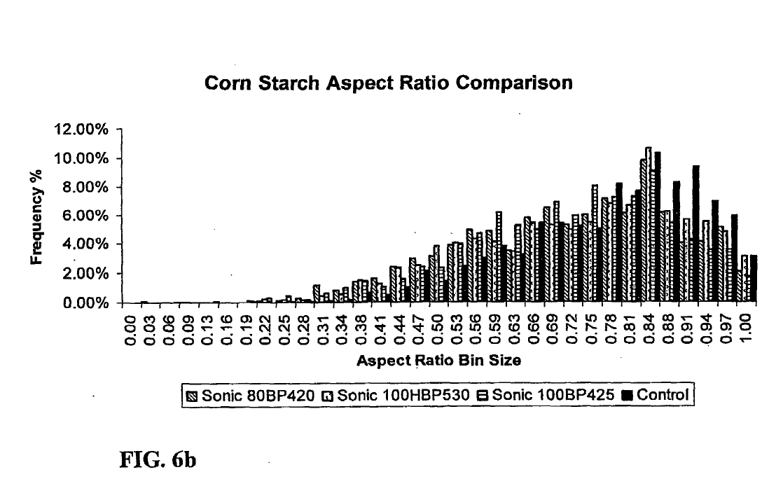

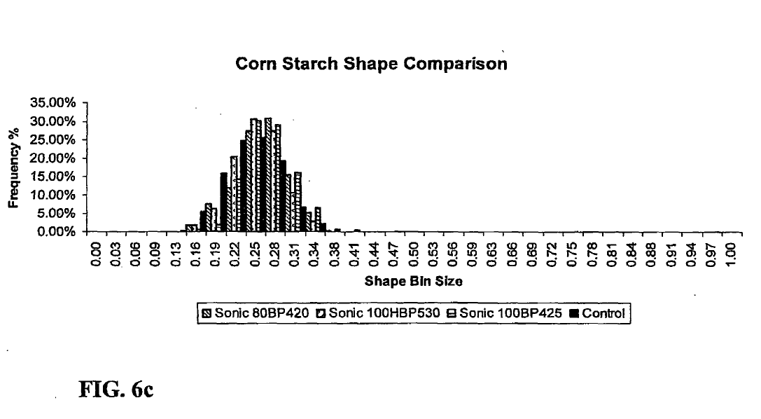

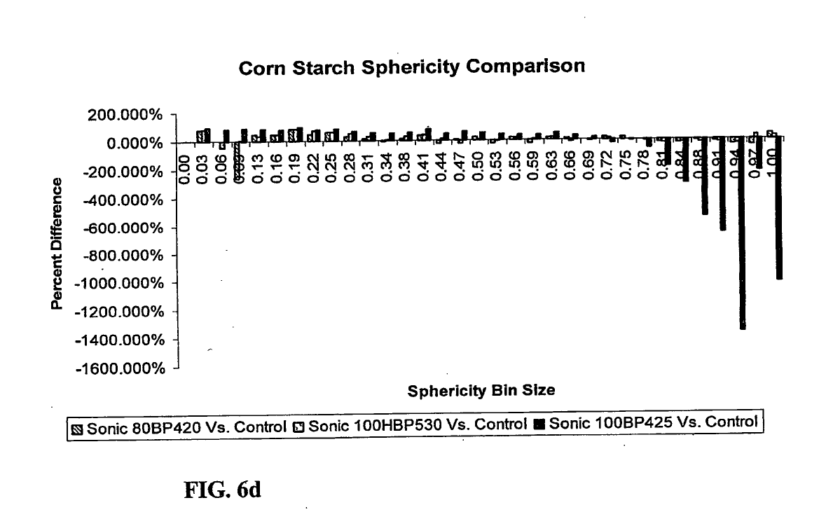

The amplitude and power delivered and the backpressure of the system were varied between different experiments. For the data shown in Table 4 through Table 7 as well as in FIGS. 6a-d, the amplitude for sample A (A Sonic 80% Amp. & 420 Watts W/BP) was 46 micrometers, with 420 watts delivered to the sample to produce an intensity of 111 watts/cm². For sample A the back pressure was 25 PSIG. The amplitude for sample B (A Sonic 100% Amp. & 530 Watts W/HBP) was 57 micrometers, with 530 watts delivered to the sample to produce an intensity of 139 watts/cm². For sample B the back pressure was 50 PSIG. The amplitude for sample C (B Sonic 100% Amp. & 425 Watts W/BP) was 57 micrometers, with 425 watts delivered to the sample to produce an intensity of 112 watts/cm². For sample C the back pressure was 25 PSIG The control sample was run through the system without, the delivery of power or back pressure. The data shown in Tables 8-19 were obtained using the amplitude, power and back pressure indicated at the top of each column.

TABLE 4
Corn ESD Analysis

| | | | A Sonic 80% | | A Sonic | | | |
|---|---|---|---|---|---|---|---|---|
| | | | Amp. & | | 100% Amp. | | B Sonic 100% | |
| | | | 420 Watts W/ | | & 530 Watts W/ | | Amp. & 425 | |
| | A Control ESD | | BP ESD | | HBP ESD | | Watts W/ BP | |
| Class | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% |
| 1.00 | 3 | 0.17% | 6 | 0.37% | 5 | 0.29% | 34 | 2.06% |
| 2.00 | 32 | 1.80% | 48 | 2.99% | 48 | 2.76% | 122 | 7.40% |
| 3.00 | 164 | 9.22% | 307 | 19.13% | 222 | 12.77% | 270 | 16.37% |
| 4.00 | 214 | 12.03% | 329 | 20.50% | 241 | 13.87% | 314 | 19.04% |
| 5.00 | 180 | 10.12% | 217 | 13.52% | 278 | 16.00% | 314 | 19.04% |
| 6.00 | 178 | 10.01% | 191 | 11.90% | 228 | 13.12% | 215 | 13.04% |
| 7.00 | 163 | 9.16% | 111 | 6.92% | 194 | 11.16% | 114 | 6.91% |
| 8.00 | 134 | 7.53% | 81 | 5.05% | 126 | 7.25% | 86 | 5.22% |
| 9.00 | 121 | 6.80% | 66 | 4.11% | 101 | 5.81% | 51 | 3.09% |
| 10.00 | 111 | 6.24% | 59 | 3.68% | 74 | 4.26% | 35 | 2.12% |
| 11.00 | 82 | 4.61% | 34 | 2.12% | 51 | 2.93% | 24 | 1.46% |
| 12.00 | 58 | 3.26% | 45 | 2.80% | 38 | 2.19% | 18 | 1.09% |
| 13.00 | 56 | 3.15% | 31 | 1.93% | 26 | 1.50% | 10 | 0.61% |
| 14.00 | 53 | 2.98% | 18 | 1.12% | 34 | 1.96% | 16 | 0.97% |
| 15.00 | 48 | 2.70% | 18 | 1.12% | 24 | 1.38% | 5 | 0.30% |
| 16.00 | 46 | 2.59% | 7 | 0.44% | 10 | 0.58% | 8 | 0.49% |
| 17.00 | 26 | 1.46% | 9 | 0.56% | 9 | 0.52% | 1 | 0.06% |
| 18.00 | 23 | 1.29% | 9 | 0.56% | 7 | 0.40% | 2 | 0.12% |
| 19.00 | 20 | 1.12% | 4 | 0.25% | 8 | 0.46% | 3 | 0.18% |
| 20.00 | 13 | 0.73% | 1 | 0.06% | 3 | 0.17% | 1 | 0.06% |
| 21.00 | 11 | 0.62% | 3 | 0.19% | 3 | 0.17% | 4 | 0.24% |
| 22.00 | 11 | 0.62% | 3 | 0.19% | 4 | 0.23% | 1 | 0.06% |
| 23.00 | 6 | 0.34% | 4 | 0.25% | 0 | 0.00% | 0 | 0.00% |
| 24.00 | 1 | 0.06% | 2 | 0.12% | 2 | 0.12% | 0 | 0.00% |
| 25.00 | 7 | 0.39% | 1 | 0.06% | 1 | 0.06% | 1 | 0.06% |
| 26.00 | 4 | 0.22% | 1 | 0.06% | 0 | 0.00% | 0 | 0.00% |
| 27.00 | 3 | 0.17% | 0 | 0.00% | 0 | 0.00% | 0 | 0.00% |
| 28.00 | 0 | 0.00% | 0 | 0.00% | 1 | 0.06% | 0 | 0.00% |
| 29.00 | 0 | 0.00% | 0 | 0.00% | 0 | 0.00% | 0 | 0.00% |
| 30.00 | 1 | 0.06% | 0 | 0.00% | 0 | 0.00% | 0 | 0.00% |
| 31.00 | 2 | 0.11% | 0 | 0.00% | 0 | 0.00% | 0 | 0.00% |
| 32.00 | 1 | 0.06% | 0 | 0.00% | 0 | 0.00% | 0 | 0.00% |
| 33.00 | 1 | 0.06% | 0 | 0.00% | 0 | 0.00% | 0 | 0.00% |
| 34.00 | 1 | 0.06% | 0 | 0.00% | 0 | 0.00% | 0 | 0.00% |
| 35.00 | 0 | 0.00% | 0 | 0.00% | 0 | 0.00% | 0 | 0.00% |
| 36.00 | 0 | 0.00% | 0 | 0.00% | 0 | 0.00% | 0 | 0.00% |
| 37.00 | 3 | 0.17% | 0 | 0.00% | 0 | 0.00% | 0 | 0.00% |
| 38.00 | 0 | 0.00% | 0 | 0.00% | 0 | 0.00% | 0 | 0.00% |
| 39.00 | 1 | 0.06% | 0 | 0.00% | 0 | 0.00% | 0 | 0.00% |
| 40.00 | 0 | 0.00% | 0 | 0.00% | 0 | 0.00% | 0 | 0.00% |
| 41.00 | 0 | 0.00% | 0 | 0.00% | 0 | 0.00% | 0 | 0.00% |
| 42.00 | 1 | 0.06% | 0 | 0.00% | 0 | 0.00% | 0 | 0.00% |
| 43.00 | 0 | 0.00% | 0 | 0.00% | 0 | 0.00% | 0 | 0.00% |
| 44.00 | 0 | 0.00% | 0 | 0.00% | 0 | 0.00% | 0 | 0.00% |
| 45.00 | 0 | 0.00% | 0 | 0.00% | 0 | 0.00% | 0 | 0.00% |
| 46.00 | 0 | 0.00% | 0 | 0.00% | 0 | 0.00% | 0 | 0.00% |
| 47.00 | 0 | 0.00% | 0 | 0.00% | 0 | 0.00% | 0 | 0.00% |
| 48.00 | 0 | 0.00% | 0 | 0.00% | 0 | 0.00% | 0 | 0.00% |
| 49.00 | 0 | 0.00% | 0 | 0.00% | 0 | 0.00% | 0 | 0.00% |
| 50.00 | 0 | 0.00% | 0 | 0.00% | 0 | 0.00% | 0 | 0.00% |
| 51.00 | 0 | 0.00% | 0 | 0.00% | 0 | 0.00% | 0 | 0.00% |
| 52.00 | 0 | 0.00% | 0 | 0.00% | 0 | 0.00% | 0 | 0.00% |
| 53.00 | 0 | 0.00% | 0 | 0.00% | 0 | 0.00% | 0 | 0.00% |
| 54.00 | 0 | 0.00% | 0 | 0.00% | 0 | 0.00% | 0 | 0.00% |
| 55.00 | 0 | 0.00% | 0 | 0.00% | 0 | 0.00% | 0 | 0.00% |
| 56.00 | 0 | 0.00% | 0 | 0.00% | 0 | 0.00% | 0 | 0.00% |
| 57.00 | 0 | 0.00% | 0 | 0.00% | 0 | 0.00% | 0 | 0.00% |
| 58.00 | 0 | 0.00% | 0 | 0.00% | 0 | 0.00% | 0 | 0.00% |
| 59.00 | 0 | 0.00% | 0 | 0.00% | 0 | 0.00% | 0 | 0.00% |
| 60.00 | 0 | 0.00% | 0 | 0.00% | 0 | 0.00% | 0 | 0.00% |
| 61.00 | 0 | 0.00% | 0 | 0.00% | 0 | 0.00% | 0 | 0.00% |
| 62.00 | 0 | 0.00% | 0 | 0.00% | 0 | 0.00% | 0 | 0.00% |
| 63.00 | 0 | 0.00% | 0 | 0.00% | 0 | 0.00% | 0 | 0.00% |
| 64.00 | 0 | 0.00% | 0 | 0.00% | 0 | 0.00% | 0 | 0.00% |
| | 1779 | 100.00% | 1605 | 100.00% | 1738 | 100.00% | 1649 | 100.00% |

TABLE 5
Corn Sphericity Analysis

| | | | A Sonic | | A Sonic | | B Sonic 100% | |
|---|---|---|---|---|---|---|---|---|
| | | | 80% Amp. & | | 100% Amp. | | Amp. & 425 | |
| | A Control | | 420 Watts W/ BP | | & 530 Watts W/ | | Watts W/ BP | |
| | Sphericity | | Sphericity | | HBP Sphericity | | Sphericity | |
| Class | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% |
| 0.03 | 1 | 0.06% | 4 | 0.25% | 5 | 0.29% | 16 | 0.97% |
| 0.06 | 3 | 0.17% | 0 | 0.00% | 2 | 0.12% | 16 | 0.97% |
| 0.09 | 4 | 0.23% | 1 | 0.06% | 4 | 0.23% | 31 | 1.88% |
| 0.13 | 5 | 0.28% | 8 | 0.50% | 7 | 0.40% | 26 | 1.58% |
| 0.16 | 7 | 0.39% | 11 | 0.69% | 12 | 0.69% | 29 | 1.76% |
| 0.19 | 4 | 0.23% | 22 | 1.37% | 20 | 1.15% | 44 | 2.67% |
| 0.22 | 9 | 0.51% | 15 | 0.94% | 30 | 1.73% | 41 | 2.49% |
| 0.25 | 10 | 0.56% | 24 | 1.50% | 24 | 1.38% | 49 | 2.97% |
| 0.28 | 17 | 0.96% | 21 | 1.31% | 33 | 1.90% | 44 | 2.67% |
| 0.31 | 25 | 1.41% | 25 | 1.56% | 33 | 1.90% | 55 | 3.34% |
| 0.34 | 26 | 1.46% | 22 | 1.37% | 26 | 1.50% | 47 | 2.85% |
| 0.38 | 26 | 1.46% | 26 | 1.62% | 35 | 2.02% | 54 | 3.27% |
| 0.41 | 19 | 1.07% | 25 | 1.56% | 29 | 1.67% | 77 | 4.67% |
| 0.44 | 43 | 2.42% | 31 | 1.94% | 48 | 2.77% | 71 | 4.31% |
| 0.47 | 35 | 1.97% | 34 | 2.12% | 28 | 1.61% | 82 | 4.97% |
| 0.50 | 39 | 2.20% | 44 | 2.75% | 40 | 2.31% | 75 | 4.55% |
| 0.53 | 55 | 3.10% | 40 | 2.50% | 51 | 2.94% | 84 | 5.09% |
| 0.56 | 50 | 2.82% | 53 | 3.31% | 57 | 3.29% | 69 | 4.18% |
| 0.59 | 52 | 2.93% | 38 | 2.37% | 54 | 3.11% | 70 | 4.24% |
| 0.63 | 55 | 3.10% | 58 | 3.62% | 66 | 3.80% | 101 | 6.12% |
| 0.66 | 66 | 3.72% | 65 | 4.06% | 59 | 3.40% | 85 | 5.15% |
| 0.69 | 87 | 4.90% | 79 | 4.93% | 82 | 4.73% | 96 | 5.82% |
| 0.72 | 92 | 5.18% | 98 | 6.12% | 99 | 5.71% | 70 | 4.24% |
| 0.75 | 87 | 4.90% | 92 | 5.75% | 83 | 4.78% | 78 | 4.73% |
| 0.78 | 131 | 7.38% | 116 | 7.25% | 122 | 7.03% | 79 | 4.79% |
| 0.81 | 173 | 9.75% | 132 | 8.24% | 135 | 7.78% | 57 | 3.46% |
| 0.84 | 194 | 10.93% | 143 | 8.93% | 163 | 9.39% | 44 | 2.67% |
| 0.88 | 221 | 12.45% | 187 | 11.68% | 180 | 10.37% | 32 | 1.94% |
| 0.91 | 131 | 7.38% | 105 | 6.56% | 110 | 6.34% | 16 | 0.97% |
| 0.94 | 79 | 4.45% | 53 | 3.31% | 60 | 3.46% | 5 | 0.30% |
| 0.97 | 17 | 0.96% | 11 | 0.69% | 23 | 1.33% | 5 | 0.30% |
| 1.00 | 12 | 0.68% | 18 | 1.12% | 15 | 0.86% | 1 | 0.06% |
| | 1775 | 100.00% | 1601 | 100.00% | 1735 | 100.00% | 1649 | 100.00% |

TABLE 6
Corn Shape Analysis

| | | | A Sonic | | A Sonic | | B Sonic 100% | |
|---|---|---|---|---|---|---|---|---|
| | | | 80% Amp. & | | 100% Amp. | | Amp. & 425 | |
| | A Control | | 420 Watts W/ BP | | & 530 Watts W/ | | watts W/ BP | |
| | Shape | | Shape | | HBP Shape | | Shape | |
| Class | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% |
| 0.03 | 0 | 0.00% | 0 | 0.00% | 0 | 0.00% | 0 | 0.00% |
| 0.06 | 0 | 0.00% | 0 | 0.00% | 0 | 0.00% | 0 | 0.00% |
| 0.09 | 0 | 0.00% | 0 | 0.00% | 0 | 0.00% | 0 | 0.00% |
| 0.13 | 2 | 0.11% | 0 | 0.00% | 1 | 0.06% | 0 | 0.00% |
| 0.16 | 96 | 5.40% | 27 | 1.68% | 29 | 1.67% | 9 | 0.55% |
| 0.19 | 284 | 15.96% | 122 | 7.60% | 109 | 6.27% | 34 | 2.06% |
| 0.22 | 440 | 24.73% | 193 | 12.02% | 355 | 20.43% | 238 | 14.43% |
| 0.25 | 455 | 25.58% | 439 | 27.35% | 534 | 30.72% | 499 | 30.26% |
| 0.28 | 343 | 19.28% | 494 | 30.78% | 476 | 27.39% | 480 | 29.11% |
| 0.31 | 121 | 6.80% | 246 | 15.33% | 184 | 10.59% | 266 | 16.13% |
| 0.34 | 37 | 2.08% | 82 | 5.11% | 49 | 2.82% | 108 | 6.55% |
| 0.38 | 1 | 0.06% | 2 | 0.12% | 1 | 0.06% | 9 | 0.55% |
| 0.41 | 0 | 0.00% | 0 | 0.00% | 0 | 0.00% | 6 | 0.36% |
| 0.44 | 0 | 0.00% | 0 | 0.00% | 0 | 0.00% | 0 | 0.00% |
| 0.47 | 0 | 0.00% | 0 | 0.00% | 0 | 0.00% | 0 | 0.00% |
| 0.50 | 0 | 0.00% | 0 | 0.00% | 0 | 0.00% | 0 | 0.00% |
| 0.53 | 0 | 0.00% | 0 | 0.00% | 0 | 0.00% | 0 | 0.00% |
| 0.56 | 0 | 0.00% | 0 | 0.00% | 0 | 0.00% | 0 | 0.00% |
| 0.59 | 0 | 0.00% | 0 | 0.00% | 0 | 0.00% | 0 | 0.00% |
| 0.63 | 0 | 0.00% | 0 | 0.00% | 0 | 0.00% | 0 | 0.00% |
| 0.66 | 0 | 0.00% | 0 | 0.00% | 0 | 0.00% | 0 | 0.00% |
| 0.69 | 0 | 0.00% | 0 | 0.00% | 0 | 0.00% | 0 | 0.00% |
| 0.72 | 0 | 0.00% | 0 | 0.00% | 0 | 0.00% | 0 | 0.00% |
| 0.75 | 0 | 0.00% | 0 | 0.00% | 0 | 0.00% | 0 | 0.00% |
| 0.78 | 0 | 0.00% | 0 | 0.00% | 0 | 0.00% | 0 | 0.00% |
| 0.81 | 0 | 0.00% | 0 | 0.00% | 0 | 0.00% | 0 | 0.00% |
| 0.84 | 0 | 0.00% | 0 | 0.00% | 0 | 0.00% | 0 | 0.00% |
| 0.88 | 0 | 0.00% | 0 | 0.00% | 0 | 0.00% | 0 | 0.00% |
| 0.91 | 0 | 0.00% | 0 | 0.00% | 0 | 0.00% | 0 | 0.00% |
| 0.94 | 0 | 0.00% | 0 | 0.00% | 0 | 0.00% | 0 | 0.00% |
| 0.97 | 0 | 0.00% | 0 | 0.00% | 0 | 0.00% | 0 | 0.00% |
| 1.00 | 0 | 0.00% | 0 | 0.00% | 0 | 0.00% | 0 | 0.00% |
| | 1779 | 100.00% | 1605 | 100.00% | 1738 | 100.00% | 1649 | 100.00% |

TABLE 7
Corn Aspect Ratio Analysis

| | | | A Sonic | | A Sonic 100% | | B Sonic 100% | |
|---|---|---|---|---|---|---|---|---|
| | | | 80% Amp. & | | Amp. & 530 | | Amp. & 425 | |
| | A Control | | 420 Watts W/ BP | | Watts W/ HBP | | Watts W/ BP | |
| | Aspect Ratio | | Aspect Ratio | | Aspect Ratio | | Aspect Ratio | |
| Class | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% |
| 0.03 | 0 | 0.00% | 1 | 0.06% | 0 | 0.00% | 0 | 0.00% |
| 0.06 | 0 | 0.00% | 0 | 0.00% | 0 | 0.00% | 0 | 0.00% |
| 0.09 | 0 | 0.00% | 0 | 0.00% | 0 | 0.00% | 0 | 0.00% |
| 0.13 | 1 | 0.06% | 0 | 0.00% | 0 | 0.00% | 0 | 0.00% |
| 0.16 | 0 | 0.00% | 0 | 0.00% | 0 | 0.00% | 0 | 0.00% |
| 0.19 | 1 | 0.06% | 0 | 0.00% | 0 | 0.00% | 2 | 0.13% |
| 0.22 | 0 | 0.00% | 2 | 0.13% | 4 | 0.24% | 4 | 0.25% |
| 0.25 | 1 | 0.06% | 2 | 0.13% | 3 | 0.18% | 7 | 0.44% |
| 0.28 | 1 | 0.06% | 4 | 0.25% | 3 | 0.18% | 3 | 0.19% |
| 0.31 | 2 | 0.12% | 18 | 1.15% | 7 | 0.41% | 10 | 0.63% |
| 0.34 | 3 | 0.17% | 13 | 0.83% | 9 | 0.53% | 16 | 1.00% |
| 0.38 | 11 | 0.64% | 22 | 1.40% | 25 | 1.48% | 23 | 1.44% |
| 0.41 | 9 | 0.52% | 25 | 1.59% | 21 | 1.24% | 17 | 1.06% |
| 0.44 | 17 | 0.99% | 37 | 2.36% | 39 | 2.31% | 25 | 1.57% |
| 0.47 | 36 | 2.09% | 47 | 2.99% | 42 | 2.49% | 38 | 2.38% |
| 0.50 | 25 | 1.45% | 49 | 3.12% | 65 | 3.85% | 37 | 2.32% |
| 0.53 | 42 | 2.44% | 61 | 3.89% | 69 | 4.09% | 64 | 4.01% |
| 0.56 | 52 | 3.02% | 78 | 4.97% | 73 | 4.32% | 76 | 4.76% |
| 0.59 | 66 | 3.83% | 77 | 4.90% | 70 | 4.14% | 99 | 6.20% |
| 0.63 | 56 | 3.25% | 55 | 3.50% | 59 | 3.49% | 84 | 5.26% |
| 0.66 | 94 | 5.46% | 92 | 5.86% | 92 | 5.45% | 80 | 5.01% |
| 0.69 | 94 | 5.46% | 103 | 6.56% | 90 | 5.33% | 111 | 6.95% |
| 0.72 | 91 | 5.28% | 84 | 5.35% | 85 | 5.03% | 96 | 6.01% |
| 0.75 | 87 | 5.05% | 95 | 6.05% | 93 | 5.51% | 129 | 8.08% |
| 0.78 | 141 | 8.18% | 112 | 7.13% | 115 | 6.81% | 116 | 7.26% |
| 0.81 | 133 | 7.72% | 97 | 6.18% | 113 | 6.69% | 117 | 7.33% |
| 0.84 | 178 | 10.33% | 155 | 9.87% | 180 | 10.66% | 146 | 9.14% |
| 0.88 | 143 | 8.30% | 98 | 6.24% | 106 | 6.28% | 87 | 5.45% |
| 0.91 | 162 | 9.40% | 64 | 4.08% | 97 | 5.74% | 69 | 4.32% |
| 0.94 | 120 | 6.96% | 66 | 4.20% | 94 | 5.57% | 57 | 3.57% |
| 0.97 | 103 | 5.98% | 81 | 5.16% | 82 | 4.85% | 57 | 3.57% |
| 1.00 | 54 | 3.13% | 32 | 2.04% | 53 | 3.14% | 27 | 1.69% |
| | 1723 | 100.00% | 1570 | 100.00% | 1689 | 100.00% | 1597 | 100.00% |

TABLE 8
Corn ESD Analysis

| | | | | | A Sonic | | | | A Sonic 100% | |
|---|---|---|---|---|---|---|---|---|---|---|
| | | | A Sonic 80% | | 100% Amp. | | A Sonic 100% | | Amp. & | |
| | A Control | | Amp. & 420 | | & 412 Watts | | Amp. & 490 | | 530 Watts | |
| | ESD | | Watts W/ BP | | W/NO BP | | Watts W/ BP | | W/ HBP | |
| Class | F(n) | F(n) % | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% | 0 | 0.00% |
| 1.00 | 3 | 0.17% | 6 | 0.37% | 18 | 1.09% | 3 | 0.18% | 5 | 0.29% |
| 2.00 | 32 | 1.80% | 48 | 2.99% | 66 | 4.01% | 27 | 1.58% | 48 | 2.76% |
| 3.00 | 164 | 9.22% | 307 | 19.13% | 157 | 9.54% | 194 | 11.33% | 222 | 12.77% |
| 4.00 | 214 | 12.03% | 329 | 20.50% | 220 | 13.37% | 281 | 16.40% | 241 | 13.87% |
| 5.00 | 180 | 10.12% | 217 | 13.52% | 224 | 13.62% | 268 | 15.65% | 278 | 16.00% |
| 6.00 | 178 | 10.01% | 191 | 11.90% | 227 | 13.80% | 238 | 13.89% | 228 | 13.12% |
| 7.00 | 163 | 9.16% | 111 | 6.92% | 209 | 12.71% | 162 | 9.46% | 194 | 11.16% |
| 8.00 | 134 | 7.53% | 81 | 5.05% | 132 | 8.02% | 108 | 6.30% | 126 | 7.25% |
| 9.00 | 121 | 6.80% | 66 | 4.11% | 102 | 6.20% | 68 | 3.97% | 101 | 5.81% |
| 10.00 | 111 | 6.24% | 59 | 3.68% | 58 | 3.53% | 56 | 3.27% | 74 | 4.26% |
| 11.00 | 82 | 4.61% | 34 | 2.12% | 44 | 2.67% | 47 | 2.74% | 51 | 2.93% |
| 12.00 | 58 | 3.26% | 45 | 2.80% | 30 | 1.82% | 40 | 2.34% | 38 | 2.19% |
| 13.00 | 56 | 3.15% | 31 | 1.93% | 25 | 1.52% | 39 | 2.28% | 26 | 1.50% |
| 14.00 | 53 | 2.98% | 18 | 1.12% | 20 | 1.22% | 25 | 1.46% | 34 | 1.96% |
| 15.00 | 48 | 2.70% | 18 | 1.12% | 15 | 0.91% | 28 | 1.63% | 24 | 1.38% |
| 16.00 | 46 | 2.59% | 7 | 0.44% | 14 | 0.85% | 33 | 1.93% | 10 | 0.58% |
| 17.00 | 26 | 1.46% | 9 | 0.56% | 14 | 0.85% | 24 | 1.40% | 9 | 0.52% |
| 18.00 | 23 | 1.29% | 9 | 0.56% | 17 | 1.03% | 21 | 1.23% | 7 | 0.40% |
| 19.00 | 20 | 1.12% | 4 | 0.25% | 11 | 0.67% | 12 | 0.70% | 8 | 0.46% |
| 20.00 | 13 | 0.73% | 1 | 0.06% | 13 | 0.79% | 9 | 0.53% | 3 | 0.17% |
| 21.00 | 11 | 0.62% | 3 | 0.19% | 6 | 0.36% | 5 | 0.29% | 3 | 0.17% |
| 22.00 | 11 | 0.62% | 3 | 0.19% | 5 | 0.30% | 10 | 0.58% | 4 | 0.23% |
| 23.00 | 6 | 0.34% | 4 | 0.25% | 9 | 0.55% | 8 | 0.47% | 0 | 0.00% |
| 24.00 | 1 | 0.06% | 2 | 0.12% | 1 | 0.06% | 1 | 0.06% | 2 | 0.12% |
| 25.00 | 7 | 0.39% | 1 | 0.06% | 2 | 0.12% | 3 | 0.18% | 1 | 0.06% |
| 26.00 | 4 | 0.22% | 1 | 0.06% | 0 | 0.00% | 1 | 0.06% | 0 | 0.00% |
| 27.00 | 3 | 0.17% | 0 | 0.00% | 2 | 0.12% | 0 | 0.00% | 0 | 0.00% |
| 28.00 | 0 | 0.00% | 0 | 0.00% | 0 | 0.00% | 0 | 0.00% | 1 | 0.06% |
| 29.00 | 0 | 0.00% | 0 | 0.00% | 2 | 0.12% | 1 | 0.06% | 0 | 0.00% |
| 30.00 | 1 | 0.06% | 0 | 0.00% | 0 | 0.00% | 0 | 0.00% | 0 | 0.00% |
| 31.00 | 2 | 0.11% | 0 | 0.00% | 0 | 0.00% | 0 | 0.00% | 0 | 0.00% |
| 32.00 | 1 | 0.06% | 0 | 0.00% | 0 | 0.00% | 0 | 0.00% | 0 | 0.00% |
| 33.00 | 1 | 0.06% | 0 | 0.00% | 0 | 0.00% | 1 | 0.06% | 0 | 0.00% |
| 34.00 | 1 | 0.06% | 0 | 0.00% | 0 | 0.00% | 0 | 0.00% | 0 | 0.00% |
| 35.00 | 0 | 0.00% | 0 | 0.00% | 1 | 0.06% | 0 | 0.00% | 0 | 0.00% |
| 36.00 | 0 | 0.00% | 0 | 0.00% | 1 | 0.06% | 0 | 0.00% | 0 | 0.00% |
| 37.00 | 3 | 0.17% | 0 | 0.00% | 0 | 0.00% | 0 | 0.00% | 0 | 0.00% |
| 38.00 | 0 | 0.00% | 0 | 0.00% | 0 | 0.00% | 0 | 0.00% | 0 | 0.00% |
| 39.00 | 1 | 0.06% | 0 | 0.00% | 0 | 0.00% | 0 | 0.00% | 0 | 0.00% |
| 40.00 | 0 | 0.00% | 0 | 0.00% | 0 | 0.00% | 0 | 0.00% | 0 | 0.00% |
| 41.00 | 0 | 0.00% | 0 | 0.00% | 0 | 0.00% | 0 | 0.00% | 0 | 0.00% |
| 42.00 | 1 | 0.06% | 0 | 0.00% | 0 | 0.00% | 0 | 0.00% | 0 | 0.00% |
| 43.00 | 0 | 0.00% | 0 | 0.00% | 0 | 0.00% | 0 | 0.00% | 0 | 0.00% |
| 44.00 | 0 | 0.00% | 0 | 0.00% | 0 | 0.00% | 0 | 0.00% | 0 | 0.00% |
| 45.00 | 0 | 0.00% | 0 | 0.00% | 0 | 0.00% | 0 | 0.00% | 0 | 0.00% |
| 46.00 | 0 | 0.00% | 0 | 0.00% | 0 | 0.00% | 0 | 0.00% | 0 | 0.00% |
| 47.00 | 0 | 0.00% | 0 | 0.00% | 0 | 0.00% | 0 | 0.00% | 0 | 0.00% |
| 48.00 | 0 | 0.00% | 0 | 0.00% | 0 | 0.00% | 0 | 0.00% | 0 | 0.00% |
| 49.00 | 0 | 0.00% | 0 | 0.00% | 0 | 0.00% | 0 | 0.00% | 0 | 0.00% |
| 50.00 | 0 | 0.00% | 0 | 0.00% | 0 | 0.00% | 0 | 0.00% | 0 | 0.00% |
| 51.00 | 0 | 0.00% | 0 | 0.00% | 0 | 0.00% | 0 | 0.00% | 0 | 0.00% |
| 52.00 | 0 | 0.00% | 0 | 0.00% | 0 | 0.00% | 0 | 0.00% | 0 | 0.00% |
| 53.00 | 0 | 0.00% | 0 | 0.00% | 0 | 0.00% | 0 | 0.00% | 0 | 0.00% |
| 54.00 | 0 | 0.00% | 0 | 0.00% | 0 | 0.00% | 0 | 0.00% | 0 | 0.00% |
| 55.00 | 0 | 0.00% | 0 | 0.00% | 0 | 0.00% | 0 | 0.00% | 0 | 0.00% |
| 56.00 | 0 | 0.00% | 0 | 0.00% | 0 | 0.00% | 0 | 0.00% | 0 | 0.00% |
| 57.00 | 0 | 0.00% | 0 | 0.00% | 0 | 0.00% | 0 | 0.00% | 0 | 0.00% |
| 58.00 | 0 | 0.00% | 0 | 0.00% | 0 | 0.00% | 0 | 0.00% | 0 | 0.00% |
| 59.00 | 0 | 0.00% | 0 | 0.00% | 0 | 0.00% | 0 | 0.00% | 0 | 0.00% |
| 60.00 | 0 | 0.00% | 0 | 0.00% | 0 | 0.00% | 0 | 0.00% | 0 | 0.00% |
| 61.00 | 0 | 0.00% | 0 | 0.00% | 0 | 0.00% | 0 | 0.00% | 0 | 0.00% |
| 62.00 | 0 | 0.00% | 0 | 0.00% | 0 | 0.00% | 0 | 0.00% | 0 | 0.00% |
| 63.00 | 0 | 0.00% | 0 | 0.00% | 0 | 0.00% | 0 | 0.00% | 0 | 0.00% |
| 64.00 | 0 | 0.00% | 0 | 0.00% | 0 | 0.00% | 0 | 0.00% | 0 | 0.00% |
| | 1779 | 100.00% | 1605 | 100.00% | 1645 | 100.00% | 1713 | 100.00% | 1738 | 100.00% |

TABLE 9
Corn ESD Analysis

| | B Sonic | | B Sonic | | B Sonic | |
|---|---|---|---|---|---|---|
| | 60% Amp. & | | 80% Amp. & 295 | | 100% Amp. & | |
| | 276 Watts W/ BP | | Watts W/O BP | | 425 Watts W/ BP | |
| Class | F(n) | F(n) % | F(n) | F(n) % | F(n) | F(n) % |
| 0.00 | 0 | 0.00% | 0 | 0.00% | 0 | 0.00% |
| 1.00 | 33 | 2.01% | 15 | 0.90% | 34 | 2.06% |
| 2.00 | 75 | 4.57% | 60 | 3.59% | 122 | 7.40% |
| 3.00 | 197 | 12.01% | 191 | 11.44% | 270 | 16.37% |
| 4.00 | 170 | 10.37% | 271 | 16.23% | 314 | 19.04% |
| 5.00 | 201 | 12.26% | 260 | 15.57% | 314 | 19.04% |
| 6.00 | 183 | 11.16% | 232 | 13.89% | 215 | 13.04% |
| 7.00 | 151 | 9.21% | 179 | 10.72% | 114 | 6.91% |
| 8.00 | 105 | 6.40% | 128 | 7.66% | 86 | 5.22% |
| 9.00 | 89 | 5.43% | 69 | 4.13% | 51 | 3.09% |
| 10.00 | 66 | 4.02% | 62 | 3.71% | 35 | 2.12% |
| 11.00 | 85 | 5.18% | 62 | 3.71% | 24 | 1.46% |
| 12.00 | 65 | 3.96% | 34 | 2.04% | 18 | 1.09% |
| 13.00 | 55 | 3.35% | 17 | 1.02% | 10 | 0.61% |
| 14.00 | 47 | 2.87% | 14 | 0.84% | 16 | 0.97% |
| 15.00 | 32 | 1.95% | 25 | 1.50% | 5 | 0.30% |
| 16.00 | 23 | 1.40% | 6 | 0.36% | 8 | 0.49% |
| 17.00 | 17 | 1.04% | 7 | 0.42% | 1 | 0.06% |
| 18.00 | 11 | 0.67% | 11 | 0.66% | 2 | 0.12% |
| 19.00 | 8 | 0.49% | 4 | 0.24% | 3 | 0.18% |
| 20.00 | 4 | 0.24% | 10 | 0.60% | 1 | 0.06% |
| 21.00 | 7 | 0.43% | 4 | 0.24% | 4 | 0.24% |
| 22.00 | 3 | 0.18% | 1 | 0.06% | 1 | 0.06% |
| 23.00 | 5 | 0.30% | 2 | 0.12% | 0 | 0.00% |
| 24.00 | 1 | 0.06% | 1 | 0.06% | 0 | 0.00% |
| 25.00 | 3 | 0.18% | 1 | 0.06% | 1 | 0.06% |
| 26.00 | 1 | 0.06% | 2 | 0.12% | 0 | 0.00% |
| 27.00 | 0 | 0.00% | 0 | 0.00% | 0 | 0.00% |
| 28.00 | 0 | 0.00% | 1 | 0.06% | 0 | 0.00% |
| 29.00 | 1 | 0.06% | 0 | 0.00% | 0 | 0.00% |
| 30.00 | 1 | 0.06% | 1 | 0.06% | 0 | 0.00% |
| 31.00 | 0 | 0.00% | 0 | 0.00% | 0 | 0.00% |
| 32.00 | 0 | 0.00% | 0 | 0.00% | 0 | 0.00% |
| 33.00 | 0 | 0.00% | 0 | 0.00% | 0 | 0.00% |
| 34.00 | 0 | 0.00% | 0 | 0.00% | 0 | 0.00% |
| 35.00 | 0 | 0.00% | 0 | 0.00% | 0 | 0.00% |
| 36.00 | 0 | 0.00% | 0 | 0.00% | 0 | 0.00% |
| 37.00 | 0 | 0.00% | 0 | 0.00% | 0 | 0.00% |
| 38.00 | 1 | 0.06% | 0 | 0.00% | 0 | 0.00% |
| 39.00 | 0 | 0.00% | 0 | 0.00% | 0 | 0.00% |
| 40.00 | 0 | 0.00% | 0 | 0.00% | 0 | 0.00% |
| 41.00 | 0 | 0.00% | 0 | 0.00% | 0 | 0.00% |
| 42.00 | 0 | 0.00% | 0 | 0.00% | 0 | 0.00% |
| 43.00 | 0 | 0.00% | 0 | 0.00% | 0 | 0.00% |
| 44.00 | 0 | 0.00% | 0 | 0.00% | 0 | 0.00% |
| 45.00 | 0 | 0.00% | 0 | 0.00% | 0 | 0.00% |
| 46.00 | 0 | 0.00% | 0 | 0.00% | 0 | 0.00% |
| 47.00 | 0 | 0.00% | 0 | 0.00% | 0 | 0.00% |
| 48.00 | 0 | 0.00% | 0 | 0.00% | 0 | 0.00% |
| 49.00 | 0 | 0.00% | 0 | 0.00% | 0 | 0.00% |
| 50.00 | 0 | 0.00% | 0 | 0.00% | 0 | 0.00% |
| 51.00 | 0 | 0.00% | 0 | 0.00% | 0 | 0.00% |
| 52.00 | 0 | 0.00% | 0 | 0.00% | 0 | 0.00% |
| 53.00 | 0 | 0.00% | 0 | 0.00% | 0 | 0.00% |
| 54.00 | 0 | 0.00% | 0 | 0.00% | 0 | 0.00% |
| 55.00 | 0 | 0.00% | 0 | 0.00% | 0 | 0.00% |
| 56.00 | 0 | 0.00% | 0 | 0.00% | 0 | 0.00% |
| 57.00 | 0 | 0.00% | 0 | 0.00% | 0 | 0.00% |
| 58.00 | 0 | 0.00% | 0 | 0.00% | 0 | 0.00% |
| 59.00 | 0 | 0.00% | 0 | 0.00% | 0 | 0.00% |
| 60.00 | 0 | 0.00% | 0 | 0.00% | 0 | 0.00% |
| 61.00 | 0 | 0.00% | 0 | 0.00% | 0 | 0.00% |
| 62.00 | 0 | 0.00% | 0 | 0.00% | 0 | 0.00% |
| 63.00 | 0 | 0.00% | 0 | 0.00% | 0 | 0.00% |
| 64.00 | 0 | 0.00% | 0 | 0.00% | 0 | 0.00% |
| | 1640 | 100.00% | 1670 | 100.00% | 1649 | 100.00% |

TABLE 10
Corn ESD Analysis

| | |
|---|---|
| | C Sonic 100% |
| | Amp. & 415 |
| C Control | Watts W/O BP |

| Class | F(n) | F(n) % | F(n) | F(n) % |
|---|---|---|---|---|
| 0.00 | 0 | 0.00% | 0 | 0.00% |
| 1.00 | 12 | 0.72% | 14 | 0.84% |
| 2.00 | 46 | 2.78% | 87 | 5.22% |
| 3.00 | 99 | 5.98% | 345 | 20.68% |
| 4.00 | 128 | 7.73% | 347 | 20.80% |
| 5.00 | 150 | 9.06% | 307 | 18.41% |
| 6.00 | 149 | 9.00% | 198 | 11.87% |
| 7.00 | 135 | 8.15% | 114 | 6.83% |
| 8.00 | 112 | 6.76% | 85 | 5.10% |
| 9.00 | 86 | 5.19% | 59 | 3.54% |
| 10.00 | 96 | 5.80% | 37 | 2.22% |
| 11.00 | 84 | 5.07% | 19 | 1.14% |
| 12.00 | 71 | 4.29% | 23 | 1.38% |
| 13.00 | 79 | 4.77% | 6 | 0.36% |
| 14.00 | 73 | 4.41% | 8 | 0.48% |
| 15.00 | 62 | 3.74% | 5 | 0.30% |
| 16.00 | 58 | 3.50% | 2 | 0.12% |
| 17.00 | 47 | 2.84% | 2 | 0.12% |
| 18.00 | 36 | 2.17% | 2 | 0.12% |
| 19.00 | 28 | 1.69% | 4 | 0.24% |
| 20.00 | 17 | 1.03% | 0 | 0.00% |
| 21.00 | 20 | 1.21% | 0 | 0.00% |
| 22.00 | 15 | 0.91% | 0 | 0.00% |
| 23.00 | 16 | 0.97% | 1 | 0.06% |
| 24.00 | 9 | 0.54% | 0 | 0.00% |
| 25.00 | 4 | 0.24% | 0 | 0.00% |
| 26.00 | 4 | 0.24% | 0 | 0.00% |
| 27.00 | 3 | 0.18% | 1 | 0.06% |
| 28.00 | 6 | 0.36% | 1 | 0.06% |
| 29.00 | 3 | 0.18% | 0 | 0.00% |
| 30.00 | 1 | 0.06% | 0 | 0.00% |
| 31.00 | 1 | 0.06% | 0 | 0.00% |
| 32.00 | 1 | 0.06% | 1 | 0.06% |
| 33.00 | 1 | 0.06% | 0 | 0.00% |
| 34.00 | 1 | 0.06% | 0 | 0.00% |
| 35.00 | 1 | 0.06% | 0 | 0.00% |
| 36.00 | 0 | 0.00% | 0 | 0.00% |
| 37.00 | 0 | 0.00% | 0 | 0.00% |
| 38.00 | 0 | 0.00% | 0 | 0.00% |
| 39.00 | 1 | 0.06% | 0 | 0.00% |
| 40.00 | 0 | 0.00% | 0 | 0.00% |
| 41.00 | 0 | 0.00% | 0 | 0.00% |
| 42.00 | 0 | 0.00% | 0 | 0.00% |
| 43.00 | 0 | 0.00% | 0 | 0.00% |
| 44.00 | 0 | 0.00% | 0 | 0.00% |
| 45.00 | 0 | 0.00% | 0 | 0.00% |
| 46.00 | 0 | 0.00% | 0 | 0.00% |
| 47.00 | 0 | 0.00% | 0 | 0.00% |
| 48.00 | 0 | 0.00% | 0 | 0.00% |
| 49.00 | 0 | 0.00% | 0 | 0.00% |
| 50.00 | 0 | 0.00% | 0 | 0.00% |
| 51.00 | 0 | 0.00% | 0 | 0.00% |
| 52.00 | 0 | 0.00% | 0 | 0.00% |
| 53.00 | 0 | 0.00% | 0 | 0.00% |
| 54.00 | 0 | 0.00% | 0 | 0.00% |
| 55.00 | 0 | 0.00% | 0 | 0.00% |
| 56.00 | 0 | 0.00% | 0 | 0.00% |
| 57.00 | 0 | 0.00% | 0 | 0.00% |
| 58.00 | 0 | 0.00% | 0 | 0.00% |
| 59.00 | 1 | 0.06% | 0 | 0.00% |
| 60.00 | 0 | 0.00% | 0 | 0.00% |
| 61.00 | 0 | 0.00% | 0 | 0.00% |
| 62.00 | 0 | 0.00% | 0 | 0.00% |
| 63.00 | 0 | 0.00% | 0 | 0.00% |
| 64.00 | 0 | 0.00% | 0 | 0.00% |
| | 1656 | 100.00% | 1668 | 100.00% |

TABLE 11
Corn Sphericity Analysis

| | | | | | A Sonic | | | | A Sonic 100% | |
|---|---|---|---|---|---|---|---|---|---|---|
| | | | A Sonic 80% | | 100% Amp. | | A Sonic 100% | | Amp. & | |
| | A Control | | Amp. & 420 | | & 412 Watts | | Amp. & 490 | | 530 Watts | |
| | Sphericity | | Watts W/ BP | | W/NO BP | | Watts W/ BP | | W/ HBP | |
| Class | F(n) | F(n) % | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% | 0 | 0.00% |
| 0.03 | 1 | 0.06% | 4 | 0.25% | 10 | 0.61% | 1 | 0.06% | 5 | 0.29% |
| 0.06 | 3 | 0.17% | 0 | 0.00% | 9 | 0.55% | 1 | 0.06% | 2 | 0.12% |
| 0.09 | 4 | 0.23% | 1 | 0.06% | 5 | 0.30% | 1 | 0.06% | 4 | 0.23% |
| 0.13 | 5 | 0.28% | 8 | 0.50% | 17 | 1.04% | 6 | 0.35% | 7 | 0.40% |
| 0.16 | 7 | 0.39% | 11 | 0.69% | 20 | 1.22% | 6 | 0.35% | 12 | 0.69% |
| 0.19 | 4 | 0.23% | 22 | 1.37% | 23 | 1.40% | 7 | 0.41% | 20 | 1.15% |
| 0.22 | 9 | 0.51% | 15 | 0.94% | 21 | 1.28% | 9 | 0.53% | 30 | 1.73% |
| 0.25 | 10 | 0.56% | 24 | 1.50% | 21 | 1.28% | 18 | 1.06% | 24 | 1.38% |
| 0.28 | 17 | 0.96% | 21 | 1.31% | 27 | 1.64% | 15 | 0.88% | 33 | 1.90% |
| 0.31 | 25 | 1.41% | 25 | 1.56% | 18 | 1.10% | 9 | 0.53% | 33 | 1.90% |
| 0.34 | 26 | 1.46% | 22 | 1.37% | 33 | 2.01% | 25 | 1.47% | 26 | 1.50% |
| 0.38 | 26 | 1.46% | 26 | 1.62% | 20 | 1.22% | 13 | 0.76% | 35 | 2.02% |
| 0.41 | 19 | 1.07% | 25 | 1.56% | 23 | 1.40% | 24 | 1.41% | 29 | 1.67% |
| 0.44 | 43 | 2.42% | 31 | 1.94% | 25 | 1.52% | 19 | 1.12% | 48 | 2.77% |
| 0.47 | 35 | 1.97% | 34 | 2.12% | 25 | 1.52% | 19 | 1.12% | 28 | 1.61% |
| 0.50 | 39 | 2.20% | 44 | 2.75% | 30 | 1.83% | 21 | 1.23% | 40 | 2.31% |
| 0.53 | 55 | 3.10% | 40 | 2.50% | 25 | 1.52% | 26 | 1.53% | 51 | 2.94% |
| 0.56 | 50 | 2.82% | 53 | 3.31% | 32 | 1.95% | 34 | 2.00% | 57 | 3.29% |
| 0.59 | 52 | 2.93% | 38 | 2.37% | 44 | 2.68% | 34 | 2.00% | 54 | 3.11% |
| 0.63 | 55 | 3.10% | 58 | 3.62% | 48 | 2.92% | 56 | 3.29% | 66 | 3.80% |
| 0.66 | 66 | 3.72% | 65 | 4.06% | 38 | 2.31% | 38 | 2.23% | 59 | 3.40% |
| 0.69 | 87 | 4.90% | 79 | 4.93% | 69 | 4.20% | 78 | 4.58% | 82 | 4.73% |
| 0.72 | 92 | 5.18% | 98 | 6.12% | 82 | 4.99% | 90 | 5.28% | 99 | 5.71% |
| 0.75 | 87 | 4.90% | 92 | 5.75% | 91 | 5.54% | 95 | 5.58% | 83 | 4.78% |
| 0.78 | 131 | 7.38% | 116 | 7.25% | 123 | 7.49% | 110 | 6.46% | 122 | 7.03% |
| 0.81 | 173 | 9.75% | 132 | 8.24% | 154 | 9.38% | 172 | 10.10% | 135 | 7.78% |
| 0.84 | 194 | 10.93% | 143 | 8.93% | 174 | 10.60% | 209 | 12.27% | 163 | 9.39% |
| 0.88 | 221 | 12.45% | 187 | 11.68% | 182 | 11.08% | 244 | 14.33% | 180 | 10.37% |
| 0.91 | 131 | 7.38% | 105 | 6.56% | 136 | 8.28% | 168 | 9.86% | 110 | 6.34% |
| 0.94 | 79 | 4.45% | 53 | 3.31% | 81 | 4.93% | 99 | 5.81% | 60 | 3.46% |
| 0.97 | 17 | 0.96% | 11 | 0.69% | 27 | 1.64% | 35 | 2.06% | 23 | 1.33% |
| 1.00 | 12 | 0.68% | 18 | 1.12% | 9 | 0.55% | 21 | 1.23% | 15 | 0.86% |
| | 1775 | 100.00% | 1601 | 100.00% | 1642 | 100.00% | 1703 | 100.00% | 1735 | 100.00% |

TABLE 12
Corn Sphericity Analysis

| | B Sonic | | B Sonic | | B Sonic | |
|---|---|---|---|---|---|---|
| | 60% Amp. & | | 80% Amp. & | | 100% Amp. & | |
| | 276 Watts W/ BP | | 295 Watts W/O BP | | 425 Watts W/ BP | |
| Class | F(n) | F(n) % | F(n) | F(n) % | F(n) | F(n) % |
| 0.00 | 0 | 0.00% | 0 | 0.00% | 0 | 0.00% |
| 0.03 | 21 | 1.28% | 8 | 0.48% | 16 | 0.97% |
| 0.06 | 19 | 1.16% | 5 | 0.30% | 16 | 0.97% |
| 0.09 | 28 | 1.71% | 9 | 0.54% | 31 | 1.88% |
| 0.13 | 39 | 2.38% | 20 | 1.20% | 26 | 1.58% |
| 0.16 | 52 | 3.17% | 12 | 0.72% | 29 | 1.76% |
| 0.19 | 60 | 3.66% | 23 | 1.38% | 44 | 2.67% |
| 0.22 | 50 | 3.05% | 26 | 1.56% | 41 | 2.49% |
| 0.25 | 49 | 2.99% | 20 | 1.20% | 49 | 2.97% |
| 0.28 | 54 | 3.29% | 12 | 0.72% | 44 | 2.67% |
| 0.31 | 47 | 2.87% | 19 | 1.14% | 55 | 3.34% |
| 0.34 | 51 | 3.11% | 39 | 2.34% | 47 | 2.85% |
| 0.38 | 64 | 3.90% | 26 | 1.56% | 54 | 3.27% |
| 0.41 | 44 | 2.68% | 23 | 1.38% | 77 | 4.67% |
| 0.44 | 40 | 2.44% | 33 | 1.98% | 71 | 4.31% |
| 0.47 | 47 | 2.87% | 33 | 1.98% | 82 | 4.97% |
| 0.50 | 52 | 3.17% | 46 | 2.76% | 75 | 4.55% |
| 0.53 | 49 | 2.99% | 44 | 2.64% | 84 | 5.09% |
| 0.56 | 53 | 3.23% | 46 | 2.76% | 69 | 4.18% |
| 0.59 | 71 | 4.33% | 42 | 2.52% | 70 | 4.24% |
| 0.63 | 62 | 3.78% | 62 | 3.72% | 101 | 6.12% |
| 0.66 | 81 | 4.94% | 69 | 4.14% | 85 | 5.15% |
| 0.69 | 93 | 5.67% | 97 | 5.83% | 96 | 5.82% |
| 0.72 | 94 | 5.73% | 81 | 4.86% | 70 | 4.24% |
| 0.75 | 84 | 5.12% | 104 | 6.25% | 78 | 4.73% |
| 0.78 | 92 | 5.61% | 167 | 10.03% | 79 | 4.79% |
| 0.81 | 83 | 5.06% | 147 | 8.83% | 57 | 3.46% |
| 0.84 | 74 | 4.51% | 150 | 9.01% | 44 | 2.67% |
| 0.88 | 49 | 2.99% | 155 | 9.31% | 32 | 1.94% |
| 0.91 | 24 | 1.46% | 92 | 5.53% | 16 | 0.97% |
| 0.94 | 11 | 0.67% | 38 | 2.28% | 5 | 0.30% |
| 0.97 | 2 | 0.12% | 10 | 0.60% | 5 | 0.30% |
| 1.00 | 1 | 0.06% | 7 | 0.42% | 1 | 0.06% |
| | 1640 | 100.00% | 1665 | 100.00% | 1649 | 100.00% |

TABLE 13
Corn Sphericity Analysis

| | C Control | | C Sonic 100% Amp. & 415 Watts W/O BP | |
|---|---|---|---|---|
| Class | F(n) | F(n) % | F(n) | F(n) % |
| 0.00 | 0 | 0.00% | 0 | 0.00% |
| 0.03 | 6 | 0.36% | 4 | 0.24% |
| 0.06 | 2 | 0.12% | 8 | 0.48% |
| 0.09 | 14 | 0.85% | 10 | 0.60% |
| 0.13 | 14 | 0.85% | 15 | 0.90% |
| 0.16 | 12 | 0.73% | 19 | 1.14% |
| 0.19 | 15 | 0.91% | 18 | 1.08% |
| 0.22 | 31 | 1.88% | 23 | 1.38% |
| 0.25 | 25 | 1.51% | 28 | 1.68% |
| 0.28 | 18 | 1.09% | 24 | 1.44% |
| 0.31 | 25 | 1.51% | 38 | 2.28% |
| 0.34 | 25 | 1.51% | 39 | 2.34% |
| 0.38 | 22 | 1.33% | 27 | 1.62% |
| 0.41 | 29 | 1.75% | 42 | 2.52% |
| 0.44 | 20 | 1.21% | 50 | 3.00% |
| 0.47 | 23 | 1.39% | 39 | 2.34% |
| 0.50 | 38 | 2.30% | 53 | 3.18% |
| 0.53 | 33 | 2.00% | 51 | 3.06% |
| 0.56 | 25 | 1.51% | 70 | 4.20% |
| 0.59 | 27 | 1.63% | 65 | 3.90% |
| 0.63 | 37 | 2.24% | 66 | 3.96% |
| 0.66 | 30 | 1.81% | 67 | 4.02% |
| 0.69 | 73 | 4.42% | 105 | 6.30% |
| 0.72 | 85 | 5.14% | 106 | 6.36% |
| 0.75 | 96 | 5.81% | 120 | 7.20% |
| 0.78 | 117 | 7.08% | 117 | 7.02% |
| 0.81 | 167 | 10.10% | 116 | 6.96% |
| 0.84 | 209 | 12.64% | 128 | 7.68% |
| 0.88 | 234 | 14.16% | 99 | 5.94% |
| 0.91 | 134 | 8.11% | 71 | 4.26% |
| 0.94 | 50 | 3.02% | 29 | 1.74% |
| 0.97 | 13 | 0.79% | 13 | 0.78% |
| 1.00 | 4 | 0.24% | 7 | 0.42% |
| | 1653 | 100.00% | 1667 | 100.00% |

TABLE 14
Corn Shape Analysis

| | | | | | A Sonic | | | | A Sonic 100% | |
|---|---|---|---|---|---|---|---|---|---|---|
| | | | A Sonic 80% | | 100% Amp. | | A Sonic 100% | | Amp. & | |
| | A Control | | Amp. & 420 | | & 412 Watts | | Amp. & 490 | | 530 Watts | |
| | Shape | | Watts W/ BP | | W/NO BP | | Watts W/ BP | | W/ HBP | |
| Class | F(n) | F(n) % | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% | 0 | 0.00% |
| 0.03 | 0 | 0.00% | 0 | 0.00% | 0 | 0.00% | 0 | 0.00% | 0 | 0.00% |
| 0.06 | 0 | 0.00% | 0 | 0.00% | 0 | 0.00% | 0 | 0.00% | 0 | 0.00% |
| 0.09 | 0 | 0.00% | 0 | 0.00% | 0 | 0.00% | 0 | 0.00% | 0 | 0.00% |
| 0.13 | 2 | 0.11% | 0 | 0.00% | 4 | 0.24% | 2 | 0.12% | 1 | 0.06% |
| 0.16 | 96 | 5.40% | 27 | 1.68% | 79 | 4.80% | 94 | 5.49% | 29 | 1.67% |
| 0.19 | 284 | 15.96% | 122 | 7.60% | 167 | 10.15% | 179 | 10.45% | 109 | 6.27% |
| 0.22 | 440 | 24.73% | 193 | 12.02% | 456 | 27.72% | 322 | 18.80% | 355 | 20.43% |
| 0.25 | 455 | 25.58% | 439 | 27.35% | 411 | 24.98% | 501 | 29.25% | 534 | 30.72% |
| 0.28 | 343 | 19.28% | 494 | 30.78% | 341 | 20.73% | 431 | 25.16% | 476 | 27.39% |
| 0.31 | 121 | 6.80% | 246 | 15.33% | 135 | 8.21% | 141 | 8.23% | 184 | 10.59% |
| 0.34 | 37 | 2.08% | 82 | 5.11% | 43 | 2.61% | 41 | 2.39% | 49 | 2.82% |
| 0.38 | 1 | 0.06% | 2 | 0.12% | 8 | 0.49% | 1 | 0.06% | 1 | 0.06% |
| 0.41 | 0 | 0.00% | 0 | 0.00% | 1 | 0.06% | 1 | 0.06% | 0 | 0.00% |
| 0.44 | 0 | 0.00% | 0 | 0.00% | 0 | 0.00% | 0 | 0.00% | 0 | 0.00% |
| 0.47 | 0 | 0.00% | 0 | 0.00% | 0 | 0.00% | 0 | 0.00% | 0 | 0.00% |
| 0.50 | 0 | 0.00% | 0 | 0.00% | 0 | 0.00% | 0 | 0.00% | 0 | 0.00% |
| 0.53 | 0 | 0.00% | 0 | 0.00% | 0 | 0.00% | 0 | 0.00% | 0 | 0.00% |
| 0.56 | 0 | 0.00% | 0 | 0.00% | 0 | 0.00% | 0 | 0.00% | 0 | 0.00% |
| 0.59 | 0 | 0.00% | 0 | 0.00% | 0 | 0.00% | 0 | 0.00% | 0 | 0.00% |
| 0.63 | 0 | 0.00% | 0 | 0.00% | 0 | 0.00% | 0 | 0.00% | 0 | 0.00% |
| 0.66 | 0 | 0.00% | 0 | 0.00% | 0 | 0.00% | 0 | 0.00% | 0 | 0.00% |
| 0.69 | 0 | 0.00% | 0 | 0.00% | 0 | 0.00% | 0 | 0.00% | 0 | 0.00% |
| 0.72 | 0 | 0.00% | 0 | 0.00% | 0 | 0.00% | 0 | 0.00% | 0 | 0.00% |
| 0.75 | 0 | 0.00% | 0 | 0.00% | 0 | 0.00% | 0 | 0.00% | 0 | 0.00% |
| 0.78 | 0 | 0.00% | 0 | 0.00% | 0 | 0.00% | 0 | 0.00% | 0 | 0.00% |
| 0.81 | 0 | 0.00% | 0 | 0.00% | 0 | 0.00% | 0 | 0.00% | 0 | 0.00% |
| 0.84 | 0 | 0.00% | 0 | 0.00% | 0 | 0.00% | 0 | 0.00% | 0 | 0.00% |
| 0.88 | 0 | 0.00% | 0 | 0.00% | 0 | 0.00% | 0 | 0.00% | 0 | 0.00% |
| 0.91 | 0 | 0.00% | 0 | 0.00% | 0 | 0.00% | 0 | 0.00% | 0 | 0.00% |
| 0.94 | 0 | 0.00% | 0 | 0.00% | 0 | 0.00% | 0 | 0.00% | 0 | 0.00% |
| 0.97 | 0 | 0.00% | 0 | 0.00% | 0 | 0.00% | 0 | 0.00% | 0 | 0.00% |
| 1.00 | 0 | 0.00% | 0 | 0.00% | 0 | 0.00% | 0 | 0.00% | 0 | 0.00% |
| | 1779 | 100.00% | 1605 | 100.00% | 1645 | 100.00% | 1713 | 100.00% | 1738 | 100.00% |

TABLE 15
Corn Shape Analysis

| | B Sonic | | B Sonic 80% | | B Sonic 100% | |
|---|---|---|---|---|---|---|
| | 60% Amp. & | | Amp. & 295 | | Amp. & | |
| | 276 Watts W/ BP | | Watts W/O BP | | 425 Watts W/ BP | |
| Class | F(n) | F(n) % | F(n) | F(n) % | F(n) | F(n) % |
| 0.00 | 0 | 0.00% | 0 | 0.00% | 0 | 0.00% |
| 0.03 | 0 | 0.00% | 0 | 0.00% | 0 | 0.00% |
| 0.06 | 0 | 0.00% | 0 | 0.00% | 0 | 0.00% |
| 0.09 | 0 | 0.00% | 0 | 0.00% | 0 | 0.00% |
| 0.13 | 2 | 0.12% | 2 | 0.12% | 0 | 0.00% |
| 0.16 | 63 | 3.84% | 44 | 2.63% | 9 | 0.55% |
| 0.19 | 261 | 15.91% | 151 | 9.04% | 34 | 2.06% |
| 0.22 | 333 | 20.30% | 386 | 23.11% | 238 | 14.43% |
| 0.25 | 414 | 25.24% | 465 | 27.84% | 499 | 30.26% |
| 0.28 | 318 | 19.39% | 398 | 23.83% | 480 | 29.11% |
| 0.31 | 175 | 10.67% | 162 | 9.70% | 266 | 16.13% |
| 0.34 | 63 | 3.84% | 57 | 3.41% | 108 | 6.55% |
| 0.38 | 11 | 0.67% | 4 | 0.24% | 9 | 0.55% |
| 0.41 | 0 | 0.00% | 1 | 0.06% | 6 | 0.36% |
| 0.44 | 0 | 0.00% | 0 | 0.00% | 0 | 0.00% |
| 0.47 | 0 | 0.00% | 0 | 0.00% | 0 | 0.00% |
| 0.50 | 0 | 0.00% | 0 | 0.00% | 0 | 0.00% |
| 0.53 | 0 | 0.00% | 0 | 0.00% | 0 | 0.00% |
| 0.56 | 0 | 0.00% | 0 | 0.00% | 0 | 0.00% |
| 0.59 | 0 | 0.00% | 0 | 0.00% | 0 | 0.00% |
| 0.63 | 0 | 0.00% | 0 | 0.00% | 0 | 0.00% |
| 0.66 | 0 | 0.00% | 0 | 0.00% | 0 | 0.00% |
| 0.69 | 0 | 0.00% | 0 | 0.00% | 0 | 0.00% |
| 0.72 | 0 | 0.00% | 0 | 0.00% | 0 | 0.00% |
| 0.75 | 0 | 0.00% | 0 | 0.00% | 0 | 0.00% |
| 0.78 | 0 | 0.00% | 0 | 0.00% | 0 | 0.00% |
| 0.81 | 0 | 0.00% | 0 | 0.00% | 0 | 0.00% |
| 0.84 | 0 | 0.00% | 0 | 0.00% | 0 | 0.00% |
| 0.88 | 0 | 0.00% | 0 | 0.00% | 0 | 0.00% |
| 0.91 | 0 | 0.00% | 0 | 0.00% | 0 | 0.00% |
| 0.94 | 0 | 0.00% | 0 | 0.00% | 0 | 0.00% |
| 0.97 | 0 | 0.00% | 0 | 0.00% | 0 | 0.00% |
| 1.00 | 0 | 0.00% | 0 | 0.00% | 0 | 0.00% |
| | 1640 | 100.00% | 1670 | 100.00% | 1649 | 100.00% |

TABLE 16
Corn Shape Analysis

| | C Control | | C Sonic 100% Amp. & 415 Watts W/O BP | |
|---|---|---|---|---|
| Class | F(n) | F(n) % | F(n) | F(n) % |
| 0.00 | 0 | 0.00% | 0 | 0.00% |
| 0.03 | 0 | 0.00% | 0 | 0.00% |
| 0.06 | 0 | 0.00% | 0 | 0.00% |
| 0.09 | 0 | 0.00% | 0 | 0.00% |
| 0.13 | 6 | 0.36% | 0 | 0.00% |
| 0.16 | 174 | 10.51% | 9 | 0.54% |
| 0.19 | 367 | 22.16% | 48 | 2.88% |
| 0.22 | 360 | 21.74% | 189 | 11.33% |
| 0.25 | 392 | 23.67% | 475 | 28.48% |
| 0.28 | 249 | 15.04% | 570 | 34.17% |
| 0.31 | 81 | 4.89% | 280 | 16.79% |
| 0.34 | 23 | 1.39% | 84 | 5.04% |
| 0.38 | 4 | 0.24% | 12 | 0.72% |
| 0.41 | 0 | 0.00% | 1 | 0.06% |
| 0.44 | 0 | 0.00% | 0 | 0.00% |
| 0.47 | 0 | 0.00% | 0 | 0.00% |
| 0.50 | 0 | 0.00% | 0 | 0.00% |
| 0.53 | 0 | 0.00% | 0 | 0.00% |
| 0.56 | 0 | 0.00% | 0 | 0.00% |
| 0.59 | 0 | 0.00% | 0 | 0.00% |
| 0.63 | 0 | 0.00% | 0 | 0.00% |
| 0.66 | 0 | 0.00% | 0 | 0.00% |
| 0.69 | 0 | 0.00% | 0 | 0.00% |
| 0.72 | 0 | 0.00% | 0 | 0.00% |
| 0.75 | 0 | 0.00% | 0 | 0.00% |
| 0.78 | 0 | 0.00% | 0 | 0.00% |
| 0.81 | 0 | 0.00% | 0 | 0.00% |
| 0.84 | 0 | 0.00% | 0 | 0.00% |
| 0.88 | 0 | 0.00% | 0 | 0.00% |
| 0.91 | 0 | 0.00% | 0 | 0.00% |
| 0.94 | 0 | 0.00% | 0 | 0.00% |
| 0.97 | 0 | 0.00% | 0 | 0.00% |
| 1.00 | 0 | 0.00% | 0 | 0.00% |
| | 1656 | 100.00% | 1668 | 100.00% |

TABLE 17
Corn Aspect Ratio Analysis

| | | | | | A Sonic | | A Sonic | | A Sonic | |
|---|---|---|---|---|---|---|---|---|---|---|
| | | | A Sonic 80% | | 100% Amp. | | 100% & | | 100% Amp. & | |
| | A Control | | Amp. & 420 | | 412 Watts | | Amp. & 490 | | 530 Watts | |
| | Aspect Ratio | | Watts W/ BP | | W/NO BP | | Watts W/ BP | | W/ HBP | |
| Class | F(n) | F(n) % | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% | 0 | 0.00% |
| 0.03 | 0 | 0.00% | 1 | 0.06% | 0 | 0.00% | 0 | 0.00% | 0 | 0.00% |
| 0.06 | 0 | 0.00% | 0 | 0.00% | 0 | 0.00% | 0 | 0.00% | 0 | 0.00% |
| 0.09 | 0 | 0.00% | 0 | 0.00% | 0 | 0.00% | 0 | 0.00% | 0 | 0.00% |
| 0.13 | 1 | 0.06% | 0 | 0.00% | 0 | 0.00% | 0 | 0.00% | 0 | 0.00% |
| 0.16 | 0 | 0.00% | 0 | 0.00% | 0 | 0.00% | 0 | 0.00% | 0 | 0.00% |
| 0.19 | 1 | 0.06% | 0 | 0.00% | 0 | 0.00% | 1 | 0.06% | 0 | 0.00% |
| 0.22 | 0 | 0.00% | 2 | 0.13% | 0 | 0.00% | 0 | 0.00% | 4 | 0.24% |
| 0.25 | 1 | 0.06% | 2 | 0.13% | 4 | 0.26% | 1 | 0.06% | 3 | 0.18% |
| 0.28 | 1 | 0.06% | 4 | 0.25% | 4 | 0.26% | 1 | 0.06% | 3 | 0.18% |
| 0.31 | 2 | 0.12% | 18 | 1.15% | 10 | 0.64% | 4 | 0.24% | 7 | 0.41% |
| 0.34 | 3 | 0.17% | 13 | 0.83% | 14 | 0.90% | 3 | 0.18% | 9 | 0.53% |
| 0.38 | 11 | 0.64% | 22 | 1.40% | 7 | 0.45% | 11 | 0.67% | 25 | 1.48% |
| 0.41 | 9 | 0.52% | 25 | 1.59% | 12 | 0.77% | 14 | 0.85% | 21 | 1.24% |
| 0.44 | 17 | 0.99% | 37 | 2.36% | 20 | 1.28% | 22 | 1.34% | 39 | 2.31% |
| 0.47 | 36 | 2.09% | 47 | 2.99% | 24 | 1.54% | 20 | 1.22% | 42 | 2.49% |
| 0.50 | 25 | 1.45% | 49 | 3.12% | 19 | 1.22% | 28 | 1.71% | 65 | 3.85% |
| 0.53 | 42 | 2.44% | 61 | 3.89% | 28 | 1.80% | 52 | 3.17% | 69 | 4.09% |
| 0.56 | 52 | 3.02% | 78 | 4.97% | 58 | 3.72% | 41 | 2.50% | 73 | 4.32% |
| 0.59 | 66 | 3.83% | 77 | 4.90% | 35 | 2.25% | 41 | 2.50% | 70 | 4.14% |
| 0.63 | 56 | 3.25% | 55 | 3.50% | 50 | 3.21% | 41 | 2.50% | 59 | 3.49% |
| 0.66 | 94 | 5.46% | 92 | 5.86% | 61 | 3.91% | 54 | 3.29% | 92 | 5.45% |
| 0.69 | 94 | 5.46% | 103 | 6.56% | 58 | 3.72% | 70 | 4.26% | 90 | 5.33% |
| 0.72 | 91 | 5.28% | 84 | 5.35% | 62 | 3.98% | 78 | 4.75% | 85 | 5.03% |
| 0.75 | 87 | 5.05% | 95 | 6.05% | 81 | 5.20% | 87 | 5.30% | 93 | 5.51% |
| 0.78 | 141 | 8.18% | 112 | 7.13% | 94 | 6.03% | 106 | 6.46% | 115 | 6.81% |
| 0.81 | 133 | 7.72% | 97 | 6.18% | 112 | 7.18% | 124 | 7.55% | 113 | 6.69% |
| 0.84 | 178 | 10.33% | 155 | 9.87% | 152 | 9.75% | 211 | 12.85% | 180 | 10.66% |
| 0.88 | 143 | 8.30% | 98 | 6.24% | 155 | 9.94% | 157 | 9.56% | 106 | 6.28% |
| 0.91 | 162 | 9.40% | 64 | 4.08% | 155 | 9.94% | 149 | 9.07% | 97 | 5.74% |
| 0.94 | 120 | 6.96% | 66 | 4.20% | 158 | 10.13% | 120 | 7.31% | 94 | 5.57% |
| 0.97 | 103 | 5.98% | 81 | 5.16% | 119 | 7.63% | 137 | 8.34% | 82 | 4.85% |
| 1.00 | 54 | 3.13% | 32 | 2.04% | 67 | 4.30% | 69 | 4.20% | 53 | 3.14% |
| | 1723 | 100.00% | 1570 | 100.00% | 1559 | 100.00% | 1642 | 100.00% | 1689 | 100.00% |

TABLE 18
Corn Aspect Ratio Analysis

| | B Sonic | | B Sonic | | B Sonic | |
|---|---|---|---|---|---|---|
| | 60% Amp. & | | 80% Amp. & 295 | | 100% Amp. & | |
| | 276 Watts W/ BP | | Watts W/O BP | | 425 Watts W/ BP | |
| Class | F(n) | F(n) % | F(n) | F(n) % | F(n) | F(n) % |
| 0.00 | 0 | 0.00% | 0 | 0.00% | 0 | 0.00% |
| 0.03 | 0 | 0.00% | 0 | 0.00% | 0 | 0.00% |
| 0.06 | 0 | 0.00% | 0 | 0.00% | 0 | 0.00% |
| 0.09 | 0 | 0.00% | 0 | 0.00% | 0 | 0.00% |
| 0.13 | 1 | 0.06% | 0 | 0.00% | 0 | 0.00% |
| 0.16 | 1 | 0.06% | 0 | 0.00% | 0 | 0.00% |
| 0.19 | 3 | 0.19% | 1 | 0.06% | 2 | 0.13% |
| 0.22 | 1 | 0.06% | 2 | 0.12% | 4 | 0.25% |
| 0.25 | 14 | 0.87% | 2 | 0.12% | 7 | 0.44% |
| 0.28 | 7 | 0.44% | 3 | 0.19% | 3 | 0.19% |
| 0.31 | 11 | 0.69% | 9 | 0.56% | 10 | 0.63% |
| 0.34 | 22 | 1.37% | 3 | 0.19% | 16 | 1.00% |
| 0.38 | 21 | 1.31% | 12 | 0.75% | 23 | 1.44% |
| 0.41 | 24 | 1.50% | 18 | 1.12% | 17 | 1.06% |
| 0.44 | 27 | 1.69% | 19 | 1.18% | 25 | 1.57% |
| 0.47 | 41 | 2.56% | 39 | 2.43% | 38 | 2.38% |
| 0.50 | 47 | 2.94% | 21 | 1.31% | 37 | 2.32% |
| 0.53 | 63 | 3.94% | 37 | 2.31% | 64 | 4.01% |
| 0.56 | 50 | 3.12% | 56 | 3.49% | 76 | 4.76% |
| 0.59 | 60 | 3.75% | 59 | 3.68% | 99 | 6.20% |
| 0.63 | 66 | 4.12% | 50 | 3.12% | 84 | 5.26% |
| 0.66 | 87 | 5.43% | 82 | 5.11% | 80 | 5.01% |
| 0.69 | 93 | 5.81% | 75 | 4.67% | 111 | 6.95% |
| 0.72 | 66 | 4.12% | 92 | 5.73% | 96 | 6.01% |
| 0.75 | 111 | 6.93% | 101 | 6.29% | 129 | 8.08% |
| 0.78 | 113 | 7.06% | 104 | 6.48% | 116 | 7.26% |
| 0.81 | 104 | 6.50% | 129 | 8.04% | 117 | 7.33% |
| 0.84 | 142 | 8.87% | 168 | 10.47% | 146 | 9.14% |
| 0.88 | 118 | 7.37% | 118 | 7.35% | 87 | 5.45% |
| 0.91 | 113 | 7.06% | 137 | 8.54% | 69 | 4.32% |
| 0.94 | 73 | 4.56% | 115 | 7.17% | 57 | 3.57% |
| 0.97 | 79 | 4.93% | 93 | 5.79% | 57 | 3.57% |
| 1.00 | 43 | 2.69% | 60 | 3.74% | 27 | 1.69% |
| | 1601 | 100.00% | 1605 | 100.00% | 1597 | 100.00% |

TABLE 19
Corn Aspect Ratio Analysis

| | C Control | | C Sonic 100% Amp. & 415 Watts W/O BP | |
|---|---|---|---|---|
| Class | F(n) | F(n) % | F(n) | F(n) % |
| 0.00 | 0 | 0.00% | 0 | 0.00% |
| 0.03 | 0 | 0.00% | 0 | 0.00% |
| 0.06 | 0 | 0.00% | 0 | 0.00% |
| 0.09 | 0 | 0.00% | 0 | 0.00% |
| 0.13 | 0 | 0.00% | 0 | 0.00% |
| 0.16 | 0 | 0.00% | 1 | 0.06% |
| 0.19 | 1 | 0.06% | 0 | 0.00% |
| 0.22 | 2 | 0.12% | 0 | 0.00% |
| 0.25 | 2 | 0.12% | 5 | 0.31% |
| 0.28 | 5 | 0.31% | 13 | 0.79% |
| 0.31 | 3 | 0.19% | 21 | 1.28% |
| 0.34 | 7 | 0.44% | 31 | 1.89% |
| 0.38 | 7 | 0.44% | 38 | 2.32% |
| 0.41 | 12 | 0.75% | 34 | 2.07% |
| 0.44 | 16 | 1.00% | 52 | 3.17% |
| 0.47 | 19 | 1.19% | 52 | 3.17% |
| 0.50 | 27 | 1.69% | 71 | 4.33% |
| 0.53 | 41 | 2.56% | 65 | 3.97% |
| 0.56 | 52 | 3.25% | 72 | 4.39% |
| 0.59 | 49 | 3.06% | 86 | 5.25% |
| 0.63 | 48 | 3.00% | 65 | 3.97% |
| 0.66 | 73 | 4.56% | 122 | 7.44% |
| 0.69 | 73 | 4.56% | 103 | 6.28% |
| 0.72 | 66 | 4.12% | 88 | 5.37% |
| 0.75 | 105 | 6.56% | 118 | 7.20% |
| 0.78 | 82 | 5.12% | 114 | 6.96% |
| 0.81 | 116 | 7.25% | 103 | 6.28% |
| 0.84 | 159 | 9.93% | 125 | 7.63% |
| 0.88 | 141 | 8.81% | 76 | 4.64% |
| 0.91 | 159 | 9.93% | 66 | 4.03% |
| 0.94 | 139 | 8.68% | 52 | 3.17% |
| 0.97 | 132 | 8.24% | 46 | 2.81% |
| 1.00 | 65 | 4.06% | 20 | 1.22% |
| | 1601 | 100.00% | 1639 | 100.00% |

### Example 6

### Treatment of Soybean Slurry

The production of soy food products requires that soy beans be ground to produce a slurry and that large particles of this slurry, the okara, are separated, typically by centrifugation, from the smaller particles the soy base. The base is then further processed to make soy food, and the paste often referred to as the okara is recycled for additional grinding. A change in the morphology of particles of the slurry that increases the number of soy particles that partition with the soy base instead of the okara results in a increase in the amount of soy base produced from a bushel of soy beans and increases the quantity of soy foods that can be produced from a bushel of soy beans. Increasing the amount of soy bean production also decreases the amount okara produced and decreases the total costs of reprocessing okara. The total solids in the slurry were 15% weight per volume.

Slurries of soy beans were subjected to ultrasonication under a variety of conditions. The ultrasonication was carried out with a Hielscher UIP 1000 ultrasonic processor, using a 20 cm head. A BS2d22 sonotrode with 2.2 cm diameter and 3.8 cm2 surface area was used in a D100LK-1S flow cell which has a sonic control volume of 1.5 cm³. The flow rate was 2 liters per minute, to produce a residence time of about 0.037 seconds under the sonotrode. The samples were run with a sonic reducer of 2.0. The temperature of the sonic unit was 174° F.

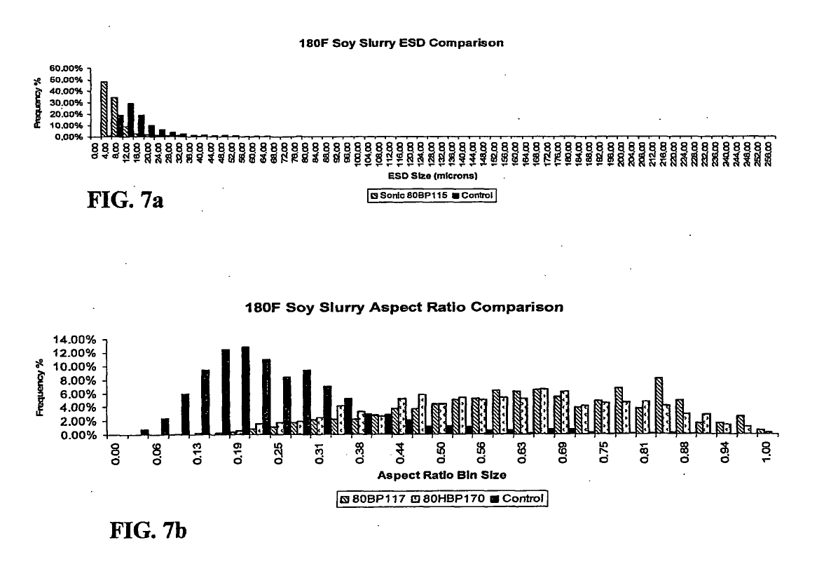

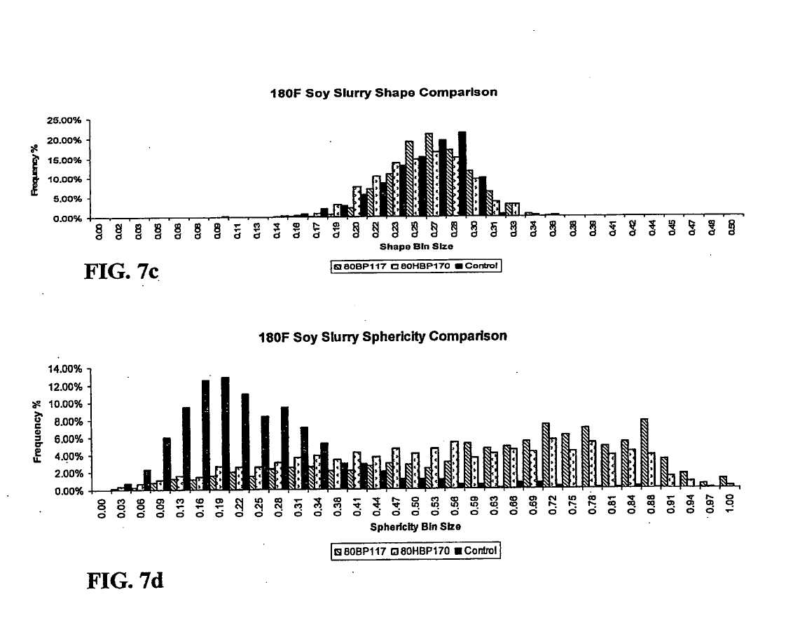

For the soy bean slurry, the amplitude, power delivered and the backpressure of the system were varied between different experiments. For the data shown in Table 20 through Table 23 and FIGS. 7a-d, the amplitude for sample A (180F 80BP 115 Watts) was 21 micrometers, with 115 watts delivered to the sample to produce an intensity of 30.26 watts/cm². For sample A the back pressure was 25 PSIG. The amplitude for sample B (180F 80HBP 170 Watts) was 21 micrometers, with 170 watts delivered to the sample to produce an intensity of 44.74 watts/cm². For sample B the back pressure was 50 PSIG. The control sample was run through the system without the delivery of power or back pressure.

TABLE 20
Soy Slurry ESD Analysis

| | 180F Soy | | 180F Soy | | 180F Soy | |
|---|---|---|---|---|---|---|
| | Slurry ESD | | Slurry ESD | | Slurry ESD | |
| | 80BP 115 Watts | | 80HBP 170 Watts | | Control | |
| Class | F(n) | F(n) % | F(n) | F(n) % | F(n) | F(n) % |
| 0.00 | 0 | 0.00% | 0 | 0.00% | 0 | 0.00% |
| 4.00 | 538 | 48.08% | 309 | 27.74% | 8 | 0.72% |
| 8.00 | 384 | 34.32% | 400 | 35.91% | 213 | 19.09% |
| 12.00 | 102 | 9.12% | 191 | 17.15% | 326 | 29.21% |
| 16.00 | 31 | 2.77% | 90 | 8.08% | 212 | 19.00% |
| 20.00 | 19 | 1.70% | 53 | 4.76% | 111 | 9.95% |
| 24.00 | 16 | 1.43% | 28 | 2.51% | 70 | 6.27% |
| 28.00 | 12 | 1.07% | 17 | 1.53% | 42 | 3.76% |
| 32.00 | 8 | 0.71% | 8 | 0.72% | 31 | 2.78% |
| 36.00 | 2 | 0.18% | 7 | 0.63% | 16 | 1.43% |
| 40.00 | 5 | 0.45% | 3 | 0.27% | 14 | 1.25% |
| 44.00 | 0 | 0.00% | 5 | 0.45% | 10 | 0.90% |
| 48.00 | 1 | 0.09% | 0 | 0.00% | 13 | 1.16% |
| 52.00 | 0 | 0.00% | 1 | 0.09% | 10 | 0.90% |
| 56.00 | 1 | 0.09% | 1 | 0.09% | 5 | 0.45% |
| 60.00 | 0 | 0.00% | 1 | 0.09% | 4 | 0.36% |
| 64.00 | 0 | 0.00% | 0 | 0.00% | 5 | 0.45% |
| 68.00 | 0 | 0.00% | 0 | 0.00% | 1 | 0.09% |
| 72.00 | 0 | 0.00% | 0 | 0.00% | 2 | 0.18% |
| 76.00 | 0 | 0.00% | 0 | 0.00% | 4 | 0.36% |
| 80.00 | 0 | 0.00% | 0 | 0.00% | 2 | 0.18% |
| 84.00 | 0 | 0.00% | 0 | 0.00% | 1 | 0.09% |
| 88.00 | 0 | 0.00% | 0 | 0.00% | 2 | 0.18% |
| 92.00 | 0 | 0.00% | 0 | 0.00% | 1 | 0.09% |
| 96.00 | 0 | 0.00% | 0 | 0.00% | 1 | 0.09% |
| 100.00 | 0 | 0.00% | 0 | 0.00% | 0 | 0.00% |
| 104.00 | 0 | 0.00% | 0 | 0.00% | 2 | 0.18% |
| 108.00 | 0 | 0.00% | 0 | 0.00% | 0 | 0.00% |
| 112.00 | 0 | 0.00% | 0 | 0.00% | 1 | 0.09% |
| 116.00 | 0 | 0.00% | 0 | 0.00% | 2 | 0.18% |
| 120.00 | 0 | 0.00% | 0 | 0.00% | 0 | 0.00% |
| 124.00 | 0 | 0.00% | 0 | 0.00% | 0 | 0.00% |
| 128.00 | 0 | 0.00% | 0 | 0.00% | 1 | 0.09% |
| 132.00 | 0 | 0.00% | 0 | 0.00% | 0 | 0.00% |
| 136.00 | 0 | 0.00% | 0 | 0.00% | 0 | 0.00% |
| 140.00 | 0 | 0.00% | 0 | 0.00% | 2 | 0.18% |
| 144.00 | 0 | 0.00% | 0 | 0.00% | 0 | 0.00% |
| 148.00 | 0 | 0.00% | 0 | 0.00% | 0 | 0.00% |
| 152.00 | 0 | 0.00% | 0 | 0.00% | 0 | 0.00% |
| 156.00 | 0 | 0.00% | 0 | 0.00% | 1 | 0.09% |
| 160.00 | 0 | 0.00% | 0 | 0.00% | 0 | 0.00% |
| 164.00 | 0 | 0.00% | 0 | 0.00% | 0 | 0.00% |
| 168.00 | 0 | 0.00% | 0 | 0.00% | 1 | 0.09% |
| 172.00 | 0 | 0.00% | 0 | 0.00% | 1 | 0.09% |
| 176.00 | 0 | 0.00% | 0 | 0.00% | 0 | 0.00% |
| 180.00 | 0 | 0.00% | 0 | 0.00% | 0 | 0.00% |
| 184.00 | 0 | 0.00% | 0 | 0.00% | 0 | 0.00% |
| 188.00 | 0 | 0.00% | 0 | 0.00% | 0 | 0.00% |
| 192.00 | 0 | 0.00% | 0 | 0.00% | 0 | 0.00% |
| 196.00 | 0 | 0.00% | 0 | 0.00% | 0 | 0.00% |
| 200.00 | 0 | 0.00% | 0 | 0.00% | 0 | 0.00% |
| 204.00 | 0 | 0.00% | 0 | 0.00% | 0 | 0.00% |
| 208.00 | 0 | 0.00% | 0 | 0.00% | 0 | 0.00% |
| 212.00 | 0 | 0.00% | 0 | 0.00% | 0 | 0.00% |
| 216.00 | 0 | 0.00% | 0 | 0.00% | 0 | 0.00% |
| 220.00 | 0 | 0.00% | 0 | 0.00% | 0 | 0.00% |
| 224.00 | 0 | 0.00% | 0 | 0.00% | 0 | 0.00% |
| 228.00 | 0 | 0.00% | 0 | 0.00% | 0 | 0.00% |
| 232.00 | 0 | 0.00% | 0 | 0.00% | 0 | 0.00% |
| 236.00 | 0 | 0.00% | 0 | 0.00% | 0 | 0.00% |
| 240.00 | 0 | 0.00% | 0 | 0.00% | 0 | 0.00% |
| 244.00 | 0 | 0.00% | 0 | 0.00% | 0 | 0.00% |
| 248.00 | 0 | 0.00% | 0 | 0.00% | 1 | 0.09% |
| 252.00 | 0 | 0.00% | 0 | 0.00% | 0 | 0.00% |
| 256.00 | 0 | 0.00% | 0 | 0.00% | 0 | 0.00% |
| | 1119 | 100.00% | 1114 | 100.00% | 1116 | 100.00% |

TABLE 21
Soy Slurry Sphericity Analysis

| | 180F Soy Slurry | | 180F Soy Slurry | | | |
|---|---|---|---|---|---|---|
| | Sphericity | | Sphericity | | 180F Soy Slurry | |
| | 80BP 115 Watts | | 80HBP 170 Watts | | Sphericity Control | |
| Class | F(n) | F(n) % | F(n) | F(n) % | F(n) | F(n) % |
| 0.00 | 0 | 0.00% | 0 | 0.00% | 0 | 0.00% |
| 0.03 | 2 | 0.18% | 4 | 0.36% | 8 | 0.72% |
| 0.06 | 3 | 0.27% | 7 | 0.63% | 26 | 2.33% |
| 0.09 | 9 | 0.81% | 12 | 1.08% | 67 | 6.00% |
| 0.13 | 14 | 1.25% | 18 | 1.62% | 105 | 9.41% |
| 0.16 | 13 | 1.16% | 16 | 1.44% | 140 | 12.54% |
| 0.19 | 18 | 1.61% | 30 | 2.69% | 143 | 12.81% |
| 0.22 | 23 | 2.06% | 29 | 2.60% | 122 | 10.93% |
| 0.25 | 17 | 1.52% | 29 | 2.60% | 94 | 8.42% |
| 0.28 | 27 | 2.42% | 35 | 3.14% | 105 | 9.41% |
| 0.31 | 28 | 2.50% | 41 | 3.68% | 79 | 7.08% |
| 0.34 | 29 | 2.59% | 44 | 3.95% | 59 | 5.29% |
| 0.38 | 24 | 2.15% | 38 | 3.41% | 33 | 2.96% |
| 0.41 | 24 | 2.15% | 47 | 4.22% | 32 | 2.87% |
| 0.44 | 30 | 2.68% | 41 | 3.68% | 23 | 2.06% |
| 0.47 | 33 | 2.95% | 52 | 4.67% | 13 | 1.16% |
| 0.50 | 32 | 2.86% | 45 | 4.04% | 13 | 1.16% |
| 0.53 | 27 | 2.42% | 52 | 4.67% | 12 | 1.08% |
| 0.56 | 35 | 3.13% | 60 | 5.39% | 6 | 0.54% |
| 0.59 | 58 | 5.19% | 40 | 3.59% | 6 | 0.54% |
| 0.63 | 52 | 4.65% | 45 | 4.04% | 2 | 0.18% |
| 0.66 | 54 | 4.83% | 50 | 4.49% | 8 | 0.72% |
| 0.69 | 61 | 5.46% | 47 | 4.22% | 8 | 0.72% |
| 0.72 | 83 | 7.42% | 63 | 5.66% | 3 | 0.27% |
| 0.75 | 69 | 6.17% | 48 | 4.31% | 1 | 0.09% |
| 0.78 | 78 | 6.98% | 59 | 5.30% | 2 | 0.18% |
| 0.81 | 54 | 4.83% | 43 | 3.86% | 2 | 0.18% |
| 0.84 | 60 | 5.37% | 48 | 4.31% | 3 | 0.27% |
| 0.88 | 87 | 7.78% | 43 | 3.86% | 1 | 0.09% |
| 0.91 | 37 | 3.31% | 15 | 1.35% | 0 | 0.00% |
| 0.94 | 19 | 1.70% | 9 | 0.81% | 0 | 0.00% |
| 0.97 | 6 | 0.54% | 1 | 0.09% | 0 | 0.00% |
| 1.00 | 12 | 1.07% | 3 | 0.27% | 0 | 0.00% |
| | 1118 | 100.00% | 1114 | 100.00% | 1116 | 100.00% |

TABLE 22
Soy Slurry Shape Analysis

| | 180F Soy | | 180F Soy | | 180F Soy | |
|---|---|---|---|---|---|---|
| | Slurry Shape | | Slurry Shape | | Slurry Shape | |
| | 80BP 115 Watts | | 80HBP 170 Watts | | Control | |
| Class | F(n) | F(n) % | F(n) | F(n) % | F(n) | F(n) % |
| 0.00 | 0 | 0.00% | 0 | 0.00% | 0 | 0.00% |
| 0.02 | 0 | 0.00% | 0 | 0.00% | 0 | 0.00% |
| 0.03 | 0 | 0.00% | 0 | 0.00% | 0 | 0.00% |
| 0.05 | 0 | 0.00% | 0 | 0.00% | 0 | 0.00% |
| 0.06 | 0 | 0.00% | 0 | 0.00% | 0 | 0.00% |
| 0.08 | 0 | 0.00% | 0 | 0.00% | 0 | 0.00% |
| 0.09 | 0 | 0.00% | 0 | 0.00% | 1 | 0.09% |
| 0.11 | 0 | 0.00% | 0 | 0.00% | 0 | 0.00% |
| 0.13 | 0 | 0.00% | 0 | 0.00% | 0 | 0.00% |
| 0.14 | 0 | 0.00% | 2 | 0.18% | 4 | 0.36% |
| 0.16 | 1 | 0.09% | 4 | 0.36% | 9 | 0.81% |
| 0.17 | 1 | 0.09% | 10 | 0.90% | 23 | 2.06% |
| 0.19 | 7 | 0.63% | 35 | 3.14% | 32 | 2.87% |
| 0.20 | 25 | 2.23% | 85 | 7.63% | 62 | 5.56% |
| 0.22 | 80 | 7.15% | 116 | 10.41% | 96 | 8.60% |
| 0.23 | 123 | 10.99% | 153 | 13.73% | 147 | 13.17% |
| 0.25 | 214 | 19.12% | 164 | 14.72% | 169 | 15.14% |
| 0.27 | 235 | 21.00% | 184 | 16.52% | 217 | 19.44% |
| 0.28 | 190 | 16.98% | 168 | 15.08% | 238 | 21.33% |
| 0.30 | 131 | 11.71% | 107 | 9.61% | 111 | 9.95% |
| 0.31 | 70 | 6.26% | 42 | 3.77% | 7 | 0.63% |
| 0.33 | 34 | 3.04% | 34 | 3.05% | 0 | 0.00% |
| 0.34 | 7 | 0.63% | 5 | 0.45% | 0 | 0.00% |
| 0.36 | 1 | 0.09% | 5 | 0.45% | 0 | 0.00% |
| 0.38 | 0 | 0.00% | 0 | 0.00% | 0 | 0.00% |
| 0.39 | 0 | 0.00% | 0 | 0.00% | 0 | 0.00% |
| 0.41 | 0 | 0.00% | 0 | 0.00% | 0 | 0.00% |
| 0.42 | 0 | 0.00% | 0 | 0.00% | 0 | 0.00% |
| 0.44 | 0 | 0.00% | 0 | 0.00% | 0 | 0.00% |
| 0.45 | 0 | 0.00% | 0 | 0.00% | 0 | 0.00% |
| 0.47 | 0 | 0.00% | 0 | 0.00% | 0 | 0.00% |
| 0.48 | 0 | 0.00% | 0 | 0.00% | 0 | 0.00% |
| 0.50 | 0 | 0.00% | 0 | 0.00% | 0 | 0.00% |
| | 1119 | 100.00% | 1114 | 100.00% | 1116 | 100.00% |

TABLE 23
Soy Slurry Aspect Ratio Analysis

| | 180F Soy | | 180F Soy | | | |
|---|---|---|---|---|---|---|
| | Slurry Aspect | | Slurry Aspect | | 180F Soy | |
| | Ratio 80BP | | Ratio 80HBP | | Slurry Aspect | |
| | 115 Watts | | 170 Watts | | Ratio Control | |
| Class | F(n) | F(n) % | F(n) | F(n) % | F(n) | F(n) % |
| 0.00 | 0 | 0.00% | 0 | 0.00% | 0 | 0.00% |
| 0.03 | 0 | 0.00% | 0 | 0.00% | 8 | 0.72% |
| 0.06 | 0 | 0.00% | 0 | 0.00% | 26 | 2.33% |
| 0.09 | 0 | 0.00% | 1 | 0.09% | 67 | 6.00% |
| 0.13 | 0 | 0.00% | 3 | 0.27% | 105 | 9.41% |
| 0.16 | 0 | 0.00% | 3 | 0.27% | 140 | 12.54% |
| 0.19 | 5 | 0.45% | 6 | 0.54% | 143 | 12.81% |
| 0.22 | 9 | 0.81% | 17 | 1.53% | 122 | 10.93% |
| 0.25 | 12 | 1.08% | 19 | 1.71% | 94 | 8.42% |
| 0.28 | 19 | 1.71% | 21 | 1.89% | 105 | 9.41% |
| 0.31 | 24 | 2.16% | 27 | 2.43% | 79 | 7.08% |
| 0.34 | 25 | 2.25% | 47 | 4.23% | 59 | 5.29% |
| 0.38 | 25 | 2.25% | 37 | 3.33% | 33 | 2.96% |
| 0.41 | 31 | 2.79% | 29 | 2.61% | 32 | 2.87% |
| 0.44 | 42 | 3.78% | 59 | 5.31% | 23 | 2.06% |
| 0.47 | 41 | 3.69% | 65 | 5.85% | 13 | 1.16% |
| 0.50 | 49 | 4.41% | 49 | 4.41% | 13 | 1.16% |
| 0.53 | 57 | 5.13% | 60 | 5.40% | 12 | 1.08% |
| 0.56 | 59 | 5.31% | 57 | 5.13% | 6 | 0.54% |
| 0.59 | 72 | 6.48% | 60 | 5.40% | 6 | 0.54% |
| 0.63 | 70 | 6.30% | 59 | 5.31% | 2 | 0.18% |
| 0.66 | 73 | 6.57% | 74 | 6.66% | 8 | 0.72% |
| 0.69 | 62 | 5.58% | 70 | 6.30% | 8 | 0.72% |
| 0.72 | 44 | 3.96% | 47 | 4.23% | 3 | 0.27% |
| 0.75 | 55 | 4.95% | 51 | 4.59% | 1 | 0.09% |
| 0.78 | 76 | 6.84% | 52 | 4.68% | 2 | 0.18% |
| 0.81 | 42 | 3.78% | 54 | 4.86% | 2 | 0.18% |
| 0.84 | 91 | 8.19% | 47 | 4.23% | 3 | 0.27% |
| 0.88 | 56 | 5.04% | 33 | 2.97% | 1 | 0.09% |
| 0.91 | 18 | 1.62% | 32 | 2.88% | 0 | 0.00% |
| 0.94 | 18 | 1.62% | 16 | 1.44% | 0 | 0.00% |
| 0.97 | 29 | 2.61% | 13 | 1.17% | 0 | 0.00% |
| 1.00 | 7 | 0.63% | 3 | 0.27% | 0 | 0.00% |
| | 1111 | 100.00% | 1111 | 100.00% | 1116 | 100.00% |

### Example 7

### Treatment of Soy Bean Base

Samples of soy bean base were subjected to ultrasonication under a variety of conditions. The ultrasonication was carried out with a Hielscher UIP 1000 ultrasonic processor, using a 20 cm head A BS2d22 sonotrode with 2.2 cm diameter and 3.8 cm² surface area was used in a D100LK-1S flow cell which has a sonic control volume of 1.5 cm³, The flow rate was 2 liters per minute, to produce a residence time of about 0.037 seconds under the sonotrode. The samples were run with a sonic reducer of 2.0. The temperature of the sonic unit was 174° F. The total solids in the samples were 15% weight per volume.

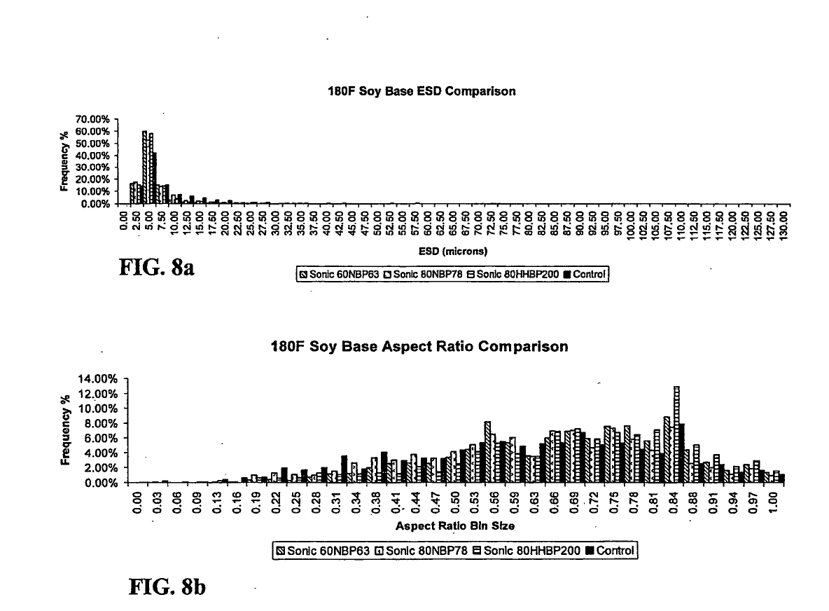

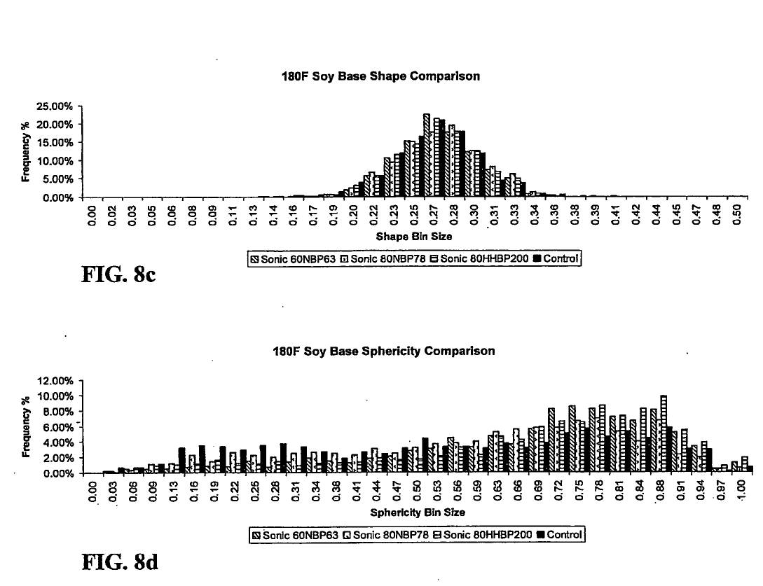

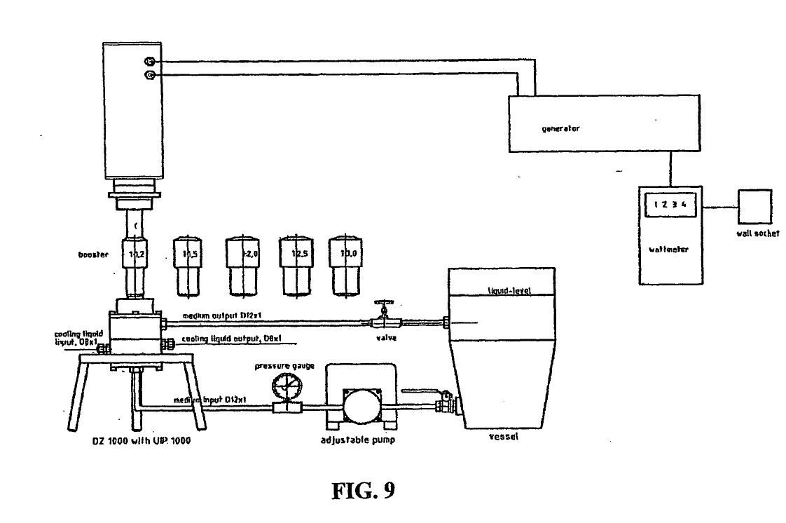

For this soybean base Example, the amplitude and the power delivered and the backpressure of the system were varied between different experiments. For the data shown in Table 24 through Table 27 and FIGS. 8a-d, the amplitude for sample A (18° F. 60 NBP 63 Watts) was 21 micrometers, with 63 watts delivered to the sample to produce an intensity of 17 watts/cm². For sample A the back pressure was 0 PSIe (no back pressure). The amplitude for sample B (180F 80 NBP 78 Watts) was 21 micrometers, with 78 watts delivered to the sample to produce an intensity of 21 watts/cm². For sample B the back pressure was 0 PSIG (no back pressure). Sample C is 180F 80 HHBP 200 Watts. The control sample was run through the system without the delivery of power or back pressure.

TABLE 24
Soy Base ESD Analysis

| | 180F Soy Base | | 180F Soy Base | | 180F Soy Base | | 180F | |
|---|---|---|---|---|---|---|---|---|
| | ESD 60NBP | | ESD 80NBP | | ESD 80HHBP | | Soy Base | |
| | 63 Watts | | 78 Watts | | 200 Watts | | ESD Control | |
| Class | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% |
| 2.50 | 193 | 16.38% | 211 | 17.60% | 172 | 15.28% | 159 | 14.40% |
| 5.00 | 706 | 59.93% | 633 | 52.79% | 654 | 58.08% | 462 | 41.85% |
| 7.50 | 180 | 15.28% | 171 | 14.26% | 162 | 14.39% | 169 | 15.31% |
| 10.00 | 33 | 2.80% | 80 | 6.67% | 44 | 3.91% | 80 | 7.25% |
| 12.50 | 14 | 1.19% | 29 | 2.42% | 14 | 1.24% | 67 | 6.07% |
| 15.00 | 11 | 0.93% | 25 | 2.09% | 16 | 1.42% | 47 | 4.26% |
| 17.50 | 6 | 0.51% | 13 | 1.08% | 13 | 1.15% | 32 | 2.90% |
| 20.00 | 4 | 0.34% | 8 | 0.67% | 6 | 0.53% | 26 | 2.36% |
| 22.50 | 6 | 0.51% | 10 | 0.83% | 6 | 0.53% | 10 | 0.91% |
| 25.00 | 6 | 0.51% | 4 | 0.33% | 8 | 0.71% | 15 | 1.36% |
| 27.50 | 2 | 0.17% | 3 | 0.25% | 5 | 0.44% | 14 | 1.27% |
| 30.00 | 1 | 0.08% | 1 | 0.08% | 2 | 0.18% | 6 | 0.54% |
| 32.50 | 6 | 0.51% | 3 | 0.25% | 1 | 0.09% | 4 | 0.36% |
| 35.00 | 0 | 0.00% | 4 | 0.33% | 0 | 0.00% | 3 | 0.27% |
| 37.50 | 0 | 0.00% | 1 | 0.08% | 0 | 0.00% | 2 | 0.18% |
| 40.00 | 2 | 0.17% | 1 | 0.08% | 4 | 0.36% | 1 | 0.09% |
| 42.50 | 1 | 0.08% | 0 | 0.00% | 2 | 0.18% | 3 | 0.27% |
| 45.00 | 0 | 0.00% | 1 | 0.08% | 1 | 0.09% | 0 | 0.00% |
| 47.50 | 0 | 0.00% | 1 | 0.08% | 1 | 0.09% | 2 | 0.18% |
| 50.00 | 1 | 0.08% | 0 | 0.00% | 1 | 0.09% | 0 | 0.00% |
| 52.50 | 0 | 0.00% | 0 | 0.00% | 3 | 0.27% | 0 | 0.00% |
| 55.00 | 0 | 0.00% | 0 | 0.00% | 0 | 0.00% | 1 | 0.09% |
| 57.50 | 1 | 0.08% | 0 | 0.00% | 3 | 0.27% | 0 | 0.00% |
| 60.00 | 0 | 0.00% | 0 | 0.00% | 0 | 0.00% | 0 | 0.00% |
| 62.50 | 0 | 0.00% | 0 | 0.00% | 0 | 0.00% | 0 | 0.00% |
| 65.00 | 0 | 0.00% | 0 | 0.00% | 0 | 0.00% | 0 | 0.00% |
| 67.50 | 0 | 0.00% | 0 | 0.00% | 1 | 0.09% | 0 | 0.00% |
| 70.00 | 0 | 0.00% | 0 | 0.00% | 0 | 0.00% | 1 | 0.09% |
| 72.50 | 0 | 0.00% | 0 | 0.00% | 1 | 0.09% | 0 | 0.00% |
| 75.00 | 0 | 0.00% | 0 | 0.00% | 0 | 0.00% | 0 | 0.00% |
| 77.50 | 0 | 0.00% | 0 | 0.00% | 0 | 0.00% | 0 | 0.00% |
| 80.00 | 0 | 0.00% | 0 | 0.00% | 0 | 0.00% | 0 | 0.00% |
| 82.50 | 0 | 0.00% | 0 | 0.00% | 0 | 0.00% | 0 | 0.00% |
| 85.00 | 0 | 0.00% | 0 | 0.00% | 0 | 0.00% | 0 | 0.00% |
| 87.50 | 2 | 0.17% | 0 | 0.00% | 0 | 0.00% | 0 | 0.00% |
| 90.00 | 0 | 0.00% | 0 | 0.00% | 0 | 0.00% | 0 | 0.00% |
| 92.50 | 0 | 0.00% | 0 | 0.00% | 0 | 0.00% | 0 | 0.00% |
| 95.00 | 1 | 0.08% | 0 | 0.00% | 0 | 0.00% | 0 | 0.00% |
| 97.50 | 1 | 0.08% | 0 | 0.00% | 0 | 0.00% | 0 | 0.00% |
| 100.00 | 0 | 0.00% | 0 | 0.00% | 2 | 0.18% | 0 | 0.00% |
| 102.50 | 0 | 0.00% | 0 | 0.00% | 1 | 0.09% | 0 | 0.00% |
| 105.00 | 0 | 0.00% | 0 | 0.00% | 0 | 0.00% | 0 | 0.00% |
| 107.50 | 0 | 0.00% | 0 | 0.00% | 2 | 0.18% | 0 | 0.00% |
| 110.00 | 0 | 0.00% | 0 | 0.00% | 0 | 0.00% | 0 | 0.00% |
| 112.50 | 1 | 0.08% | 0 | 0.00% | 0 | 0.00% | 0 | 0.00% |
| 115.00 | 0 | 0.00% | 0 | 0.00% | 0 | 0.00% | 0 | 0.00% |
| 117.50 | 0 | 0.00% | 0 | 0.00% | 0 | 0.00% | 0 | 0.00% |
| 120.00 | 0 | 0.00% | 0 | 0.00% | 0 | 0.00% | 0 | 0.00% |
| 122.50 | 0 | 0.00% | 0 | 0.00% | 0 | 0.00% | 0 | 0.00% |
| 125.00 | 0 | 0.00% | 0 | 0.00% | 0 | 0.00% | 0 | 0.00% |
| 127.50 | 0 | 0.00% | 0 | 0.00% | 1 | 0.09% | 0 | 0.00% |
| 130.00 | 0 | 0.00% | 0 | 0.00% | 0 | 0.00% | 0 | 0.00% |
| 132.50 | 0 | 0.00% | 0 | 0.00% | 0 | 0.00% | 0 | 0.00% |
| 135.00 | 0 | 0.00% | 0 | 0.00% | 0 | 0.00% | 0 | 0.00% |
| 137.50 | 0 | 0.00% | 0 | 0.00% | 0 | 0.00% | 0 | 0.00% |
| 140.00 | 0 | 0.00% | 0 | 0.00% | 0 | 0.00% | 0 | 0.00% |
| 142.50 | 0 | 0.00% | 0 | 0.00% | 0 | 0.00% | 0 | 0.00% |
| 145.00 | 0 | 0.00% | 0 | 0.00% | 0 | 0.00% | 0 | 0.00% |
| 147.50 | 0 | 0.00% | 0 | 0.00% | 0 | 0.00% | 0 | 0.00% |
| 150.00 | 0 | 0.00% | 0 | 0.00% | 0 | 0.00% | 0 | 0.00% |
| 152.50 | 0 | 0.00% | 0 | 0.00% | 0 | 0.00% | 0 | 0.00% |
| 155.00 | 0 | 0.00% | 0 | 0.00% | 0 | 0.00% | 0 | 0.00% |
| 157.50 | 0 | 0.00% | 0 | 0.00% | 0 | 0.00% | 0 | 0.00% |
| 160.00 | 0 | 0.00% | 0 | 0.00% | 0 | 0.00% | 0 | 0.00% |
| | 1178 | 100.00% | 1199 | 100.00% | 1126 | 100.00% | 1104 | 100.00% |

TABLE 25
Soy Base Sphericity Analysis

| | 80F Soy Base | | 180F Soy Base | | 180F Soy Base | | | |
|---|---|---|---|---|---|---|---|---|
| | Sphericity | | Sphericity | | Sphericity | | 180F Soy Base | |
| | 60NBP | | 80NBP | | 80HHBP | | Sphericity | |
| | 63 Watts | | 78 Watts | | 200 Watts | | Control | |
| Class | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% |
| 0.03 | 2 | 0.17% | 2 | 0.17% | 1 | 0.09% | 7 | 0.63% |
| 0.06 | 6 | 0.51% | 4 | 0.33% | 7 | 0.62% | 7 | 0.63% |
| 0.09 | 5 | 0.43% | 13 | 1.09% | 10 | 0.89% | 12 | 1.09% |
| 0.13 | 6 | 0.51% | 14 | 1.17% | 11 | 0.98% | 35 | 3.17% |
| 0.16 | 8 | 0.68% | 27 | 2.25% | 12 | 1.07% | 38 | 3.45% |
| 0.19 | 10 | 0.85% | 17 | 1.42% | 18 | 1.61% | 37 | 3.35% |
| 0.22 | 9 | 0.77% | 31 | 2.59% | 13 | 1.16% | 32 | 2.90% |
| 0.25 | 17 | 1.45% | 26 | 2.17% | 12 | 1.07% | 38 | 3.45% |
| 0.28 | 8 | 0.68% | 24 | 2.00% | 16 | 1.43% | 40 | 3.63% |
| 0.31 | 16 | 1.37% | 29 | 2.42% | 10 | 0.89% | 36 | 3.26% |
| 0.34 | 22 | 1.88% | 31 | 2.59% | 13 | 1.16% | 29 | 2.63% |
| 0.38 | 17 | 1.45% | 29 | 2.42% | 14 | 1.25% | 20 | 1.81% |
| 0.41 | 14 | 1.19% | 27 | 2.25% | 15 | 1.34% | 28 | 2.54% |
| 0.44 | 21 | 1.79% | 36 | 3.01% | 21 | 1.87% | 26 | 2.36% |
| 0.47 | 24 | 2.05% | 29 | 2.42% | 18 | 1.61% | 34 | 3.08% |
| 0.50 | 32 | 2.73% | 38 | 3.17% | 19 | 1.69% | 48 | 4.35% |
| 0.53 | 35 | 2.99% | 44 | 3.67% | 23 | 2.05% | 36 | 3.26% |
| 0.56 | 52 | 4.44% | 45 | 3.76% | 36 | 3.21% | 37 | 3.35% |
| 0.59 | 38 | 3.24% | 48 | 4.01% | 25 | 2.23% | 34 | 3.08% |
| 0.63 | 55 | 4.69% | 62 | 5.18% | 52 | 4.64% | 41 | 3.72% |
| 0.66 | 42 | 3.58% | 67 | 5.59% | 47 | 4.19% | 35 | 3.17% |
| 0.69 | 66 | 5.63% | 69 | 5.76% | 66 | 5.89% | 42 | 3.81% |
| 0.72 | 96 | 8.19% | 69 | 5.76% | 74 | 6.60% | 55 | 4.99% |
| 0.75 | 100 | 8.53% | 80 | 6.68% | 73 | 6.51% | 62 | 5.62% |
| 0.78 | 96 | 8.19% | 84 | 7.01% | 97 | 8.65% | 50 | 4.53% |
| 0.81 | 84 | 7.17% | 63 | 5.26% | 82 | 7.31% | 58 | 5.26% |
| 0.84 | 78 | 6.66% | 48 | 4.01% | 92 | 8.21% | 48 | 4.35% |
| 0.88 | 95 | 8.11% | 81 | 6.76% | 110 | 9.81% | 64 | 5.80% |
| 0.91 | 60 | 5.12% | 27 | 2.25% | 61 | 5.44% | 33 | 2.99% |
| 0.94 | 39 | 3.33% | 22 | 1.84% | 43 | 3.84% | 32 | 2.90% |
| 0.97 | 5 | 0.43% | 5 | 0.42% | 9 | 0.80% | 2 | 0.18% |
| 1.00 | 14 | 1.19% | 7 | 0.58% | 21 | 1.87% | 7 | 0.63% |
| | 1172 | 100.00% | 1198 | 100.00% | 1121 | 100.00% | 1103 | 100.00% |

TABLE 26
Soy Base Shape Analysis

| | 180F Soy | | 180F Soy | | 180F Soy | | | |
|---|---|---|---|---|---|---|---|---|
| | Base Shape | | Base Shape | | Base Shape | | 180F Soy | |
| | 60NBP | | 80NBP | | 80HHBP | | Base Shape | |
| | 63 Watts | | 78 Watts | | 200 Watts | | Control | |
| Class | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% |
| 0.02 | 0 | 0.00% | 0 | 0.00% | 0 | 0.00% | 0 | 0.00% |
| 0.03 | 0 | 0.00% | 0 | 0.00% | 0 | 0.00% | 0 | 0.00% |
| 0.05 | 0 | 0.00% | 0 | 0.00% | 0 | 0.00% | 0 | 0.00% |
| 0.06 | 0 | 0.00% | 0 | 0.00% | 0 | 0.00% | 0 | 0.00% |
| 0.08 | 0 | 0.00% | 0 | 0.00% | 0 | 0.00% | 0 | 0.00% |
| 0.09 | 0 | 0.00% | 0 | 0.00% | 0 | 0.00% | 0 | 0.00% |
| 0.11 | 0 | 0.00% | 0 | 0.00% | 0 | 0.00% | 0 | 0.00% |
| 0.13 | 0 | 0.00% | 0 | 0.00% | 0 | 0.00% | 1 | 0.09% |
| 0.14 | 1 | 0.08% | 0 | 0.00% | 1 | 0.09% | 1 | 0.09% |
| 0.16 | 0 | 0.00% | 1 | 0.08% | 4 | 0.36% | 4 | 0.36% |
| 0.17 | 2 | 0.17% | 2 | 0.17% | 1 | 0.09% | 6 | 0.54% |
| 0.19 | 8 | 0.68% | 8 | 0.67% | 6 | 0.53% | 14 | 1.27% |
| 0.20 | 22 | 1.87% | 28 | 2.34% | 34 | 3.02% | 42 | 3.80% |
| 0.22 | 67 | 5.69% | 79 | 6.59% | 64 | 5.68% | 63 | 5.71% |
| 0.23 | 123 | 10.44% | 111 | 9.26% | 129 | 11.46% | 130 | 11.78% |
| 0.25 | 179 | 15.20% | 180 | 15.01% | 162 | 14.39% | 181 | 16.39% |
| 0.27 | 265 | 22.50% | 211 | 17.60% | 240 | 21.31% | 230 | 20.83% |
| 0.28 | 206 | 17.49% | 233 | 19.43% | 199 | 17.67% | 195 | 17.66% |
| 0.30 | 144 | 12.22% | 150 | 12.51% | 141 | 12.52% | 131 | 11.87% |
| 0.31 | 86 | 7.30% | 98 | 8.17% | 77 | 6.84% | 49 | 4.44% |
| 0.33 | 60 | 5.09% | 74 | 6.17% | 56 | 4.97% | 41 | 3.71% |
| 0.34 | 10 | 0.85% | 16 | 1.33% | 10 | 0.89% | 9 | 0.82% |
| 0.36 | 5 | 0.42% | 5 | 0.42% | 2 | 0.18% | 6 | 0.54% |
| 0.38 | 0 | 0.00% | 0 | 0.00% | 0 | 0.00% | 1 | 0.09% |
| 0.39 | 0 | 0.00% | 2 | 0.17% | 0 | 0.00% | 0 | 0.00% |
| 0.41 | 0 | 0.00% | 1 | 0.08% | 0 | 0.00% | 0 | 0.00% |
| 0.42 | 0 | 0.00% | 0 | 0.00% | 0 | 0.00% | 0 | 0.00% |
| 0.44 | 0 | 0.00% | 0 | 0.00% | 0 | 0.00% | 0 | 0.00% |
| 0.45 | 0 | 0.00% | 0 | 0.00% | 0 | 0.00% | 0 | 0.00% |
| 0.47 | 0 | 0.00% | 0 | 0.00% | 0 | 0.00% | 0 | 0.00% |
| 0.48 | 0 | 0.00% | 0 | 0.00% | 0 | 0.00% | 0 | 0.00% |
| 0.50 | 0 | 0.00% | 0 | 0.00% | 0 | 0.00% | 0 | 0.00% |
| | 1178 | 100.00% | 1199 | 100.00% | 1126 | 100.00% | 1104 | 100.00% |

TABLE 27
Soy Base Aspect Ratio Analysis

| | 180F Soy Base | | 180F Soy Base | | 180F Soy Base | | | |
|---|---|---|---|---|---|---|---|---|
| | Aspect Ratio | | Aspect Ratio | | Aspect Ratio | | 180F Soy Base | |
| | 60NBP | | 80NBP | | 80HHBP | | Aspect Ratio | |
| | 63 Watts | | 78 Watts | | 200 Watts | | Control | |
| Class | F(n) | F(n) % | F(n) | F(n) % | F(n) | F(n) % | F(n) | F(n) % |
| 0.00 | 0 | 0.00% | 0 | 0.00% | 0 | 0.00% | 0 | 0.00% |
| 0.03 | 0 | 0.00% | 1 | 0.08% | 0 | 0.00% | 2 | 0.18% |
| 0.06 | 0 | 0.00% | 0 | 0.00% | 0 | 0.00% | 1 | 0.09% |
| 0.09 | 0 | 0.00% | 0 | 0.00% | 1 | 0.09% | 1 | 0.09% |
| 0.13 | 0 | 0.00% | 1 | 0.08% | 2 | 0.18% | 4 | 0.37% |
| 0.16 | 1 | 0.09% | 1 | 0.08% | 0 | 0.00% | 7 | 0.64% |
| 0.19 | 4 | 0.35% | 12 | 1.01% | 7 | 0.64% | 8 | 0.73% |
| 0.22 | 5 | 0.43% | 15 | 1.26% | 6 | 0.55% | 21 | 1.92% |
| 0.25 | 3 | 0.26% | 13 | 1.09% | 7 | 0.64% | 18 | 1.65% |
| 0.28 | 8 | 0.69% | 12 | 1.01% | 14 | 1.27% | 22 | 2.01% |
| 0.31 | 13 | 1.12% | 18 | 1.51% | 12 | 1.09% | 39 | 3.57% |
| 0.34 | 14 | 1.21% | 32 | 2.68% | 13 | 1.18% | 20 | 1.83% |
| 0.38 | 23 | 1.98% | 40 | 3.36% | 14 | 1.27% | 45 | 4.12% |
| 0.41 | 30 | 2.59% | 36 | 3.02% | 13 | 1.18% | 32 | 2.93% |
| 0.44 | 31 | 2.67% | 45 | 3.78% | 24 | 2.18% | 36 | 3.30% |
| 0.47 | 30 | 2.59% | 39 | 3.27% | 16 | 1.46% | 35 | 3.21% |
| 0.50 | 39 | 3.36% | 50 | 4.19% | 28 | 2.55% | 48 | 4.40% |
| 0.53 | 52 | 4.49% | 61 | 5.12% | 46 | 4.19% | 59 | 5.40% |
| 0.56 | 94 | 8.11% | 78 | 6.54% | 58 | 5.28% | 60 | 5.49% |
| 0.59 | 62 | 5.35% | 73 | 6.12% | 43 | 3.91% | 53 | 4.85% |
| 0.63 | 42 | 3.62% | 42 | 3.52% | 39 | 3.55% | 57 | 5.22% |
| 0.66 | 70 | 6.04% | 83 | 6.96% | 76 | 6.92% | 59 | 5.40% |
| 0.69 | 80 | 6.90% | 84 | 7.05% | 80 | 7.28% | 74 | 6.78% |
| 0.72 | 69 | 5.95% | 56 | 4.70% | 65 | 5.91% | 56 | 5.13% |
| 0.75 | 87 | 7.51% | 87 | 7.30% | 74 | 6.73% | 58 | 5.31% |
| 0.78 | 88 | 7.59% | 70 | 5.87% | 71 | 6.46% | 49 | 4.49% |
| 0.81 | 66 | 5.69% | 51 | 4.28% | 78 | 7.10% | 42 | 3.85% |
| 0.84 | 102 | 8.80% | 89 | 7.47% | 142 | 12.92% | 86 | 7.88% |
| 0.88 | 51 | 4.40% | 31 | 2.60% | 56 | 5.10% | 28 | 2.56% |
| 0.91 | 32 | 2.76% | 24 | 2.01% | 41 | 3.73% | 27 | 2.47% |
| 0.94 | 19 | 1.64% | 14 | 1.17% | 24 | 2.18% | 15 | 1.37% |
| 0.97 | 28 | 2.42% | 22 | 1.85% | 32 | 2.91% | 18 | 1.65% |
| 1.00 | 16 | 1.38% | 12 | 1.01% | 17 | 1.55% | 12 | 1.10% |
| | 1159 | 100.00% | 1192 | 100.00% | 1099 | 100.00% | 1092 | 100.00% |

### Example 8

### Treatment of Soybean Milk

Samples of soybean base were subjected to ultrasonication under a variety of conditions. The ultrasonication was carried out with a Hielscher UIP 1000 ultrasonic processor, using a 3.4 cm head. A BS2d34 sonotrode with 3.4 cm diameter and 9 cm² surface area was used in a D100LK-1S flow cell which has a sonic control volume of 2.85 cm³. The flow rate was 2 liters per minute, to produce a residence time of about 0.037 seconds under the sonotrode. The samples were run with a sonic reducer of 2.0. The temperature of the sonic unit was 174° F. The total solids in the samples was approximately 7 percent.

For the soybean milk example the amplitude and power delivered and the backpressure of the system were varied between different experiments. The amplitude for sample A was 21 micrometers, with 220 watts delivered to the sample to produce an intensity of 24 watts/cm². For sample A the back pressure was 0 PSIG (no back pressure). The amplitude for sample B was 26 micrometers, with 425 watts delivered to the sample to produce an intensity of 47 watts/cm². For sample B the back pressure was 25 PSIG. The control sample was untreated soy milk.

### Example 9

### Yields of Fermentable Sugars and Ethanol from Ultrasonication Treatments of Corn Slurries

To determine if the methods of the invention produce corn starch particles that produce greater yields of fermentable sugars and ethanol under commercial conditions, corn slurries were ultrasonicated in the method and compared to non-treated slurry and slurry treated in methods that do not comply with the method of the invention. The various treated slurries were then treated with amylases and fermented at a commercial ethanol plant. The samples A (80bBP425w/NO Recycle) and B (100BP400/No Recycle); were treated as described in Example 5, for sample A the amplitude was 80%, 425 watts were applied with 15 PSIG of backpressure, while sample B the amplitude was 100% and 400 watts were applied with 15 PSIG of back pressure. Samples C (100BP600 W/Recycle) and D(100BP500W/Recyle [2PASS]) were not treated according to the methods of the invention, as these samples were recycled through the sonic unit, with sample c recycled once and sample D recycled twice. For samples C the amplitude was 100% with 600 watts and 15 PSIG backpressure. For samples C the amplitude was 100% with 500 watts and 15 PSIG backpressure. As a control sample the corn slurry was not treated with ultrasonication. The corn slurry for all samples was 32% solids weight per volume and 67% starch. All samples were similarly treated with amylase enzymes at a commercial plant and under went fermentation for 48 hours at a commercial ethanol production plant.

Corn slurries were treated according to the aspect of the invention that involves corn starch particles. Ultrasonication of corn slurry according to the method of the invention increased yields of fermentable sugars (glucose, maltose, dextrin) obtained from amylase digestions by 15 to 17% as compared to the control untreated corn slurries, with Samples A and B yielding 29.2% and 28.8% fermentable sugar as compared to 25% for the control sample. Similarly, ultrasonication of corn slurry according to the invention increased yields of ethanol obtained following fermentation by 9 to 10.4%, with 13.80% and 13.01% conversions for samples A and B respectively as compared to 12.1% conversion for the untreated control slurry. Interestingly, ultrasonic treatments of corn slurry that are not in accordance with the methods of this invention resulted in yields of the amount of fermentable sugars 23.02% for sample C and 19.37% for sample D, an 8 and 22.5% reduction compared to the yield from the control samples. Similarly percentage conversion of ethanol obtained from fermentation of samples C and D was only 9.5% and 6.63%, respectively, as compared to the 12.1% conversion rate of the control untreated samples.

### Particle Morphology Analysis

As can be seen from the foregoing, the various samples show differences from the non-ultrasound treated samples at the 99% confidence level. These differences are consistent between time and temperature variables for skim milk. It is believed that these differences will remain consistent across various products and various fat levels. The following is a description of the techniques used to generate and analyze the data.

Image Analysis of Fat Particles: Images of fat particles in samples of products were obtained using a modified dark field technique augmented by reverse video with threshold. The maximum optical system resolution with this particular technique and hardware components was approximately 0.15-0.2 microns. All fat particle feature measurements were obtained using the Powder WorkBench32 imaged through a Cambridge microscope where each sample was mounted on a standard slide with cover slip. Note: Darkfield is often technique of choice for imaging small or minute objects as well as emulsions or unstained objects in watery solutions. In this technique, diffracted and scattered light components reach the objective while directly reflecting light bundles are guided past the object, thus fine structures can be resolved and appear bright on a dark background.

Image Analysis of Protein and Carbohydrate Particles: Images of protein and sugar particles in samples of products were obtained using a standard brightfield technique augmented by threshold. All particle feature measurements were obtained using the Powder WorlcBench32 imaged through a Cambridge microscope with each sample mounted on a standard slide with cover slip.

Image Analysis of Fiber Particles: Images of fiber particles were obtained using a standard brightfield technique augmented by threshold. All particle feature measurements were obtained using the Powder WorkBench32 imaged through a Cambridge microscope with each sample mounted on a standard slide without cover slip.

Chi_Square Test: The basic idea behind the chi-square goodness of fit test is to divide the range of the data into a number of intervals. Then the number of points that fall into each interval is compared to expected number of points for that interval if the data in fact come from the hypothesized distribution. More formally, the chi-square goodness of fit test statistic can be defined as follows.
H₀: The data follow the specified distribution.
Hₐ: The data do not follow the specified distribution.
Test Statistic For the chi-square goodness of fit, the data is divided into k bins and the test statistic is defined as

$${χ}^{2} = {\sum }_{i = 1}^{k} {( {O}_{i} - {E}_{i} )}^{2} / {E}_{i}$$

where O_{I} is the observed frequency for bin i and Eᵢ is the expected frequency for bin i. The expected frequency is calculated by

Eᵢ=F(Yᵤ)−F(Yₗ)
where F is the cumulative distribution function for the distribution being tested, Yᵤ is the upper limit for class i, and Yₗ is the lower limit for class i.
Significance Level: A
Critical Region: The test statistic follows, approximately, a chi-square distribution with (k−c) degrees of freedom where k is the number of non-empty cells and c=the number of parameters.
   The hypothesis that the distribution is from the specified distribution is rejected if

X²>X²_{(1-α, k-c)}
where X²_{(1-α, k-c)} is the chi-square percent point function with k−c degrees of freedom and a significance level of α.

The primary advantage of the chi square goodness of fit test is that it is quite general. It can be applied for any distribution, either discrete or continuous, for which the cumulative distribution function can be computed.

The present invention utilizes ultrasound energy to affect the particle morphology of various components in products. In general, the particle size, distribution and morphology of the component particles have an effect on the functionality of the product. For example, optimization of particle morphology can be used to reduce the amount of stabilizers in a food product, while maintaining the functional and organoleptic properties of the food product Optimization of particle morphology in accordance with the present invention can permit an overall reduction in the fat content of a food product, again while maintaining the functional and organoleptic properties of the food product.

In another example, the optimization of particle morphology in accordance with the present invention can result in an increase in protein particles having an ESD at the sub-micron level, which results in a marked improvement in creaminess and other desirable organoleptic properties. Other physical and/or organoleptic properties of products can be controlled or improved using the techniques described herein.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein.

1. A method for improving the physical and functional properties of corn-originating particles, comprising: providing a grain-originating material selected from the group consisting of grain carbohydrate, grain fiber, grain cellulosic material, and combinations thereof; and processing the grain-originating material to modify one or more morphological properties of the material to provide corn-originating particles having solid or liquid characteristics, wherein said morphological properties of said particles that are modified are selected from the group consisting of sphericity, equivalent spherical diameter, shape, aspect ratio, and combinations thereof.

2. The method of claim 1, wherein said sphericity property ranges between about 0.03 and about 0.75.

3. The method of claims 1 or 2, wherein said equivalent spherical diameter property ranges between about zero and about 8 microns.

4. The method of any of claims 1-3, wherein said shape property ranges between about 0.13 and about 0.5.

5. The method of any of claims 1-4, wherein said aspect ratio property ranges between about zero and about 0.75.

6. The method of any of claims 1-5, wherein the method further comprises determining a range of values for the morphological property, and processing the particles to increase a number of the particles within the range of values as compared to a control product.

7. The method of any of claims 1-6, wherein the method further comprises processing the particles to more uniformly distribute the particles within one or more of said ranges of property values as compared to control product.

8. The method of claim 7, wherein said one or more of said ranges of property values is at least about 1% greater than the percentage of particles in each class for the control product.

9. The method of claim 7 or 8, wherein said one or more of said ranges of property values is up to about 100% greater than the percentage of particles in each class for the control product.

10. The method of claim 9, wherein said one or more of said ranges of property values is between about 5% and about 75%, optionally between about 10% and about 60%, and optionally between about 20% and about 50% greater than the percentage of particles in each class for the control product.

11. A method for producing ethanol which includes improving the physical and functional properties of corn-originating particles made by the method of any of claims 1-10, comprising: providing a corn-originating material selected from the group consisting of corn carbohydrate, corn fiber, corn cellulosic material, and combinations thereof; processing the corn-originating material to modify one or more morphological properties of the material to provide corn-originating particles having solid or liquid characteristics, wherein said morphological properties of said particles are selected from the group consisting of sphericity, equivalent spherical diameter, shape, aspect ratio, and combinations thereof; and fermenting said particles into ethanol.

12. A method for improving the physical and functional properties of soybean-originating particles, comprising: providing a soybean-originating material selected from the group consisting of soybean fiber, soybean protein, and combinations thereof; and processing the soybean-originating material to modify one or more morphological properties of the material to provide soybean-originating particles having solid or liquid characteristics, wherein said morphological properties of said particles that are modified are selected from the group consisting of sphericity, equivalent spherical diameter, shape, aspect ratio, and combinations thereof.

13. The method of claim 12, wherein said sphericity property ranges between about 0.38 and about 1.

14. The method of claims 12 or 13, wherein said equivalent spherical diameter property ranges between about zero and about 10 microns.

15. The method of any of claims 12-14, wherein said shape property ranges between about 0.14 and about 0.5.

16. The method of any of claims 12-15, wherein said aspect ratio property ranges between about 0.38 and about 1.

17. The method of any of claims 12-16, wherein the method further comprises determining a range of values for the morphological property, and processing the particles to increase a number of the particles within the range of values as compared to a control product.

18. The method of any of claims 12-17, wherein the method further comprises processing the particles to more uniformly distribute the particles within one or more of said ranges of property values as compared to control product.

19. The method of claim 18, wherein said one or more of said ranges of property values is at least about 1% greater than the percentage of particles in each class for the control product.

20. The method of claim 18 or 19, wherein said one or more of said ranges of property values is up to about 100% greater than the percentage of particles in each class for the control product.

21. The method of claim 20, wherein said one or more of said ranges of property values is between about 5% and about 75%, optionally between about 10% and about 60%, and optionally between about 20% and about 50% greater than the percentage of particles in each class for the control product.

22. A method for producing soy-based products which includes improving the physical and functional properties of soybean-originating particles made by the method of any of claims 12-21, comprising: providing a soybean-originating material selected from the group consisting of soybean protein, soybean fiber, and combinations thereof; processing the soybean-originating material to modify one or more morphological properties of the material to provide soybean-originating particles having solid or liquid characteristics, wherein said morphological properties of said particles that are modified are selected from the group consisting of sphericity, equivalent spherical diameter, shape, aspect ratio, and combinations thereof; and formulating said particles into a soy-based product.

23. The method of claim 22, wherein said soy-based product is soy milk.

24. A method for improving the physical and functional properties of a product containing particles having solid or liquid characteristics, comprising: providing a material selected from the group consisting of fiber, protein, carbohydrate and cellulosic materials, and combinations thereof; processing the particles to modify one or more morphological properties of the materials, wherein said morphological properties that are modified are selected from the group consisting of sphericity, equivalent spherical diameter, shape, aspect ratio, and combinations thereof.

25. The method of claim 24, wherein said sphericity property ranges between about 0.03 and about 1.0.

26. The method of claims 24 or 25, wherein said equivalent spherical diameter property ranges between about zero and about 10 microns.

27. The method of any of claims 24-26, wherein said shape property ranges between about 0.13 and about 0.5.

28. The method of any of claims 24-27, wherein said aspect ratio property ranges between about zero and about 1.0.

29. The method of any of claims 24-28, wherein the method further comprises determining a range of values for the morphological property, and processing the particles to increase a number of the particles within the range of values as compared to a control product.

30. The method of any of claims 24-29, wherein the method further comprises processing the particles to more uniformly distribute the particles within one or more of said ranges of property values as compared to control product.

31. The method of claim 30, wherein said one or more of said ranges of property values is at least about 1% greater than the percentage of particles in each class for the control product.

32. The method of claim 30 or 31, wherein said one or more of said ranges of property values is up to about 100% greater than the percentage of particles in each class for the control product.

33. The method of claim 32, wherein said one or more of said ranges of property values is between about 5% and about 75%, optionally between about 10% and about 60%, and optionally between about 20% and about 50% greater than the percentage of particles in each class for the control product.

34. The corn-originating particles produced in accordance with the method of any of claims 1-10.

35. Corn-originating particles comprising particles having solid or liquid characteristics that are processed from corn, said corn-originating particles having a sphericity property ranging between about 0.03 and about 0.75, an equivalent spherical diameter property ranging between about zero and about 8 microns, a shape property ranging between about 0.13 and about 0.5, and an aspect ratio property ranging between about zero and about 0.75.

36. Ethanol produced in accordance with the method of claim 11.

37. The soybean-originating particles produced in accordance with the method of any of claims 12-21.

38. Soybean-originating particles comprising particles having solid or liquid characteristics that are processed from soybeans, said soybean-originating particles having a sphericity property ranging between about 0.38 and about 1, an equivalent spherical diameter property ranging between about zero and about 10 microns, a shape property ranging between about 0.14 and about 0.5, and an aspect ratio property ranging between about 0.38 and about 1.

39. A soy-based product produced in accordance with the method of claim 22.

40. The soy-based product of claim 39, selected from the group consisting of yoghurt and yogurt-containing products, soy milk and soy milk-containing products, tofu, and combinations thereof.

41. The particles produced in accordance with the method of any of claims 24-33.

42. The soy-based product of claim 40, said product being soy milk, said soy milk having a sphericity property ranging between about 0.47 and about 0.98, an equivalent spherical diameter property ranging between about zero and about 10 microns, a shape property ranging between about 0.188 and about 0.5, and an aspect ratio property ranging between about 0.53 and about 0.95.

43. The method of claim 1, wherein said grain-based material is selected from the group consisting of corn, sorghum, wheat and combinations thereof.
